(19) United States
(12) Patent Application Publication
(10) Pub. No.: US 2012/0187047 A1
(43) Pub. Date: Jul. 26, 2012

(54) RARE EARTH REMOVAL OF HYDRATED AND HYDROXYL SPECIES

(75) Inventors: Robert Cable, Las Vegas, NV (US); Carl Hassler, Gig Harbor, WA (US); John Burba, Parker, CO (US)

(73) Assignee: MOLYCORP MINERALS, LLC, Greenwood Village, CO (US)

(21) Appl. No.: 13/356,581

(22) Filed: Jan. 23, 2012

Related U.S. Application Data
(60) Provisional application No. 61/435,060, filed on Jan. 21, 2011.
(60) Provisional application No. 61/435,663, filed on Jan. 24, 2011.
(60) Provisional application No. 61/436,127, filed on Jan. 25, 2011.
(60) Provisional application No. 61/439,741, filed on Feb. 4, 2011.
(60) Provisional application No. 61/445,915, filed on Feb. 23, 2011.
(60) Provisional application No. 61/448,021, filed on Mar. 1, 2011.
(60) Provisional application No. 61/453,446, filed on Mar. 16, 2011.
(60) Provisional application No. 61/474,902, filed on Apr. 13, 2011.
(60) Provisional application No. 61/475,155, filed on Apr. 13, 2011.
(60) Provisional application No. 61/539,780, filed on Sep. 27, 2011.
(60) Provisional application No. 61/546,803, filed on Oct. 13, 2011.

(51) Int. Cl. C01F 17/00; C02F 9/04; C02F 1/72; C02F 1/70; C09K 3/00; C02F 1/28

(52) U.S. Cl. 210/668; 423/263; 252/175; 210/660

(57) ABSTRACT

This disclosure relates generally to methods and rare earth-containing additives for removing target materials in the form of hydroxides, carbonates, hydrates, or oxyhydroxyls from, a typically aqueous, liquid medium.

### CROSS REFERENCE TO RELATED APPLICATIONS

The present application claims the benefits of U.S. Provisional Application Serial Nos. 61/435,060 with a filing date of Jan. 21, 2011, 61/435,663 with a filing date of Jan. 24, 2011, 61/436,127 with a filing date of Jan. 25, 2011, 61/439,741 with a filing date of Feb. 4, 2011, 61/445,915 with a filing date of Feb. 23, 2011, 61/448,021 with a filing date of Mar. 1, 2011, 61/453,446 with a filing date of Mar. 16, 2011, 61/474,902 with a filing date of Apr. 13, 2011, 61/475,155 with a filing date of Apr. 13, 2011, 61/539,780 with a filing date of Sep. 27, 2011, 61/546,803 with a filing date of Oct. 13, 2011 all entitled “Process for Treating Waters and Water Handling Systems Using Rare Earth Metals”, each of which is incorporated in its entirety herein by this reference.

Cross reference is made to U.S. patent application Ser. No. 13/244,092 filed Sep. 23, 2011, entitled “PROCESS FOR TREATING WATERS AND WATER HANDLING SYSTEMS TO REMOVE SCALES AND REDUCE THE SCALING TENDENCY” having attorney docket no. 6062-89-3, which is incorporated herein by this reference in its entirety.

Cross reference is made to U.S. patent application ser. No. 13/244,117 filed Sep. 23, 2011, entitled “PARTICULATE CERIUM DIOXIDE AND AN IN SITU METHOD FOR MAKING AND USING THE SAME” having attorney docket no. 6062-89-4, which is incorporated herein by this reference in its entirety.

### FIELD OF INVENTION

The present disclosure is related generally to rare earth removal of hydrated and hydroxyl species, more particularly to rare earth removal of metal and metalloid-containing hydrated and/or hydroxyl species.

### BACKGROUND OF THE INVENTION

As fresh water resources grow increasingly scarce, water quality is rapidly becoming a major global concern. In addition to high levels of pollution from industrial and municipal sources and saltwater intrusion into fresh water acquifers, commonly used disinfectants in drinking water, particularly free chlorine (in the form of HOCl/OCl⁻) and monochloramine (NH₂Cl), react with metals and metalloids to produce soluble products. Monochloramine, for example, is believed to react with lead to produce soluble Pb(II) products, leading to elevated Pb levels in drinking water.

Various technologies have been used to remove contaminants from municipal, industrial, and recreational waters. Examples of such techniques include adsorption on high surface area materials, such as alumina and activated carbon, ion exchange with anion exchange resins, co-precipitation and electrodialysis. However, most technologies for contaminant removal are hindered by the difficulty of removing problematic contaminants, more particularly the difficulty of removing metal and metalloid contaminant species.

### SUMMARY OF THE INVENTION

These and other needs are addressed by the various embodiments and configurations of this disclosure. The present disclosure is directed to the use of rare earth-containing compositions to remove various contaminants, including metal and metalloid target materials.

In one embodiment, a composition has the formula:

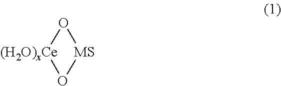

where 0≦X≦8 and MS is one of the following:

M(H₂O)₆ⁿ, M(H₂O)₅OH⁽ⁿ⁻¹), M(OH)⁽ⁿ⁻¹⁾M(H₂O)₄(OH)₂⁽ⁿ⁻²⁾, M(OH)₂⁽ⁿ⁻²⁾, M(H₂O)₃(OH)₃⁽ⁿ⁻³⁾, M(OH)₃⁽ⁿ⁻³⁾, M(H₂O)₂(OH)₄⁽ⁿ⁻⁴⁾, M(OH)₄⁽ⁿ⁻⁴⁾, M(H₂O)(OH)₅⁽ⁿ⁻⁵⁾, M(OH)₅⁽ⁿ⁻⁵⁾, M(OH)₆⁽ⁿ⁻⁶⁾, M(H₂O)₅O⁽ⁿ⁻²⁾, M(H₂O)₄(O)₂⁽ⁿ⁻⁴⁾, M(H₂O)₃(O)₃⁽ⁿ⁻⁶⁾, M(H₂O)₂(O)₄⁽ⁿ⁻⁸⁾, M(H₂O)(O)₅⁽ⁿ⁻¹⁰⁾, M(H₂O)₅CO₃⁽ⁿ⁻²⁾, MCO₃⁽ⁿ⁻²⁾, M(H₂O)₄(CO₃)₂⁽ⁿ⁻⁴⁾, M(CO₃)₂⁽ⁿ⁻⁴⁾, M(H₂O)₃(CO₃)₃⁽ⁿ⁻⁶⁾, M(CO₃)₃⁽ⁿ⁻⁶⁾, M(H₂O)₂(CO₃)₄⁽ⁿ⁻⁸⁾, M(CO₃)₄⁽ⁿ⁻⁸⁾, M(H₂O)(CO₃)₅⁽ⁿ⁻¹⁰⁾, M(CO₃)₅⁽ⁿ⁻¹⁰⁾, M(CO₃)₆⁽ⁿ⁻¹²⁾, M(H₂O)₄ⁿ, M(H₂O)₃OH⁽ⁿ⁻¹⁾, M(H₂O)₂(OH)₂⁽ⁿ⁻²⁾, M(H₂O)(OH)₃⁽ⁿ⁻³⁾, M(H₂O)₃O⁽ⁿ⁻²⁾, M(H₂O)₂(O)₂⁽ⁿ⁻⁴⁾, and M(H₂O)(O)₃⁽ⁿ⁻⁶⁾. “M” is a metal or metalloid having an atomic number selected from the group consisting of 5, 13, 22-33, 40-52, 72-84, and 89-94. The symbol “n” is a real number≦8 and represents a charge or oxidation state of “M”.

In one application, the composition is in a liquid media or medium, and the media or medium comprises a pH and Eh sufficient to favor MS as the primary species of M.

In one application, M is one or more of boron, vanadium, chromium, cadmium, antimony, lead, and bismuth.

In one embodiment, a method contacts, in a medium, a rare earth-containing additive with a metal or metalloid target material to remove the target material. The target material is in the form of a hydroxide, carbonate, hydrate, or oxyhydroxyl as a primary species.

In one embodiment, a method is provided that contacts, in a medium, a rare earth-containing additive with one or more of a metal or metalloid hydroxide, carbonate, and hydrate to remove the metal or metalloid hydroxide, carbonate, and/or hydrate.

The rare earth-containing additive can be water soluble or water insoluble.

In one application, the target material has an atomic number selected from the group consisting of 5, 13, 22-33, 40-52, 72-84, and 89-94.

In one application, the contacting step comprises the sub-steps:

(a) introducing, to the medium, an oxidizing agent to oxidize a target material-containing species to a primary species in the form of one or more of a metal or metalloid hydroxide, carbonate, oxyhydroxyl, and hydrate, the target material-containing species being different from the metal or metalloid hydroxide, carbonate, oxyhydroxyl, and/or hydrate; and

(b) thereafter contacting, in the medium, the rare earth-containing additive with the metal or metalloid hydroxide, carbonate, oxyhydroxyl, and/or hydrate to remove the metal or metalloid hydroxide, carbonate, oxyhydroxyl, and/or hydrate.

In one application, the contacting step comprises the sub-steps:

(a) introducing, to the medium, a reducing agent to reduce a target material-containing species comprising the metal or metalloid to a primary species in the form of the metal or metalloid hydroxide, carbonate, oxyhydroxyl, and/or hydrate, the target material-containing species being different from the metal or metalloid hydroxide, carbonate, oxyhydroxyl, and/or hydrate; and

(b) thereafter contacting, in the medium, the rare earth-containing additive with the metal or metalloid hydroxide, carbonate, oxyhydroxyl, and/or hydrate to remove the metal or metalloid hydroxide, carbonate, oxyhydroxyl, and/or hydrate.

In one application, the contacting step comprises the sub-steps:

(a) introducing, to the medium, a base and/or base equivalent to convert a target material-containing species comprising the metal or metalloid to a primary species in the form of the metal or metalloid hydroxide, carbonate, oxyhydroxl, and/or hydrate, the target material-containing species being different from the metal or metalloid hydroxide, carbonate, oxyhydroxyl, and/or hydrate; and

(b) thereafter contacting, in the medium, the rare earth-containing additive with the metal or metalloid hydroxide, carbonate, and/or hydrate to remove the metal or metalloid hydroxide, carbonate, oxyhydroxyl, and/or hydrate.

In one application, the contacting step comprises the sub-steps:

(a) introducing, to the medium, an acid and/or acid equivalent to convert a target material-containing species comprising the metal or metalloid to a primary species in the form of the metal or metalloid hydroxide, carbonate, oxyhydroxyl, and/or hydrate, the target material-containing species being different from the metal or metalloid hydroxide, carbonate, oxyhydroxyl, and/or hydrate; and

(b) thereafter contacting, in the medium, the rare earth-containing additive with the metal or metalloid hydroxide, carbonate, oxyhydroxyl, and/or hydrate to remove the metal or metalloid hydroxide, carbonate, oxyhydroxyl, and/or hydrate.

The disclosure can have a number of advantages. For example, the rare earth-containing composition can remove effectively a large number of target materials, whether in the form of dissolved or undissolved species. As an illustration, the composition can remove lead and lead species in various forms, including as a colloid, hydrate, carbonate, hydroxide, and oxyhydroxyl. The pH and/or Eh can be adjusted to produce a selected primary target material species, which is removed more effectively by the rare earth composition compared to rare earth removal of other target material species. High levels of removal of selected target materials can therefore be realized.

These and other advantages will be apparent from the disclosure.

As used herein, the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

“Absorption” refers to the penetration of one substance into the inner structure of another substance, as distinguished from adsorption.

“Adsorption” refers to the adherence of atoms, ions, molecules, polyatomic ions, or other substances to the surface of another substance, called the adsorbent. Typically, the attractive force for adsorption can be in the form of a bond and/or force, such ascovalent bonds, metallic bonds, coordination bonds, ionic bonds, hydrogen bonds, electrostatic forces (e.g., van der Waals and/or London's forces), and the like.

“At least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The term “water” refers to any aqueous stream. The water may originate from any aqueous stream may be derived from any natural and/or industrial source. Non-limiting examples of such aqueous streams and/or waters are drinking waters, potable waters, recreational waters, waters derived from manufacturing processes, wastewaters, pool waters, spa waters, cooling waters, boiler waters, process waters, municipal waters, sewage waters, agricultural waters, ground waters, power plant waters, remediation waters, co-mingled water and combinations thereof.

The terms “agglomerate” and “aggregate” refer to a composition formed by gathering one or more materials into a mass.

A “binder” generally refers to one or more substances that bind together a material being agglomerated. Binders are typically solids, semi-solids, or liquids. Non-limiting examples of binders are polymeric materials, tar, pitch, asphalt, wax, cement water, solutions, dispersions, powders, silicates, gels, oils, alcohols, clays, starch, silicates, acids, molasses, lime, lignosulphonate oils, hydrocarbons, glycerin, stearate, or combinations thereof. The binder may or may not chemically react with the material being agglomerated. Non-liming examples of chemical reactions include hydration/dehydration, metal ion reactions, precipitation/gelation reactions, and surface charge modification.

A “carbonate” generally refers to a chemical compound containing the carbonate radical or ion (CO₃⁻²). Most familiar carbonates are salts that are formed by reacting an inorganic base (e.g., a metal hydroxide with carbonic acid (H₂CO₃). Normal carbonates are formed when equivalent amounts of acid and base react; bicarbonates, also called acid carbonates or hydrogen carbonates, are formed when the acid is present in excess. Examples of carbonates include sodium carbonate, (Na₂CO₃), sodium bicarbonate (NaHCO₃), and potassium carbonate (K₂CO₃).

The term “composition” generally refers to one or more chemical units composed of one or more atoms, such as a molecule, polyatomic ion, chemical compound, coordination complex, coordination compound, and the like. As will be appreciated, a composition can be held together by various types of bonds and/or forces, such as covalent bonds, metallic bonds, coordination bonds, ionic bonds, hydrogen bonds, electrostatic forces (e.g., van der Waal's forces and London's forces), and the like.

“Chemical species” or “species” are atoms, elements, molecules, molecular fragments, ions, compounds, and other chemical structures.

“Chemical transformation” refers to process where at least some of a material has had its chemical composition transformed by a chemical reaction. A “chemical transformation” differs from “a physical transformation”. A physical transformation refers to a process where the chemical composition has not been chemically transformed but a physical property, such as size or shape, has been transformed.

The term “contained within the water” generally refers to materials suspended and/or dissolved within the water. Water is typically a solvent for dissolved materials and water-soluble material. Furthermore, water is typically not a solvent for insoluble materials and water-insoluble materials. Suspended materials are substantially insoluble in water and dissolved materials are substantially soluble in water. The suspended materials have a particle size.

“De-toxify” or “de-toxification” includes rendering a target material, such as chemical and/or biological target material non-toxic or non-harmful to a living organism, such as, for example, human or other animal. The target material may be rendered non-toxic by converting the target material into a non-toxic or non-harmful form or species.

The term “fluid” refers to a liquid, gas or both.

A “halogen” is a nonmetal element from Group 17 IUPAC Style (formerly: VII, VIIA) of the periodic table, comprising fluorine (F), chlorine (Cl), bromine (Br), iodine (I), and astatine (At). The artificially created element 117, provisionally referred to by the systematic name ununseptium, may also be a halogen.

A “halide compound” is a compound having as one part of the compound at least one halogen atom and the other part the compound is an element or radical that is less electronegative (or more electropositive) than the halogen. The halide compound is typically a fluoride, chloride, bromide, iodide, or astatide compound. Many salts are halides having a halide anion. A halide anion is a halogen atom bearing a negative charge. The halide anions are fluoride (F⁻), chloride (Cl⁻), bromide (Br⁻), iodide (I⁻) and astatide (At⁻).

A “hydroxyl” generally refers to a chemical functional group containing an oxygen atom connected by a covalent bond to a hydrogen atom. When it appears in a chemical species, the hydroxyl group imparts some of the reactive and interactive properties of water (ionizability, hydrogen bonding, etc.). Chemical species containing one or more hydroxyl groups are typically referred to as “hydroxyl species”. The neutral form of the hydroxyl group is a hydroxyl radical. The anion form of the hydroxyl group (OH⁻) is called “an hydroxide” or “hydroxide anion”.

The term “hydrated species” generally refers to any of a class of compounds or other species containing chemically combined with water, whether occurring as a solid or a fluid component and whether occurring as a compound or charged species. In the case of some hydrates, as washing soda, Na₂CO₃.10H₂O, the water is loosely held and is easily lost on heating; in others, as sulfuric acid, SO₃.H₂O, or H₂SO₄, it is strongly held as water of constitution.

The term “inorganic material” generally refers to a chemical compound or other species that is not an organic material.

The term “insoluble” refers to materials that are intended to be and/or remain as solids in water. Insoluble materials are able to be retained in a device, such as a column, or be readily recovered from a batch reaction using physical means, such as filtration. Insoluble materials should be capable of prolonged exposure to water, over weeks or months, with little loss of mass.

Typically, a little loss of mass refers to less than about 5% mass loss of the insoluble material after a prolonged exposure to water.

An “ion” generally refers to an atom or group of atoms having a charge. The charge on the ion may be negative or positive.

“Organic carbons” or “organic material” generally refer to any compound of carbon except such binary compounds as carbon oxides, the carbides, carbon disulfide, etc.; such ternary compounds as the metallic cyanides, metallic carbonyls, phosgene, carbonyl sulfide, etc.; and the metallic carbonates, such as alkali and alkaline earth metal carbonates.

The term “oxidizing agent” generally refers to one or both of a chemical substance and physical process that transfers and/or assists in removal of one or more electrons from a substance. The substance having the one or more electrons being removed is oxidized. In regards to the physical process, the physical process may removal and/or may assist in the removal of one or more electrons from the substance being oxidized. For example, the substance to be oxidized can be oxidized by electromagnetic energy when the interaction of the electromagnetic energy with the substance be oxidized is sufficient to substantially remove one or more electrons from the substance. On the other hand, the interaction of the electromagnetic energy with the substance being oxidized may not be sufficient to remove one or more electrons, but may be enough to excite electrons to higher energy state, were the electron in the excited state can be more easily removed by one or more of a chemical substance, thermal energy, or such.

The terms “oxyanion” and/or “oxoanion” generally refers to anionic chemical compounds having a negative charge with a generic formula of AₓO_{y}^{z-} (where A represents a chemical element other than oxygen, “O” represents the element oxygen and x, y and z represent real numbers). In the embodiments having oxyanions as a chemical contaminant, “A” represents metal, metalloid, and/or non-metal elements. Examples for metal-based oxyanions include chromate, tungstate, molybdate, aluminates, zirconate, etc. Examples of metalloid-based oxyanions include arsenate, arsenite, antimonate, germanate, silicate, etc. Examples of non-metal-based oxyanions include phosphate, selemate, sulfate, etc. Preferably, the oxyanion includes oxyanions of elements having an atomic number of 7, 13 to 17, 22 to 25, 31 to 35, 40 to 42, 44, 45, 49 to 53, 72 to 75, 77, 78, 82, 83 85 and 92. These elements include These elements include nitrogen, aluminum, silicon, phosphorous, sulfur, chlorine, titanium, vanadium, chromium, manganese, arsenic, selenium, bromine, gallium, germanium, zirconium, niobium, molybdenum, ruthenium, rhodium, indium, tin, iodine, antimony, tellurium, hafnium, tantalum, tungsten, rhenium, iridium, platinum, lead, bismuth astatine, and uranium.

The terms “oxyspecies” and/or “oxospecies” generally refer to cationic, anionic, or neutral chemical compounds with a generic formula of AₓO_{y} (where A represents a chemical element other than oxygen, O represents the element oxygen and x and y represent real numbers). In the embodiments having oxyanions as a chemical contaminant, “A” represents metal, metalloid, and/or non-metal elements. An oxyanion or oxoanion are a type of oxyspecies or oxospecies.

The terms “pore volume” and “pore size”, respectively, refer to pore volume and pore size determinations made by any suite measure method. Preferably, the pore size and pore volume are determined by any suitable Barret-Joyner-Halenda method for determining pore size and volume. Furthermore, it can be appreciated that as used herein pore size and pore diameter can used interchangeably.

“Precipitation” generally refers to the removal of a dissolved target material in the form of an insoluble target material-laden rare earth composition. The target material-laden rare earth composition can comprise a target-laden cerium (IV) composition, a target-laden rare earth-containing additive composition, a target-laden rare composition comprising a rare earth other than cerium (IV), or a combination thereof. Typically, the target material-laden rare earth composition comprises an insoluble target material-laden rare earth composition. For example, “precipitation” includes processes, such as adsorption and absorption of the target material by one or more of the cerium (IV) composition, the rare earth-containing additive, or a rare earth other than cerium (IV). The target-material laden composition can comprise a +3 rare earth, such as cerium (III), lanthanum (III) or other lanthanoid having a +3 oxidation state.

A “principal species” generally refers to the major species in which a cation is present, under a specified set of conditions. Although usually applied to cations, the term “principal species” may be negatively charged or uncharged.

A “radical” generally refers to an atom or group of atoms that are joined together in some particular spatial structure and commonly take part in chemical reactions as a single unit. A radical is more generally an atom, molecule, or ion (group of atoms is probably ok) with one or more unpaired electrons. A radical may have a net positive or negative charge or be neutral.

“Rare earth” refers to one or more of yttrium, scandium, lanthanum, cerium, praseodymium, neodymium, samarium, europium, gadolinium, terbium, dysprosium, holmium erbium, thulium, ytterbium, and lutetium. As will be appreciated, lanthanum, cerium, praseodymium, neodymium, samarium, europium, gadolinium, terbium, dysprosium, holmium erbium, thulium, ytterbium, and lutetium are known as lanthanoids.

The terms “rare earth”, “rare earth-containing composition”, “rare earth-containing additive” and “rare earth-containing particle” refer both to singular and plural forms of the terms. By way of example, the term “rare earth” refers to a single rare earth and/or combination and/or mixture of rare earths and the term “rare earth-containing composition” refers to a single composition comprising a single rare earth and/or a mixture of differing rare earth-containing compositions containing one or more rare earths and/or a single composition containing one or more rare earths. The terms “rare earth-containing additive” and “rare earth-containing particle” are additives or particles including a single composition comprising a single rare earth and/or a mixture of differing rare earth-containing compositions containing one or more rare earths and/or a single composition containing one or more rare earths. The term “processed rare earth composition” refers not only to any composition containing a rare earth other than non-compositionally altered rare earth-containing minerals. In other words, as used herein “processed rare earth-containing composition” excludes comminuted naturally occurring rare earth-containing minerals. However, as used herein “processed rare earth-containing composition” includes a rare earth-containing mineral where one or both of the chemical composition and chemical structure of the rare earth-containing portion of the mineral has been compositionally altered. More specifically, a comminuted naturally occurring bastnasite would not be considered a processed rare earth-containing composition and/or processed rare earth-containing additive. However, a synthetically prepared bastnasite or a rare earth-containing composition prepared by a chemical transformation of naturally occurring bastnasite would be considered a processed rare earth-containing composition and/or processed rare earth-containing additive. The processed rare earth and/or rare-containing composition and/or additive are, in one application, not a naturally occurring mineral but synthetically manufactured. Exemplary naturally occurring rare earth-containing minerals include bastnasite (a carbonate-fluoride mineral) and monazite. Other naturally occurring rare earth-containing minerals include aeschynite, allanite, apatite, britholite, brockite, cerite, fluorcerite, fluorite, gadolinite, parisite, stillwellite, synchisite, titanite, xenotime, zircon, and zirconolite. Exemplary uranium minerals include uraninite (UO₂), pitchblende (a mixed oxide, usually U₃O₈), brannerite (a complex oxide of uranium, rare-earths, iron and titanium), coffinite (uranium silicate), carnotite, autunite, davidite, gummite, torbernite and uranophane. In one formulation, the rare earth-containing composition is substantially free of one or more elements in Group 1, 2, 4-15, or 17 of the Periodic Table, a radioactive species, such as uranium, sulfur, selenium, tellurium, and polonium.

The term “reducing agent”, “reductant” or “reducer” generally refers to an element or compound that donates one or more electrons to another species or agent this is reduced. In the reducing process, the reducing agent is oxidized and the other species, which accepts the one or more electrons, is reduced.

The terminology “removal”, “remove” or “removing” includes the sorbtion, precipitation, conversion, detoxification, deactivation, and/or combination thereof of a target material contained in a water and/or water handling system.

The term “soluble” refers to a material that readily dissolves in a fluid, such as water or other solvent. For purposes of this disclosure, it is anticipated that the dissolution of a soluble material would necessarily occur on a time scale of minutes rather than days. For the material to be considered to be soluble, it is necessary that the material/composition has a significant solubility in the fluid such that upwards of about 5 g of the material will dissolve in about one liter of the fluid and be stable in the fluid.

The term “sorb” refers to adsorption, absorption or both adsorption and absorption.

The term “suspension” refers to a heterogeneous mixture of a solid, typically in the form of particulates dispersed in a liquid. In a suspension, the solid particulates are in the form of a discontinuous phase dispersed in a continuous liquid phase. The term “colloid” refers to a suspension comprising solid particulates that typically do not settle-out from the continuous liquid phase due to gravitational forces. A “colloid” typically refers to a system having finely divided particles ranging from about 10 to 10,000 angstroms in size, dispersed within a continuous medium. As used hereinafter, the terms “suspension”, “colloid” or “slurry” will be used interchangeably to refer to one or more materials dispersed and/or suspended in a continuous liquid phase.

The term “surface area” refers to surface area of a material and/or substance determined by any suitable surface area measurement method. Preferably, the surface area is determined by any suitable Brunauer-Emmett-Teller (BET) analysis technique for determining the specific area of a material and/or substance.

The term “water handling system” refers to any system containing, conveying, manipulating, physically transforming, chemically processing, mechanically processing, purifying, generating and/or forming the aqueous composition, treating, mixing and/or co-mingling the aqueous composition with one or more other waters and any combination thereof.

A “water handling system component” refers to one or more unit operations and/or pieces of equipment that process and/or treat water (such as a holding tank, reactor, purifier, treatment vessel or unit, mixing vessel or element, wash circuit, precipitation vessel, separation vessel or unit, settling tank or vessel, reservoir, pump, aerator, cooling tower, heat exchanger, valve, boiler, filtration device, solid liquid and/or gas liquid separator, nozzle, tender, and such), conduits interconnecting the unit operations and/or equipment (such as piping, hoses, channels, aqua-ducts, ditches, and such) and the water conveyed by the conduits. The water handling system components and conduits are in fluid communication.

The terms “water” and “water handling system” will be used interchangeably. That is, the term “water” may used to refer to “a water handling system” and the term “water handling system” may be used to refer to the term “water”.

The preceding is a simplified summary of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. metal or metalloid having an atomic number selecting from the group consisting of 5, 13, 22-33, 40-52, 72-84, and 89-94

### BRIEF DESCRIPTION OF THE DRAWINGS

The accompanying drawings, which are incorporated in and constitute a part of the specification, illustrate embodiments of the disclosure and together with the general description of the disclosure given above and the detailed description given below, serve to explain the principles of the disclosure.

FIG. 1 depicts a water handling system and method according to an embodiment;

FIGS. 2A-E depict prior art Pourbaix diagrams under specified conditions for primary species of boron;

FIGS. 3A-E depict prior art Pourbaix diagrams under specified conditions for primary species of aluminum;

FIGS. 4A-D depict prior art Pourbaix diagrams under specified conditions for primary species of thallium;

FIGS. 5A-E depict prior art Pourbaix diagrams under specified conditions for primary species of vanadium;

FIGS. 6A-E depict prior art Pourbaix diagrams under specified conditions for primary species of chromium;

FIGS. 7A-F depict prior art Pourbaix diagrams under specified conditions for primary species of manganese;

FIGS. 8A-F depict prior art Pourbaix diagrams under specified conditions for primary species of iron;

FIGS. 9A-E depict prior art Pourbaix diagrams under specified conditions for primary species of cobalt;

FIGS. 10A-E depict prior art Pourbaix diagrams under specified conditions for primary species of nickel;

FIGS. 11A-E depict prior art Pourbaix diagrams under specified conditions for primary species of copper;

FIGS. 12A-D depict prior art Pourbaix diagrams under specified conditions for primary species of zinc;

FIGS. 13A-B depict prior art Pourbaix diagrams under specified conditions for primary species of gallium;

FIG. 14 depicts a prior art Pourbaix diagram under specified conditions for primary species of germanium;

FIGS. 15A-D depict prior art Pourbaix diagrams under specified conditions for primary species of arsenic;

FIGS. 16A-D depict prior art Pourbaix diagrams under specified conditions for primary species of zirconium;

FIGS. 17A-D depict prior art Pourbaix diagrams under specified conditions for primary species of niobium;

FIGS. 18A-C depict prior art Pourbaix diagrams under specified conditions for primary species of molybdenum;

FIGS. 19A-F depict prior art Pourbaix diagrams under specified conditions for primary species of technetium;

FIGS. 20A-D depict prior art Pourbaix diagrams under specified conditions for primary species of ruthenium;

FIGS. 21A-B depicts a prior art Pourbaix diagram under specified conditions for primary species of rhodium;

FIGS. 22A-C depict prior art Pourbaix diagrams under specified conditions for primary species of palladium;

FIGS. 23A-E depict prior art Pourbaix diagrams under specified conditions for primary species of silver;

FIGS. 24A-C depict prior art Pourbaix diagrams under specified conditions for primary species of cadmium;

FIGS. 25A-B depict prior art Pourbaix diagrams under specified conditions for primary species of indium;

FIGS. 26A-E depict prior art Pourbaix diagrams under specified conditions for primary species of tin;

FIGS. 27A-D depict prior art Pourbaix diagrams under specified conditions for primary species of antimony;

FIG. 28 depicts a prior art Pourbaix diagram under specified conditions for primary species of tellurium;

FIG. 29 depicts a prior art Pourbaix diagram under specified conditions for primary species of hafnium;

FIG. 30 depicts a prior art Pourbaix diagram under specified conditions for primary species of lead;

FIGS. 31A-B depict prior art Pourbaix diagrams under specified conditions for primary species of tungsten;

FIGS. 32A-B depict prior art Pourbaix diagrams under specified conditions for primary species of rhenium;

FIG. 33 depicts a prior art Pourbaix diagram under specified conditions for primary species of osmium;

FIG. 34 depicts a prior art Pourbaix diagram under specified conditions for primary species of uranium;

FIGS. 35A-B depict prior art Pourbaix diagrams under specified conditions for primary species of platinum;

FIGS. 36A-C depict prior art Pourbaix diagrams under specified conditions for primary species of gold;

FIGS. 37A-D depict prior art Pourbaix diagrams under specified conditions for primary species of mercury;

FIGS. 38A-E depict prior art Pourbaix diagrams under specified conditions for primary species of lead;

FIG. 39 depicts a prior art Pourbaix diagram under specified conditions for primary species of lead;

FIGS. 40A-C depict prior art Pourbaix diagrams under specified conditions for primary species of bismuth;

FIGS. 41A-B depict prior art Pourbaix diagrams under specified conditions for primary species of polonium;

FIGS. 42A-B depict prior art Pourbaix diagrams under specified conditions for primary species of actinium;

FIGS. 43A-E depict prior art Pourbaix diagrams under specified conditions for primary species of thorium;

FIGS. 44A-B depict prior art Pourbaix diagrams under specified conditions for primary species of protactinium;

FIGS. 45A-G depict prior art Pourbaix diagrams under specified conditions for primary species of uranium;

FIGS. 46A-E depict prior art Pourbaix diagrams under specified conditions for primary species of neptunium;

FIGS. 47A-F depict prior art Pourbaix diagrams under specified conditions for primary species of plutonium;

FIG. 48 is a plot of loading capacity (mg/g) (vertical axis) versus arsenic concentration (g/L) (horizontal axis);

FIG. 49 is a plot of final arsenic concentration (mg/L) (vertical axis) versus molar ratio of cerium:arsenic (horizontal axis);

FIG. 50 is a plot of final arsenic concentration (mg/L) (vertical axis) versus molar ratio of cerium to arsenic (horizontal axis);

FIG. 51 is a series of XRD patterns for precipitates formed upon addition of Ce (III) or Ce (IV) solutions to sulfide-arsenite solutions and sulfate-arsenate solutions;

FIG. 52 is a plot of arsenic sequestered (micromoles) (vertical axis) and cerium added (micromoles) (horizontal axis);

FIG. 53 is a series of XRD patterns exhibiting the structural differences between gasparite (CeAsO₄) and the novel trigonal phase CeAsO₄.(H₂O)_{X};

FIG. 54 is a series of XRD patterns exhibiting the structural differences among trigonal CeAsO₄.(H₂O)_{X} (experimental), trigonal CeAsO₄.(H₂O)_{X} (simulated), and trigonal BiPO₄.(H₂O)_{0.67} (simulated);

FIG. 55 is a plot of arsenic capacity (mg As/g CeO₂) against various solution compositions;

FIG. 56 is a plot of arsenic (V) concentration (ppb) against bed volumes treated;

FIG. 57 is a plot of mg As/g CeO₂ (vertical axis) against test solution conditions (horizontal axis);

FIG. 58 depicts a prior art Pourbaix diagram under specified conditions for primary species of bismuth;

FIG. 59 depicts a prior art Pourbaix diagram under specified conditions for primary species of aluminum;

FIG. 60 depicts a prior art Pourbaix diagram under specified conditions for primary species of cobalt;

FIG. 61 depicts a prior art Pourbaix diagram under specified conditions for primary species of chromium;

FIG. 62 depicts a prior art Pourbaix diagram under specified conditions for primary species of manganese;

FIG. 63 depicts a prior, Pourbaix diagram under specified conditions for primary species of copper;

FIG. 64 depicts a prior art Pourbaix diagram under specified conditions for primary species of zirconium; and

FIG. 65 depicts a prior art Pourbaix diagram under specified conditions for primary species of zinc.

### DETAILED DESCRIPTION

### General Overview

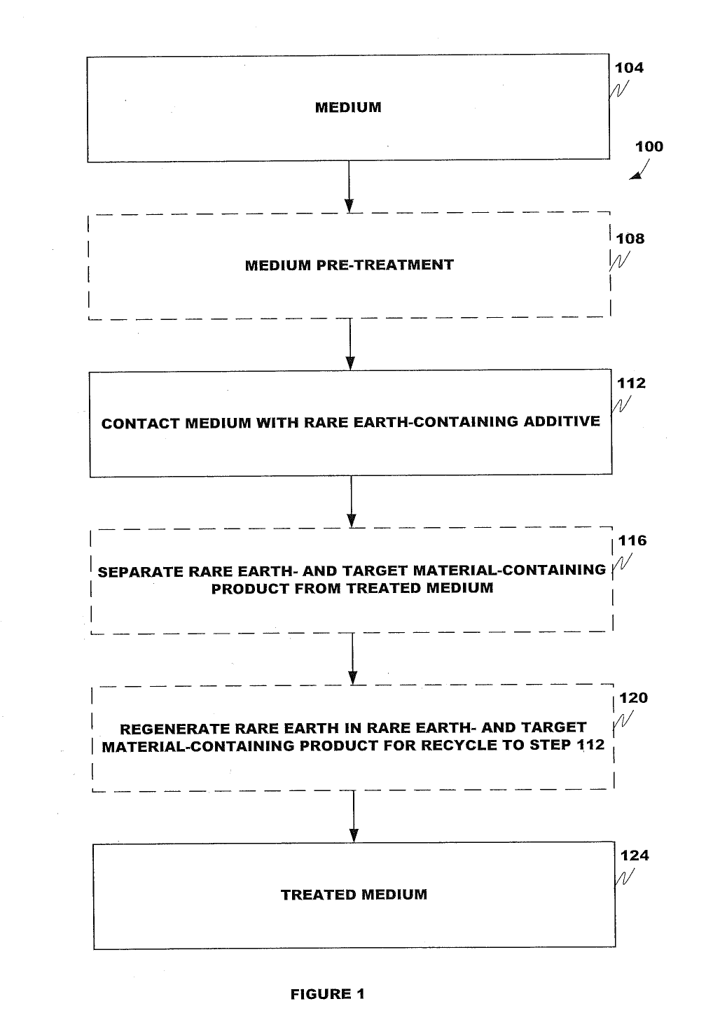

As illustrated by FIG. 1, the present disclosure is directed to removal from and/or detoxification of water, a water-handling system, or an aqueous medium or other aqueous media, of a target material or target material-containing species, such as a pollutant or contaminant, by a rare earth-containing composition, additive, or particle. Preferably, the rare earth-containing composition, additive, or particle is a processed rare earth-containing composition, additive or particle. In some embodiments, the target material or target material-containing species is removed and/or detoxified by forming a target material-laden rare earth-containing composition comprising the target material, target material-containing species, or a derivative thereof. The target material is one or more of an inorganic oxyspecies (other than an oxyanion), a hydroxyl species, which may comprise a hydroxide ion or hydroxyl radical, a hydrated species, or a combination thereof. The rare earth-containing composition may be soluble or insoluble and commonly is cerium, a cerium-containing compound, lanthanum, a lanthanum-containing compound, or a mixture thereof. A more common rare earth-containing composition is cerium (IV) oxide, cerium (III) oxide, a cerium (IV) salt, a cerium (III) salt, lanthanum (III) oxide, a lanthanum (III) salt, or a mixture thereof. The target material-laden rare earth composition comprises one or more of the target material and/or species thereof or a portion of the target material and/or species thereof.

### Rare Earth-Containing Additive

The rare earth-containing composition, additive, and/or particles may be water-soluble, water-insoluble, a combination of water-soluble and/or water-insoluble rare earth-containing compositions, additives, and/or particles, a partially water-soluble rare earth-containing composition, additive, and/or particles, and/or a partially water-insoluble rare earth-containing composition, additive and/or particles.

Commonly, the rare earth-containing composition, additive, and/or particles comprise cerium, in the form of a cerium-containing compound and/or dissociated ionic form of cerium, lanthanum, in the form of a lanthanum-containing compound and/or dissociated ionic form of lanthanum, or a mixture thereof. More common rare earth-containing composition, additives, and particles are cerium (IV) oxides, cerium (III) oxides, cerium (IV) salts, cerium (III) salts, lanthanum (III) oxides, lanthanum (III) salts, or mixtures and/or combinations thereof.

The rare earth-containing composition, additive, and/or particles may contain one or more rare earths, and be in any suitable form, such as a free-flowing powder, a liquid formulation, or other form. Examples of rare earth-containing compositions, additives, and particles include cerium (III) oxides, cerium (IV) oxides, ceric (IV) salts (such as ceric chloride, ceric bromide, ceric iodide, ceric sulfate, ceric nitrate, ceric chlorate, and ceric oxalate), cerium (III) salts (such as cerous chloride, cerous bromide, cerous iodide, cerous sulfate, cerous nitrate, cerous chlorate, cerous chloride, and cerous oxalate), lanthanum (III) oxides, a lanthanum (III) salts (such as lanthanum chloride, lanthanum bromide, lanthanum iodide, lanthanum chlorate, lanthanum sulfate, lanthanum oxalate, and lanthanum nitrate), and mixtures thereof.

The rare earth and/or rare earth-containing composition in the rare earth-containing additive can be rare earths in elemental, ionic or compounded forms. The rare earth and/or rare earth-containing composition can be contained in a fluid, such as water, or in the form of nanoparticles, particles larger than nanoparticles, agglomerates, or aggregates or combinations and/or mixtures thereof. The rare earth and/or rare earth-containing composition can be supported or unsupported. The rare earth and/or rare earth-containing composition can comprise one or more rare earths. The rare earths may be of the same or different valence and/or oxidation states and/or numbers. The rare earths can be a mixture of different rare earths, such as two or more of yttrium, scandium, cerium, lanthanum, praseodymium, and neodymium.

The rare earth and/or rare earth-containing composition is, in one application, a processed rare earth-containing composition and does not include, or is substantially free of, a naturally occurring and/or derived mineral. In one formulation, the rare earth and/or rare earth-containing composition is substantially free of one or more elements in Group 1, 2, 4-15, or 17 of the Periodic Table, and is substantially free of a radioactive species, such as uranium, sulfur, selenium, tellurium, and polonium.

In some formulations, the rare earth-containing composition comprises one or more rare earths. While not wanting to be limited by example, the rare earth-containing composition can comprise a first rare earth and a second rare earth. The first and second rare earths may have the same or differing atomic numbers. In some formulations, the first rare earth comprises cerium (III) and the second rare earth comprises a rare earth other than cerium (III). The rare earth other than cerium (III) can be one or more trivalent rare earths, cerium (IV), or any other rare other than trivalent cerium. For example, a mixture of rare earth-containing compositions can comprise a first rare earth having a +3 oxidation state and a second rare earth having a +4 oxidation state. In some embodiments, the first and second rare earths are the same and comprise cerium. More specifically, the first rare earth comprises cerium (III) and the second rare earth comprises cerium (IV). Preferably, the cerium is primarily in the form of a water-soluble cerium (III) salt, with the remaining cerium being present as cerium oxide, a substantially water insoluble cerium composition.

In one formulation, the cerium is primarily in the form of cerium (IV) oxide while the remaining cerium is present as a dissociated cerium (III) salt. For rare earth-containing compositions having a mixture of +3 and +4 oxidations states commonly at least some of the rare earth has a +4 oxidation sate, more commonly at least most of the rare earth has a +4 oxidation state, more commonly at least about 75 wt % of the rare earth has a +4 oxidation state, even more commonly at least about 90 wt % of the rare earth has a +4 oxidation state, and yet even more commonly at least about 98 wt % of the rare earth has a +4 oxidation state. The rare earth-containing composition commonly includes at least about 1 ppm, more commonly at least about 10 ppm, and even more commonly at least about 100 ppm of a cerium (III) salt. While in some embodiments, the rare earth-containing composition includes at least about 0.0001 wt % cerium (III) salt, preferably at least about 0.001 wt % cerium (III) salt and even more preferably at least about 0.01 wt % cerium (III) salt calculated as cerium oxide. Moreover, in some embodiments, the rare earth composition-containing commonly has at least about 20,000 ppm cerium (IV), more commonly at least about 100,000 ppm cerium (IV) and even more commonly at least about 250,000 ppm cerium (IV).

In some formulations, the molar ratio of cerium (IV) to cerium (III) is about 1 to about 1×10⁻⁶, more commonly is about 1 to about 1×10⁻⁵, even more commonly is about 1 to about 1×10⁻⁴, yet even more commonly is about 1 to about 1×10³, still yet even more commonly is about 1 to about 1×10⁻², still yet even more commonly is about 1 to about 1×10⁻¹, or still yet even more commonly is about 1 to about 1. Moreover, in some formulations the molar ratio of cerium (III) to cerium (IV) is about 1 to about 1×10⁻⁶, more commonly is about 1 to about 1×10⁵, even more commonly is about 1 to about 1×10⁻⁴, yet even more commonly is about 1 to about 1×10⁻³, still yet even more commonly is about 1 to about 1×10⁻², still yet even more commonly is about 1 to about 1×10⁻¹, or still yet even more commonly is about 1 to about 1. Further, these molar ratios apply for any combinations of soluble and insoluble forms of Ce(III) and soluble and insoluble forms of Ce(IV).

In one formulation, the cerium is primarily in the form of a dissociated cerium (III) salt, with the remaining cerium being present as cerium (IV) oxide. For rare earth-containing compositions having a mixture of +3 and +4 oxidations states commonly at least some of the rare earth has a +3 oxidation rate, more commonly at least most of the rare earth has a +3 oxidation state, more commonly at least about 75 wt % of the rare earth has a +3 oxidation state, even more commonly at least about 90 wt % of the rare earth has a +3 oxidation state, and yet even more commonly at least about 98 wt % of the rare earth has a +3 oxidation state. The rare earth-containing composition commonly includes at least about 1 ppm, more commonly at least about 10 ppm, and even more commonly at least about 100 ppm cerium (IV) oxide. While in some embodiments, the rare earth-containing composition includes at least about 0.0001 wt % cerium (IV), preferably at least about 0.001 wt % cerium (IV) and even more preferably at least about 0.01 wt % cerium (IV) calculated as cerium oxide. Moreover, in some embodiments, the rare earth composition-containing commonly has at least about 20,000 ppm cerium (III), more commonly at least about 100,000 ppm cerium (III) and even more commonly at least about 250,000 ppm cerium (III).

In some formulations, the molar ratio of cerium (III) to cerium (IV) is about 1 to about 1×10⁻⁶, more commonly is about 1 to about 1×10⁻⁵, even more commonly is about 1 to about 1×10⁻⁴, yet even more commonly is about 1 to about 1×10⁻³, still yet even more commonly is about 1 to about 1×10⁻², still yet even more commonly is about 1 to about 1×10⁻¹, or still yet even more commonly is about 1 to about 1. Moreover, in some formulations the molar ratio of cerium (IV) to cerium (III) is aboutl to about 1×10⁻⁶, more commonly is about 1 to about 1×10⁻⁵, even more commonly is about 1 to about 1×10⁻⁴, yet even more commonly is about 1 to about 1×10⁻³, still yet even more commonly is about 1 to about 1×10⁻², still yet even more commonly is about 1 to about 1×10⁻¹, or still yet even more commonly is about 1 to about 1. Further, these molar ratios apply for any combinations of soluble and insoluble forms of Ce(III) and soluble and insoluble forms of Ce(IV).

Having a mixture of +3 and +4 cerium, preferably in the faun of a dissociated cerium (III) salt and a cerium (IV) composition, can be advantageous. Preferred, non-limiting examples of cerium (IV) compositions are: cerium (IV) dioxide, cerium (IV) oxide, cerium (IV) oxyhydroxide, cerium (IV) hydroxide, and hydrous cerium (IV) oxide. For example, having dissociated cerium (III) provides for the opportunity to take advantage of cerium (III) solution sorbtion and/or precipitation chemistries, such as, but not limited to, the formation of insoluble cerium oxyanion compositions. Furthermore, having a cerium (IV) composition presents, provides for the opportunity to take advantage of sorbtion and oxidation/reduction chemistries of cerium (IV), such as, the strong interaction of cerium (IV) with compositions such as metal and/or metalloid target material-containing species. Commonly, cerium (IV) is also referred to as cerium (+4) and/or eerie.

In one formulation, the rare earth composition comprises a water-soluble rare earth composition having a +3 oxidation state. Non-limiting examples of suitable water-soluble rare earth compositions include rare earth chlorides, rare earth bromides, rare earth iodides, rare earth astatides, rare earth nitrates, rare earth sulfates, rare earth oxalates, rare earth perchlorates, rare earth carbonates, and mixtures thereof. In one formulation, the rare earth-containing additive includes water-soluble cerium (III) and lanthanum (III) compositions. In some applications, the water-soluble cerium composition comprises cerium (III) chloride, CeCl₃. Commonly, cerium (III) is also referred to as cerium (+3) and/or cerous.

More preferably, the rare earth composition comprises a water-soluble cerium +3 composition. Non-limiting examples of suitable water-soluble cerium +3 compositions are cerium (III) chloride, cerium (III) nitrate, cerium (III) sulfate, cerium (III) oxalate, and a mixture thereof.

In some formulations, the water-soluble cerium (III) composition may comprise, in addition to cerium, one or more other water soluble rare earths. The rare earths other than cerium include yttrium, scandium, lanthanum, praseodymium, neodymium, samarium, europium, gadolinium, terbium, dysprosium, holmium, erbium, thulium, ytterbium, and lutetium. The other rare earths may and may not be water-soluble.

In some formulations, the water-soluble cerium-containing additive contains water-soluble cerium (III) and one or more other water-soluble trivalent rare earths (such as, but not limited to, one or more of lanthanum, neodymium, praseodymium and samarium). The molar ratio of cerium (III) to the other trivalent rare earths is commonly at least about 1:1, more commonly at least about 10:1, more commonly at least about 15:1, more commonly at least about 20:1, more commonly at least about 25:1, more commonly at least about 30:1, more commonly at least about 35:1, more commonly at least about 40:1, more commonly at least about 45:1, and more commonly at least about 50:1.

In some formulations, the water-soluble cerium-containing additive contains cerium (III) and one or more of water-soluble lanthanum, neodymium, praseodymium and samarium. The water-soluble rare earth-containing additive commonly includes at least about 0.01 wt. % of one or more of lanthanum, neodymium, praseodymium and samarium. The water-soluble rare earth-containing additive commonly has on a dry basis no more than about 10 wt. % La, more commonly no more than about 9 wt. % La, even more commonly no more than about 8 wt. % La, even more commonly no more than about 7 wt. % La, even more commonly no more than about 6 wt. % La, even more commonly no more than about 5 wt. % La, even more commonly no more than about 4 wt. % La, even more commonly no more than about 3 wt. % La, even more commonly no more than about 2 wt. % La, even more commonly no more than about 1 wt. % La, even more commonly no more than about 0.5 wt. % La, and even more commonly no more than about 0.1 wt. % La. The water-soluble rare earth-containing additive commonly has on a dry basis no more than about 8 wt. % Nd, more commonly no more than about 7 wt. % Nd, even more commonly no more than about 6 wt. % Nd, even more commonly no more than about 5 wt. % Nd, even more commonly no more than about 4 wt. % Nd, even more commonly no more than about 3 wt. % Nd, even more commonly no more than about 2 wt. % Nd, even more commonly no more than about 1 wt. % Nd, even more commonly no more than about 0.5 wt. % Nd, and even more commonly no more than about 0.1 wt. % Nd. The water-soluble rare earth-containing additive commonly has on a dry basis no more than about 5 wt. % Pr, more commonly no more than about 4 wt. % Pr, even more commonly no more than about 3 wt. % Pr, even more commonly no more than about 2.5 wt. % Pr, even more commonly no more than about 2.0 wt. % Pr, even more commonly no more than about 1.5 wt. % Pr, even more commonly no more than about 1.0 wt. % Pr, even more commonly no more than about 0.5 wt. % Pr, even more commonly no more than about 0.4 wt. % Pr, even more commonly no more than about 0.3 wt. % Pr, even more commonly no more than about 0.2 wt. % Pr, and even more commonly no more than about 0.1 wt. % Pr. The water-soluble rare earth-containing additive commonly has on a dry basis no more than about 3 wt. % Sm, more commonly no more than about 2.5 wt. % Sm, even more commonly no more than about 2.0 wt. % Sm, even more commonly no more than about 1.5 wt. % Sm, even more commonly no more than about 1.0 wt. % Sm, even more commonly no more than about 0.5 wt. % Sm, even more commonly no more than about 0.4 wt. % Sm, even more commonly no more than about 0.3 wt. % Sm, even more commonly no more than about 0.2 wt. % Sm, even more commonly no more than about 0.1 wt. % Sm, even more commonly no more than about 0.05 wt. % Sm, and even more commonly no more than about 0.01 wt. % Sm.

In some formulations, the water-soluble cerium-containing additive contains water-soluble cerium (III) and one or more other water-soluble trivalent rare earths (such as one or more of lanthanum, neodymium, praseodymium and samarium). The molar ratio of cerium (III) to the other trivalent rare earths is commonly at least about 1:1, more commonly at least about 10:1, more commonly at least about 15:1, more commonly at least about 20:1, more commonly at least about 25:1, more commonly at least about 30:1, more commonly at least about 35:1, more commonly at least about 40:1, more commonly at least about 45:1, and more commonly at least about 50:1.

In one formulation, the rare earth-containing additive consists essentially of a water-soluble cerium (III) salt, such as a cerium (III) chloride, cerium (III) bromide, cerium (III) iodide, cerium (III) astatide, cerium perhalogenates, cerium (III) carbonate, cerium (III) nitrate, cerium (III) sulfate, cerium (III) oxalate and mixtures thereof. The rare earth in this formulation commonly is primarily cerium (III), more commonly at least about 75 mole % of the rare earth content of the rare earth-containing additive is cerium (III), that is no more than about 25 mole % of the rare earth content of the rare earth-containing additive comprises rare earths other than cerium (III). Even more commonly, the rare earth in this formulation commonly is primarily at least about 80 mole % cerium (III), yet even more commonly at least about 85 mole % cerium (III), still yet even more commonly at least about 90 mole % cerium (III), and yet still even more commonly at least about 95 mole % cerium (III).

The rare earth composition may comprise a water insoluble composition, such as a water-insoluble rare earth oxide, oxyhydroxide, and/or hydrous oxide. The insoluble rare earth composition may be in the form of a dispersion, suspension or slurry of rare earth particulates. The rare earth particulates can have an average particle size ranging from the sub-micron, to micron or greater than micron. The insoluble rare earth composition may have a surface area of at least about 1 m²/g. Commonly, the insoluble rare earth has a surface area of at least about 70 m²/g. In another formulation, the insoluble rare earth composition may have a surface area from about 25 m²/g to about 500 m²/g.

In some formulations, the rare earth composition may be agglomerated. Commonly, the rare earth composition may be in the form of agglomerate, the agglomerate comprising a polymeric binder and rare earth-containing composition.

In one formulation, the rare earth-containing additive comprises a rare earth and/or rare earth-containing composition comprising at least some water insoluble cerium (IV) and water-soluble cerium (III) and/or lanthanum (III). The rare earth and/or rare earth-containing composition comprise at least some water-soluble cerium (III), typically in the form of water-soluble cerium (III) salt. Commonly, the rare earth-containing additive comprises more than about 1 wt. % of a water-soluble cerium (III) composition, more commonly more than about 5 wt. % of a water-soluble cerium (III) composition, even more commonly more than about 10 wt. % of a water-soluble cerium (III) composition, yet even more commonly more than about 20 wt. % of a water-soluble cerium (III) composition, still yet even more commonly more than about 30 wt. % of a water-soluble cerium (III) composition, or still yet even more commonly more than about 40 wt. % of a water-soluble cerium (III) composition.

In accordance with some formulations, the rare earth-containing additive typically comprises more than about 50 wt. % of a water-soluble cerium (III) composition, more typically the rare earth-containing additive comprises more than about 60 wt. % of a water-soluble cerium (III) composition, even more typically the rare earth-containing additive comprises more than about 65 wt. % of a water-soluble cerium (III) composition, yet even more typically the rare earth-containing additive comprises more than about 70 wt. % of a water-soluble cerium (III) composition, still yet even more typically the rare earth-containing additive comprises more than about 75 wt. % of a water-soluble cerium (III) composition, still yet even more typically the rare earth-containing additive comprises more than about 80 wt. % of a water-soluble cerium (III) composition, still yet even more typically the rare earth-containing additive comprises more than about 85 wt. % of a water-soluble cerium (III) composition, still yet even more typically the rare earth-containing additive comprises more than about 90 wt. % of a water-soluble cerium (III) composition, still yet even more typically the rare earth-containing additive comprises more than about 95 wt. % of a water-soluble cerium (III) composition, still yet even more typically the rare earth-containing additive comprises more than about 98 wt. % of a water-soluble cerium (III) composition, still yet even more typically the rare earth-containing additive comprises more than about 99 wt. % of a water-soluble cerium (III) composition, or yet still eve more typically comprises about 100 wt. % of a water-soluble cerium (III) composition.

In some formulations, the rare earth-containing additive comprises one or more nitrogen-containing materials. The one or more nitrogen-containing materials, commonly, comprise one or more of ammonia, an ammonium-containing composition, a primary amine, a secondary amine, a tertiary amine, an amide, a cyclic amine, a cyclic amide, a polycyclic amine, a polycyclic amide, and combinations thereof. The nitrogen-containing materials are typically less than about 1 ppm, less than about 5 ppm, less than about 10 ppm, less than about 25 ppm, less than about 50 ppm, less about 100 ppm, less than about 200 ppm, less than about 500 ppm, less than about 750 ppm or less than about 1000 ppm of the water-soluble rare earth-containing additive. Commonly, the rare earth-containing additive comprises a water-soluble cerium (III) and/or lanthanum (III) composition. More commonly, the rare earth-containing additive comprises cerium (III) chloride. The rare earth-containing additive is typically dissolved in a liquid. The liquid is the rare earth-containing additive is dissolved in is preferably water.

In some formulations, the rare earth-containing additive is in the form of one or more of: an aqueous solution containing substantially dissociated, dissolved forms of the rare earths and/or rare earth-containing compositions; free flowing granules, powder, particles, and/or particulates of rare earths and/or rare earth-containing compositions containing at least some water-soluble cerium (III); free flowing aggregated granules, powder, particles, and/or particulates of rare earths and/or rare earth-containing compositions substantially free of a binder and containing at least some water-soluble cerium (III); free flowing agglomerated granules, powder, particles, and/or particulates comprising a binder and rare earths and/or rare earth-containing compositions one or both of in an aggregated and non-aggregated form and containing at least some water-soluble cerium (III); rare earths and/or rare earth-containing compositions containing at least some water-soluble cerium (III) and supported on substrate; and combinations thereof.

Regarding particulate forms of rare earth-containing compositions, the particles, in one formulation, have a particle size may be from about 1 nanometer to about 1000 nanometers. In another embodiment the particles may have a particle size less than about 1 nanometer. In yet another embodiment the particles may have a particle size from about 1 micrometer to about 1,000 micrometers.

Regarding rare earths and/or rare earth-containing compositions supported on a substrate, suitable substrates can include porous and fluid permeable solids having a desired shape and physical dimensions. The substrate, for example, can be a sintered ceramic, sintered metal, micro-porous carbon, glass fiber, cellulosic fiber, alumina, gamma-alumina, activated alumina, acidified alumina, a metal oxide containing labile anions, crystalline alumino-silicate such as a zeolite, amorphous silica-alumina, ion exchange resin, clay, ferric sulfate, porous ceramic, and the like. Such substrates can be in the form of mesh, such as screens, tubes, honeycomb structures, monoliths, and blocks of various shapes, including cylinders and toroids. The structure of the substrate will vary depending on the application. Suitable structural forms of the substrate can include a woven substrate, non-woven substrate, porous membrane, filter, fabric, textile, or other fluid permeable structure. The rare earth-containing additive can be incorporated into or coated onto a filter block or monolith for use as a filter, such as a cross-flow type filter. The rare earth and/or rare earth-containing additive can be in the form of particles coated on to or incorporated in the substrate. In some configurations, the rare earth and/or rare earth-containing additive can be ionically substituted for cations in the substrate. Typically, the rare earth-coated substrate comprises at least about 0.1% by weight, more typically 1% by weight, more typically at least about 5% by weight, more typically at least about 10% by weight, more typically at least about 15% by weight, more typically at least about 20% by weight, more typically at least about 25% by weight, more typically at least about 30% by weight, more typically at least about 35% by weight, more typically at least about 40% by weight, more typically at least about 45% by weight, and more typically at least about 50% by weight rare earth and/or rare earth-containing composition. Typically, the rare earth-coated substrate includes no more than about 95% by weight, more typically no more than about 90% by weight, more typically no more than about 85% by weight, more typically no more than about 80% by weight, more typically no more than about 75% by weight, more typically no more than about 70% by weight, and even more typically no more than about 65% by weight rare earth and/or rare earth-containing composition.

In some formulations, the rare earth-containing additive includes a rare earth-containing composition supported on, coated on, or incorporated into a substrate, preferably the rare earth-containing composition is in the form of particulates. The rare earth-containing particulates can, for example, be supported or coated on the substrate with or without a binder. The binder may be any suitable binder, such as those set forth herein.

Further regarding formulations comprising the rare earth-containing additive comprising rare earth-containing granules, powder, particles, and/or particulates agglomerated and/or aggregated together with or without a binder, such formulations commonly have a mean, median, or P₉₀ particle size of at least about 1 more commonly at least about 5 μm, more commonly at least about 10 μm, still more commonly at least about 25 μm. In some formulations, the rare earth-containing agglomerates or aggregates have a mean, median, or P₉₀ particle size distribution from about 100 to about 5,000 microns; a mean, median, or P₉₀ particle size distribution from about 200 to about 2,500 microns; a mean, median, or P₉₀ particle size distribution from about 250 to about 2,500 microns; or a mean, median, or P₉₀ particle size distribution from about 300 to about 500 microns. In other formulations, the agglomerates and/or aggregates can have a mean, median, or P₉₀ particle size distribution of at least about 100 nm, specifically at least about 250 nm, more specifically at least about 500 nm, even more specifically at least about 1 μm and yet even more specifically at least about 0.5 nm, the mean, median, or P₉₀ particle size distribution of the agglomerates and/or aggregates can be up to about 1 micron or more. Moreover, the rare earth-containing particulates, individually and/or in the form of agglomerates and/or aggregates, can have in some cases a surface area of at least about 5 m²/g, in other cases at least about 10 m²/g, in other cases at least about 70 m²/g, in yet other cases at least about 85 m²/g, in still yet other cases at least about 100 m²/g, in still yet other cases at least about 115 m²/g, in still yet other cases at least about 125 m²/g, in still yet other cases at least about 150 m²/g, in still yet other cases at least 300 m²/g, and in still yet other cases at least about 400 m²/g. In some configurations, the rare earth-containing particulates, individually and/or in the form of agglomerates or aggregates commonly can have a surface area from about 50 to about 500 m²/g, or more commonly from about 110 to about 250 m²/g. Commonly, the rare earth-containing agglomerate includes more than 10.01 wt. %, more commonly more than about 85 wt. %, even more commonly more than about 90 wt. %, yet even more commonly more than about 92 wt. % and still yet even more commonly from about 95 to about 96.5 wt. % rare earth-containing particulates, with the balance being primarily the binder. Stated another way, the binder can be less than about 15% by weight of the agglomerate, in some cases less than about 10% by weight, in still other cases less than about 8% by weight, in still other cases less than about 5% by weight, and in still other cases less than about 3.5% by weight of the agglomerate. In some formulations, the rare earth-containing particulates are in the form of powder and have aggregated nano-crystalline domains. The binder can include one or more polymers selected from the group consisting of thermosetting polymers, thermoplastic polymers, elastomeric polymers, cellulosic polymers and glasses. Preferably, the binder comprises a fluorocarbon-containing polymer and/or an acrylic-polymer.

In one embodiment, the rare earth-containing composition is in the form of a colloid, suspension, or slurry of particulates. The particulates commonly can have a mean, median and/or P₉₀ particle size of less than about 1 nanometer, more commonly a mean, median and/or P₉₀ particle size from about 1 nanometer to about 1,000 nanometers, even more commonly a mean, median and/or P₉₀ particle size from about 1 micron to about 1,000 microns, or yet even more commonly a mean, median and/or P₉₀ particle size of at least about 1,000 microns. Preferably, the particulates have a mean, median and/or P₉₀ particle size from about 0.1 to about 1,000 nm, more preferably from about 0.1 to about 500 nm. Even more preferably, the cerium (IV) particulates have a mean, median and/or P₉₀ particle size from about 0.2 to about 100 nm.

In some embodiments, the particulates may have a mean and/or median surface area of at least about 1 m²/g, preferably a mean and/or median surface area of at least about 70 m²/g. In other embodiments, the particulates may preferably have a mean and/or median surface area from about 25 m²/g to about 500 m²/g and more preferably, a mean and/or median surface area of about 100 to about 250 m²/g. In some embodiments, the particulates may be in the form of one or more of a granule, crystal, crystallite, and particle.

In one application, the particulates comprise cerium (IV), typically as cerium (IV) oxide. The weight percent (wt. %) cerium (IV) content based on the total rare earth content of the cerium (IV) particulates typically is at least about 50 wt. % cerium (IV), more typically at least about 60 wt. % cerium (IV), even more typically at least about 70 wt. % cerium (IV), yet even more typically at least about 75 wt. % cerium (IV), still yet even more typically at least about 80 wt. % cerium (IV), still yet even more typically at least about 85 wt. % cerium (IV), still yet even more typically at least about 90 wt. % cerium (IV), still yet even more typically at least about 95 wt. % cerium (IV), and even more typically at least about 99 wt. % cerium (IV). Preferably, the cerium (IV) particulate is substantially devoid of rare earths other than cerium (IV). More preferably, the weight percent (wt. %) cerium (IV) content based on the total rare earth content of the cerium (IV) particulates is about 100 wt. % cerium (IV) and comprises one or more of cerium (IV) oxide, cerium (IV) hydroxide, cerium (IV) oxyhydroxyl, cerium (IV) hydrous oxide, cerium (IV) hydrous oxyhydroxyl, CeO₂, and/or Ce(IV)(O)_{w}(OH)ₓ(OH)_{y}.zH₂O, where w, x, y and can be zero or a positive, real number.

### The Medium (or Media) 104

The medium (or media) 104 can be any fluid stream. The fluid stream may be derived from any source containing one or more target materials. Commonly, the medium (or media) 104 is derived from any aqueous source containing one or more target materials. Non-limiting examples of a suitable medium (or media) 104 is recreational waters, municipal waters (such as, sewage, waste, agricultural, or ground waters), industrial (such as cooling, boiler, or process waters), wastewaters, well waters, septic waters, drinking waters, naturally occurring waters, (such as a lake, pond, reservoir, river, or stream), and/or other waters and/or aqueous process streams.

Non-limiting examples of recreational waters are swimming pool waters, brine pool waters, therapy pool waters, diving pool waters, sauna waters, spa waters, and hot tub waters. Non-limiting examples of municipal waters are drinking waters, waters for irrigation, well waters, waters for agricultural use, waters for architectural use, reflective pool waters, water-fountain waters, water-wall waters, use, non-potable waters for municipal use and other non-potable municipal waters. Wastewaters include without limitation, municipal and/or agricultural run-off waters, septic waters, waters formed and/or generated during an industrial and/or manufacturing process, waters formed and/or generated by a medical facility, waters associated with mining, mineral production, recovery and/or processing (including petroleum), evaporation pound waters, and non-potable disposal waters. Well waters include without limitation waters produced from a subsurface well for the purpose of human consumption, agricultural use (including consumption by a animal, irrigation of crops or consumption by domesticated farm animals), mineral-containing waters, waters associated with mining and petroleum production. Non-limiting examples of naturally occurring waters include associated with rains, storms, streams, rivers, lakes, aquifers, estuaries, lagoons, and such.

The medium (or media) 104 is typically obtained from one or more of the above sources and processed, conveyed and/or manipulated by a water handling system. The medium (or media) can be primarily the water in a water handling system.

The water handling system components and configuration can vary depending on the treatment process, water, and water source. While not wanting to limited by example, municipal and/or wastewater handling systems typically one or more of the following process units: clarifying, disinfecting, coagulating, aerating, filtering, separating solids and liquids, digesting, and polishing. The number and ordering of the process units can vary. Furthermore, some process units may occur two or more times within a water handling system. It can be appreciated that the one or more process units are in fluid communication.

The water handling system may or may not have a clarifier. Some water handling systems may have more than one clarifier, such as primary and final clarifiers. Clarifiers typically reduce cloudiness of the water by removing biological matter (such as bacteria and/or algae), suspended and/or dispersed chemicals and/or particulates from the water. Commonly a clarification process occurs before and/or after a filtration process.

The water handling system may or may not contain a filtering process. Typically, the water handling system contains at least one filtering process. Non-limiting examples of common filtering processes include without limitation screen filtration, trickling filtration, particulate filtration, sand filtration, macro-filtration, micro-filtration, ultra-filtration, nano-filtration, reverse osmosis, carbon/activated carbon filtration, dual media filtration, gravity filtration and combinations thereof. Commonly a filtration process occurs before and/or after a disinfection process. For example, a filtration process to remove solid debris, such as solid organic matter and grit from the water typically precedes the disinfection process. In some embodiments, a filtration process, such as an activated carbon and/or sand filtrations follows the disinfection process. The post-disinfection filtration process removes at least some of the chemical disinfectant remaining in the treated water.

The water handling system may or may not include a disinfection process. The disinfection process may include without limitation treating the aqueous stream and/or water with one or more of fluorine, fluorination, chlorine, chlorination, bromine, bromination, iodine, iodination, ozone, ozonation, electromagnetic irradiation, ultra-violet light, gama rays, electrolysis, chlorine dioxide, hypochlorite, heat, ultrasound, trichloroisocyanuric acid, soaps/detergents, alcohols, bromine chloride (BrCl), cupric ion (Cu²⁺), silver, silver ion (Ag⁺), permanganate, phenols, and combinations thereof. Preferably, the water handling system contains a single disinfection process, more preferably the water handling system contains two or more disinfection processes. Disinfection process are typically provided to one of at least remove, kill and/or detoxify pathogenic material contained in the water. Typically, the pathogenic material comprises biological contaminants, in particular biological contaminants comprising the target materials. In some embodiments, the disinfection process converts the target material species into a species that can be removed and/or detoxified by the rare earth-containing composition, additive, and/or particle or particulate.

The water handling system may or may not include coagulation. The water handling system may contain one or more coagulation processes. Typically, the coagulation process includes adding a flocculent to the water in the water handling system. Typical flocculants include aluminum sulfate, polyelectrolytes, polymers, lime and ferric chloride. The flocculent aggregates the particulate matter suspended and/or dispersed in the water, the aggregated particulate matter forms a coagulum. The coagulation process may or may not include separating the coagulum from the liquid phase. In some embodiments, coagulation may comprise part, or all, the entire clarification process. In other embodiments, the coagulation process is separate and distinct from the clarification process. Typically, the coagulation process occurs before the disinfection process.

The water handling system may or may not include aeration. Within the water handing system, aeration comprises passing a stream of air and/or molecular oxygen through the water contained in the water handling system. The aeration process promotes oxidation of contaminants contained in the water being processed by the water handling system, preferably the aeration promotes the oxidation of biological contaminates, such as target materials. In some embodiments, the aeration process converts the target material species into a species that can be removed and/or detoxified by the rare earth-containing composition, additive, and/or particle or particulate. The water handling system may contain one or more aeration processes. Typically, the disinfection process occurs after the aeration process.

The water handling system may or may not have one or more of a heater, a cooler, and a heat exchanger to heat and/or cool the water being processed by the water handling system. The heater may be any method suitable for heating the water. Non-limiting examples of suitable heating processes are solar heating systems, electromagnetic heating systems (such as, induction heating, microwave heating and infrared), immersion heaters, and thermal transfer heating systems (such as, combustion, stream, hot oil, and such, where the thermal heating source has a higher temperature than the water and transfers heat to the water to increase the temperature of the water). The heat exchanger can be any process that transfers thermal energy to or from the water. The heat exchanger can remove thermal energy from the water to cool and/or decrease the temperature of the water. Or, the heat exchanger can transfer thermal energy to the water to heat and/or increase the temperature of the water. The cooler may be any method suitable for cooling the water. Non-limiting examples of suitable cooling process are refrigeration process, evaporative coolers, and thermal transfer cooling systems (such as, chillers and such where the thermal (cooling) source has a lower temperature than the water and removes heat from the water to decrease the temperature of the water). Any of the clarification, disinfection, coagulation, aeration, filtration, sludge treatment, digestion, nutrient control, solid/liquid separation, and/or polisher processes may further include before, after and/or during one or both of a heating and cooling process. It can be appreciated that a heat exchanger typically includes at least one of heating and cooling process.

The water handling system may or may not include a digestion process. Typically, the digestion process is one of an anaerobic or aerobic digestion process. In some configurations, the digestion process may include one of an anaerobic or aerobic digestion process followed by the other of the anaerobic or aerobic digestion processes. For example, one such configuration can be an aerobic digestion process followed by an anaerobic digestion process. Commonly, the digestion process comprises microorganisms that breakdown the biodegradable material contained in the water. In some embodiments, the biodegradable material includes a target material. Furthermore, the digestion process converts the target material species into a species that can be removed and/or detoxified by the rare earth-containing composition, additive, and/or particle or particulate. The anaerobic digestion of biodegradable material proceeds in the absence of oxygen, while the aerobic digestion of biodegradable material proceeds in the presence of oxygen. In some water handling systems the digestion process is typically referred to as biological stage/digester or biological treatment stage/digester. Moreover, in some systems the disinfection process comprises a digestion process.

The water handling system may or may not include a nutrient control process. Furthermore, the water handling system may include one or more nutrient control processes. The nutrient control process typically includes nitrogen and/or phosphorous control. Moreover, nitrogen control commonly may include nitrifying bacteria. Typically, phosphorous control refers to biological phosphorous control, preferably controlling phosphorous that can be used as a nutrient for algae. Nutrient control typically includes processes associated with control of oxygen demand substances, which include in addition to nutrients, pathogens, and inorganic and synthetic organic compositions. The nutrient control process can occur before or after the disinfection process. In some embodiments, the nutrient control process converts the target material species into a species that can be removed and/or detoxified by the rare earth-containing composition, additive, and/or particle or particulate.

The water handling system may or may not include a solid/liquid separation process. Preferably, the water handling system includes one or more solid/liquid separation processes. The solid/liquid separation process can comprise any process for separating a solid phase from a liquid phase, such as water. Non-limiting examples of suitable solid liquid separation processes are clarification (including trickling filtration), filtration (as described above), vacuum and/or pressure filtration, cyclone (including hydrocyclones), floatation, sedimentation (including gravity sedimentation), coagulation (as described above), sedimentation (including, but not limited to grit chambers), and combinations thereof.

The water handling system may or may not include a polisher. The polishing process can include one or more of removing fine particulates from the water, an ion-exchange process to soften the water, an adjustment to the pH value of the water, or a combination thereof. Typically, the polishing process is after the disinfection step.

While the water handling system typically includes one or more of a clarifying, disinfecting, coagulating, aerating, filtering, separating solids and liquids, digesting, and polishing processes, the water handling system may further include additional processing equipment. The additional processing equipment includes without limitation holding tanks, reactors, purifiers, treatment vessels or units, mixing vessels or elements, wash circuits, precipitation vessels, separation vessels or units, settling tanks or vessels, reservoirs, pumps, cooling towers, heat exchangers, valves, boilers, gas liquid separators, nozzles, tenders, and such. Furthermore, the water handling system includes conduit(s) interconnecting the unit operations and/or additional processing equipment. The conduits include without limitation piping, hoses, channels, aqua-ducts, ditches, and such. The water is conveyed to and from the unit operations and/or additional processing equipment by the conduit(s). Moreover, each unit operations and/or additional processing equipment is in fluid communication with the other unit operations and/or additional processing equipment by the conduits.

### The Target Material

The aqueous medium that is treated by the rare earth-containing composition, additive, and/or particles may contain one or more target materials. The one or more target material-containing species may include metals (other than scandium, yttrium and lanthanoids), metalloids, and/or radioactive isotopes in various forms. In some aqueous media, the target material-containing species include, without limitation, a hydrated metal (including without limitation alkali metals, alkaline earth metals, actinoids, transition metals, and post-transition metals and excluding scandium, yttrium and lanthanoids), metalloid, and/or radioactive isotope, a hydrated metal, metalloid, or radioactive isotope oxyspecies in the form of an anion, cation, or having no net charge (e.g., MₐOₓⁿ⁺ or MₐOₓ⁰ where 0<a≦4, 0<x≦4, and 0<n≦6), a positively, negatively, or uncharged metal, metalloid, or radioactive isotope carbonate (e.g., M_{c}(CO₃)_{y} where 0<c≦4 and 0<y≦4), or a positively, negatively, or uncharged metal, metalloid, or radioactive isotope hydroxyl species (particularly a metal or metalloid hydroxide (e.g., M(OH)_{z} where 0<z≦8)), a positively, negatively, uncharged metal, metalloid, or radioactive isotope oxyhydroxyl species and mixtures thereof. The target material-containing species may be in the form of a solid, a dissolved species, or a suspension.

In some embodiments, the rare earth-containing composition removes anionic, cationic, oxy, hydroxyl, hydrated, or a combination thereof species of a target material, where the target material “M” has an atomic number of 5, 13, 22-33, 40-52, 72-84, and 89-94. Examples of hydrated hydroxyl and hydrated oxy compounds (which may be anionic, neutral or cationic and hereinafter referenced by the symbol “MS”) include, but are not limited to, M(H₂O)₆ⁿ, M(H₂O)₅OH⁽ⁿ⁻¹), M(OH)⁽ⁿ⁻¹⁾M(H₂O)₄(OH)₂⁽ⁿ⁻²⁾, M(OH)₂⁽ⁿ⁻²⁾, M(H₂O)₃(OH)₃⁽ⁿ⁻³⁾, M(OH)₃⁽ⁿ⁻³⁾, M(H₂O)₂(OH)₄⁽ⁿ⁻⁴⁾, M(OH)₄⁽ⁿ⁻⁴⁾, M(H₂O)(OH)₅⁽ⁿ⁻⁵⁾, M(OH)₅⁽ⁿ⁻⁵⁾, M(OH)₆⁽ⁿ⁻⁶⁾, M(H₂O)₅O⁽ⁿ⁻²⁾, MO⁽ⁿ⁻²⁾, M(H₂O)₄(O)₂⁽ⁿ⁻⁴⁾, MO₂⁽ⁿ⁻⁴⁾, M(H₂O)₃(O)₃⁽ⁿ⁻⁶⁾, MO₃⁽ⁿ⁻⁶⁾, M(H₂O)₂(O)₄⁽ⁿ⁻⁸⁾, MO₄⁽ⁿ⁻⁸⁾, M(H₂O)(O)₅⁽ⁿ⁻¹⁰⁾, MO₅⁽ⁿ⁻¹⁰⁾, M(O)₆⁽ⁿ⁻¹²⁾, M(H₂O)₅CO₃⁽ⁿ⁻²⁾, MCO₃⁽ⁿ⁻²⁾, M(H₂O)₄(CO₃)₂⁽ⁿ⁻⁴⁾, M(CO₃)₂⁽ⁿ⁻⁴⁾, M(H₂O)₃(CO₃)₃⁽ⁿ⁻⁶⁾, M(CO₃)₃⁽ⁿ⁻⁶⁾, M(H₂O)₂(CO₃)₄⁽ⁿ⁻⁸⁾, M(CO₃)₄⁽ⁿ⁻⁸⁾, M(H₂O)(CO₃)₅⁽ⁿ⁻¹⁰⁾, M(CO₃)₅⁽ⁿ⁻¹⁰⁾, M(CO₃)₆⁽ⁿ⁻¹²⁾, M(H₂O)₄ⁿ, M(H₂O)₃OH⁽ⁿ⁻¹⁾, M(H₂O)₂(OH)₂⁽ⁿ⁻²⁾, M(H₂O)(OH)₃⁽ⁿ⁻³⁾, M(H₂O)₃O⁽ⁿ⁻²⁾, M(H₂O)₂(O)₂⁽ⁿ⁻⁴⁾, M(H₂O)(O)₃⁽ⁿ⁻⁶⁾, and M(O)₄⁽ⁿ⁻⁸⁾. In the foregoing formulas, n is a real number no greater than eight and represents the charge or oxidation state of the metal or metalloid “M” (for example when M is Pb(II) n is 2, and when M is Pb(IV) n is 4). In general, M has a positive charge “n” no greater than about 8.

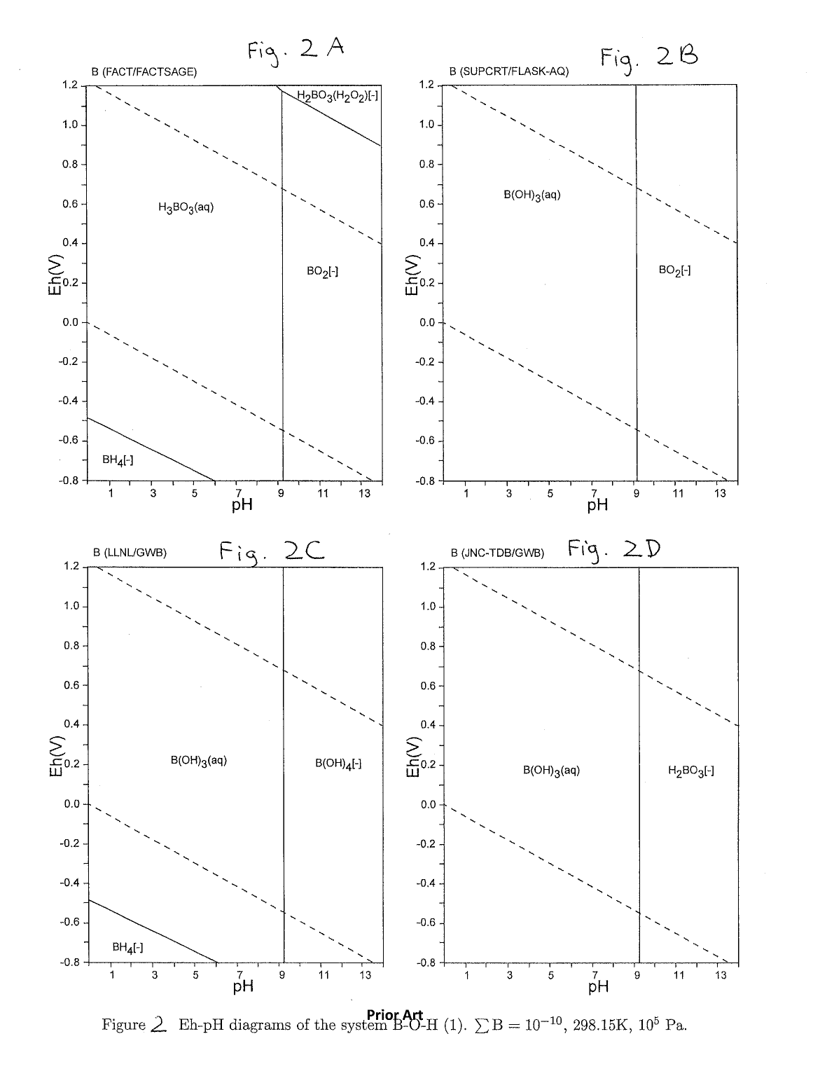

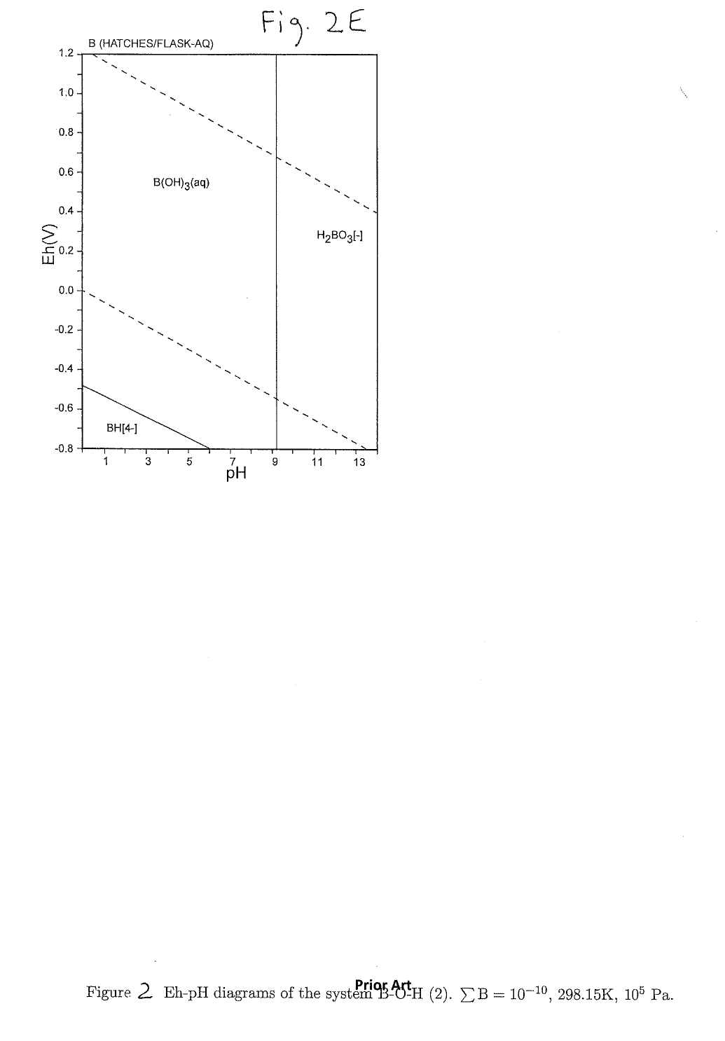

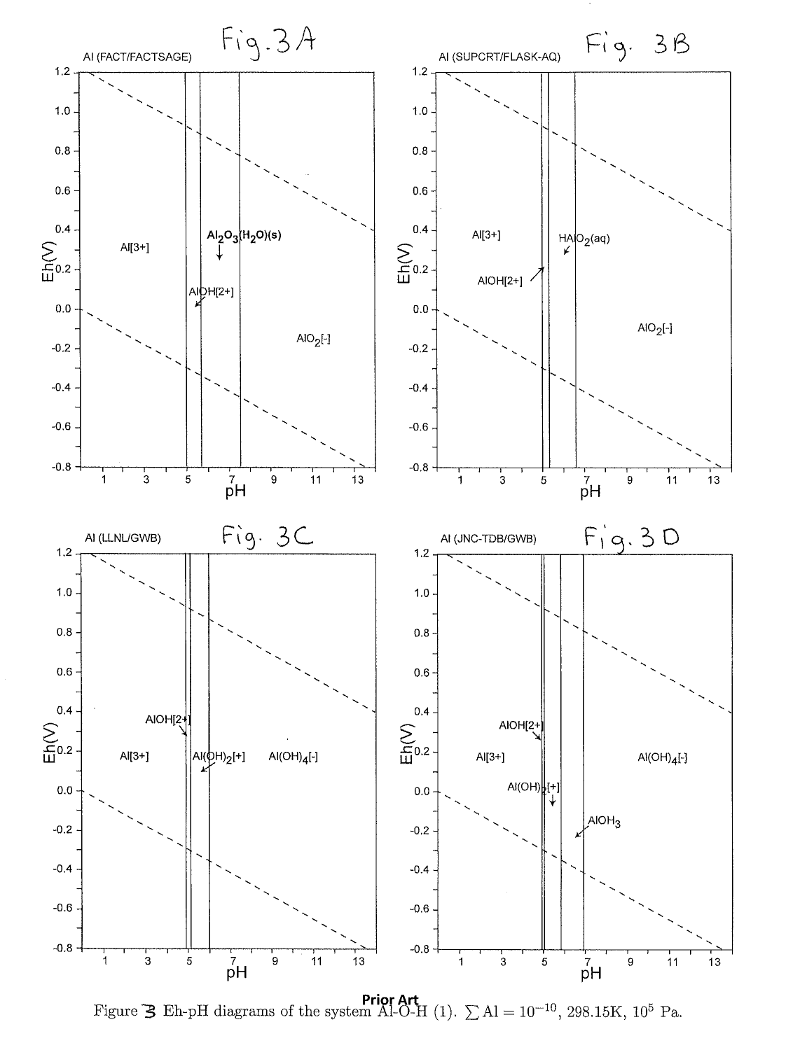

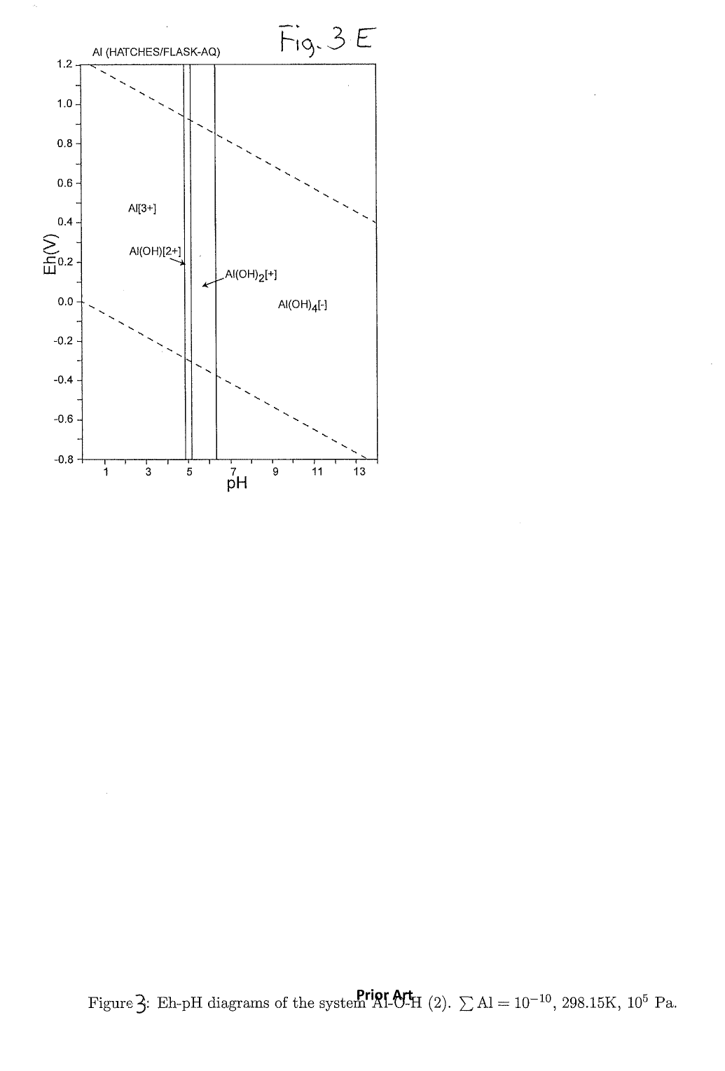

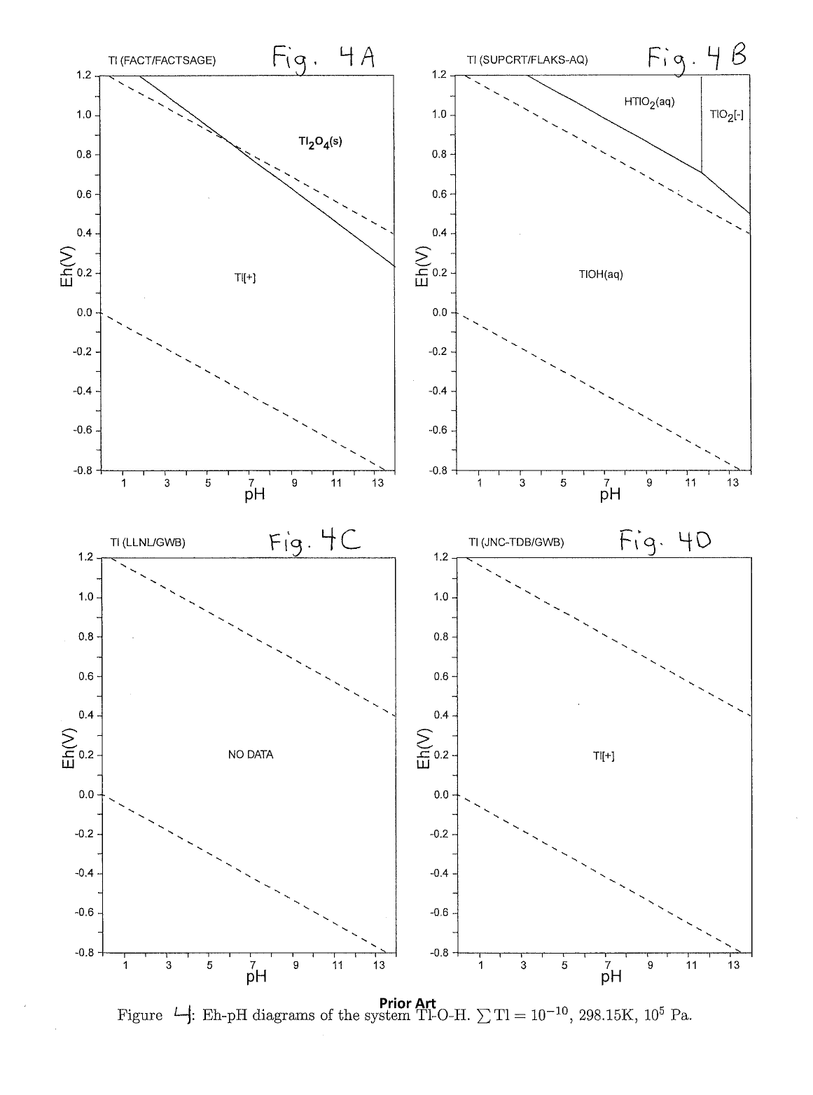

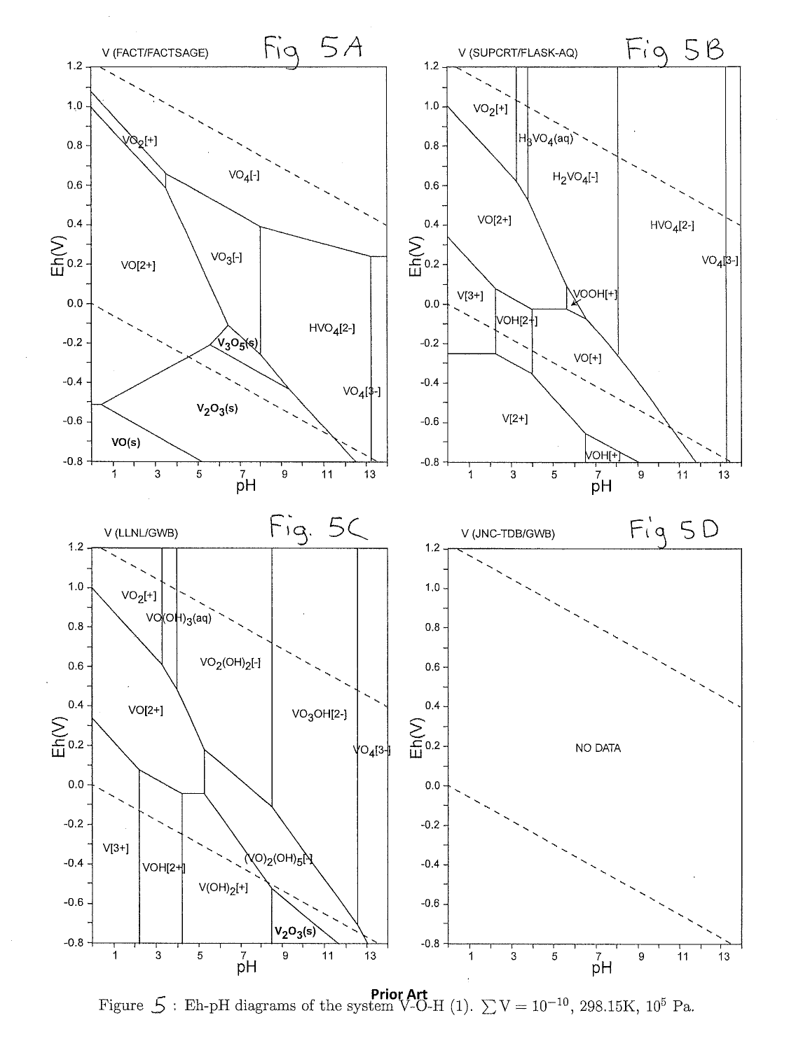

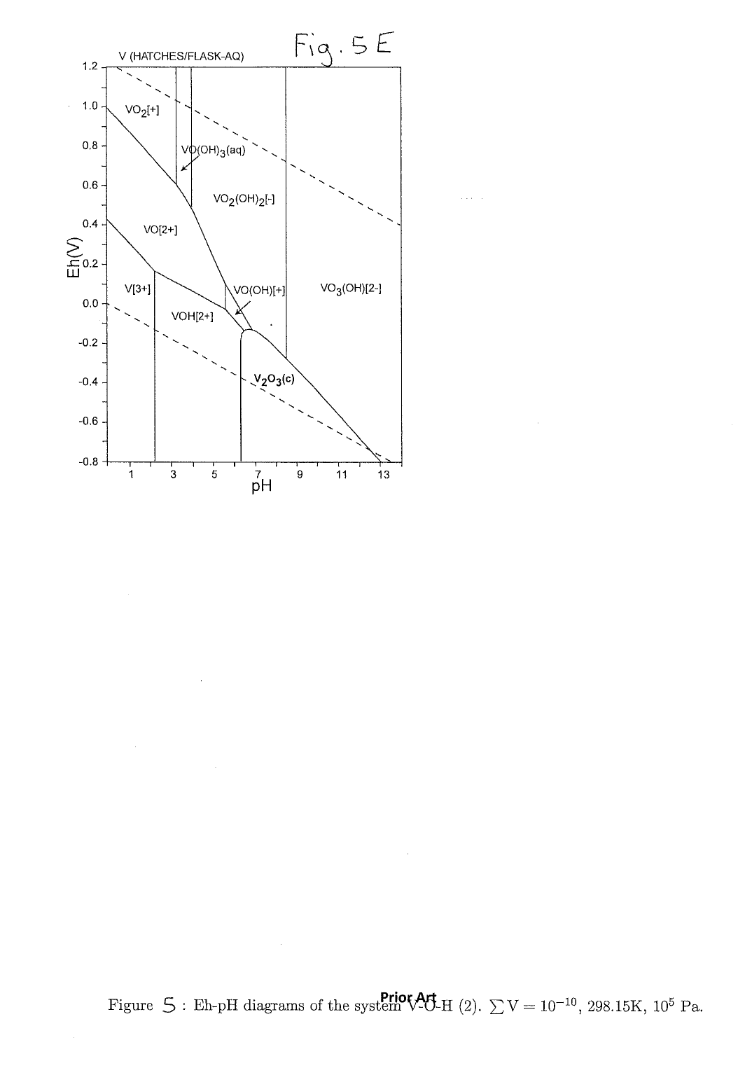

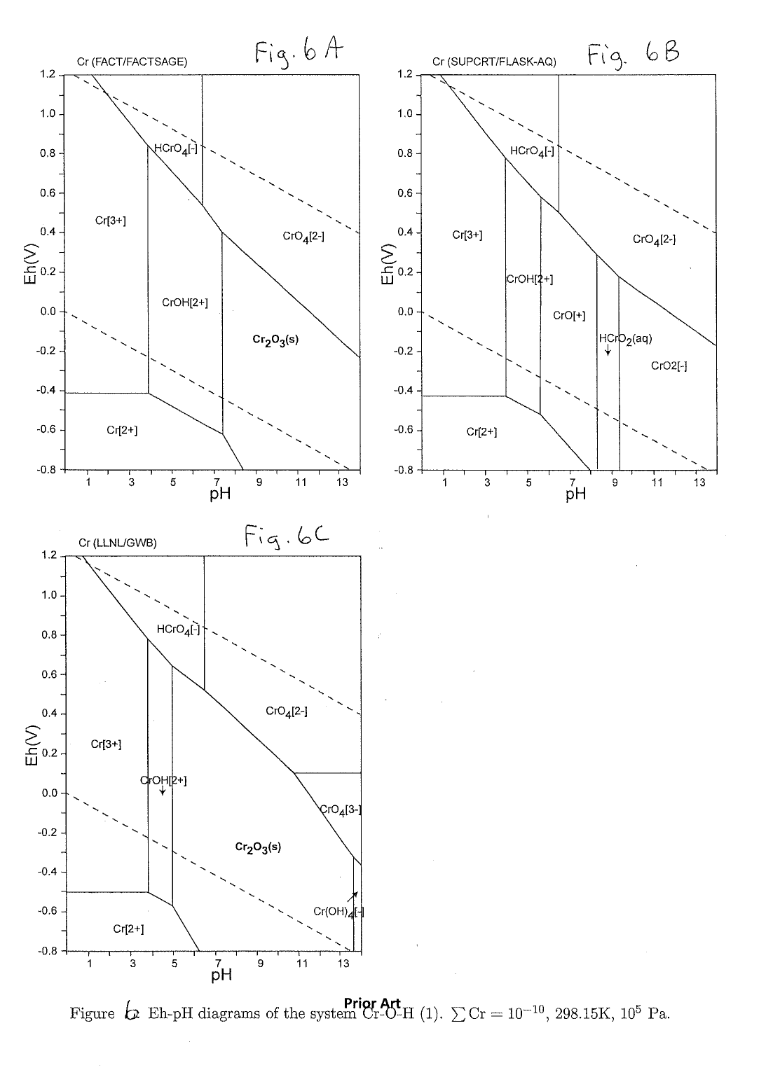

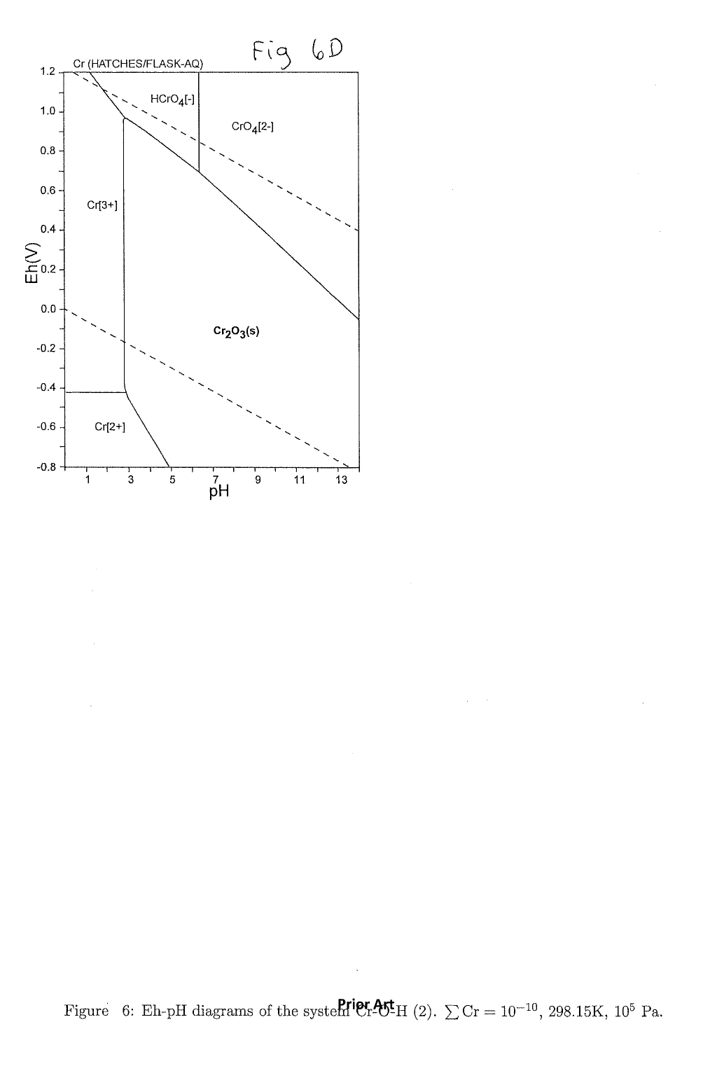

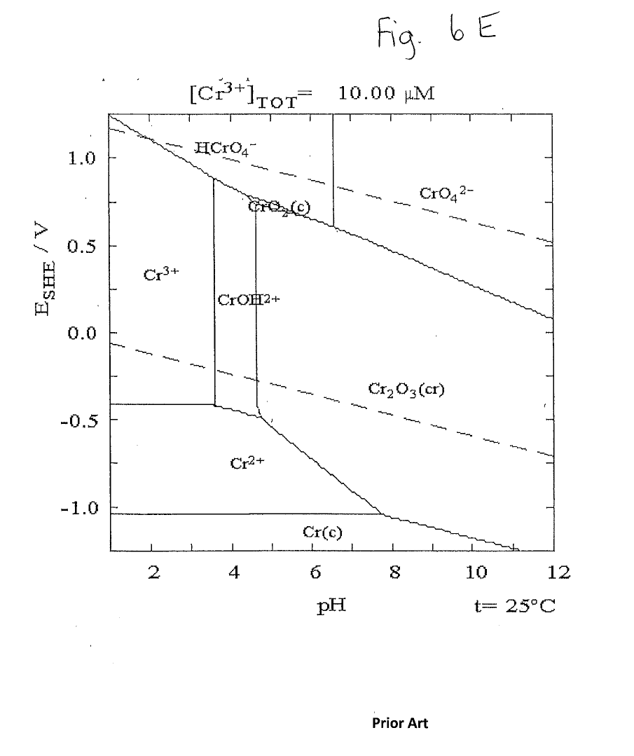

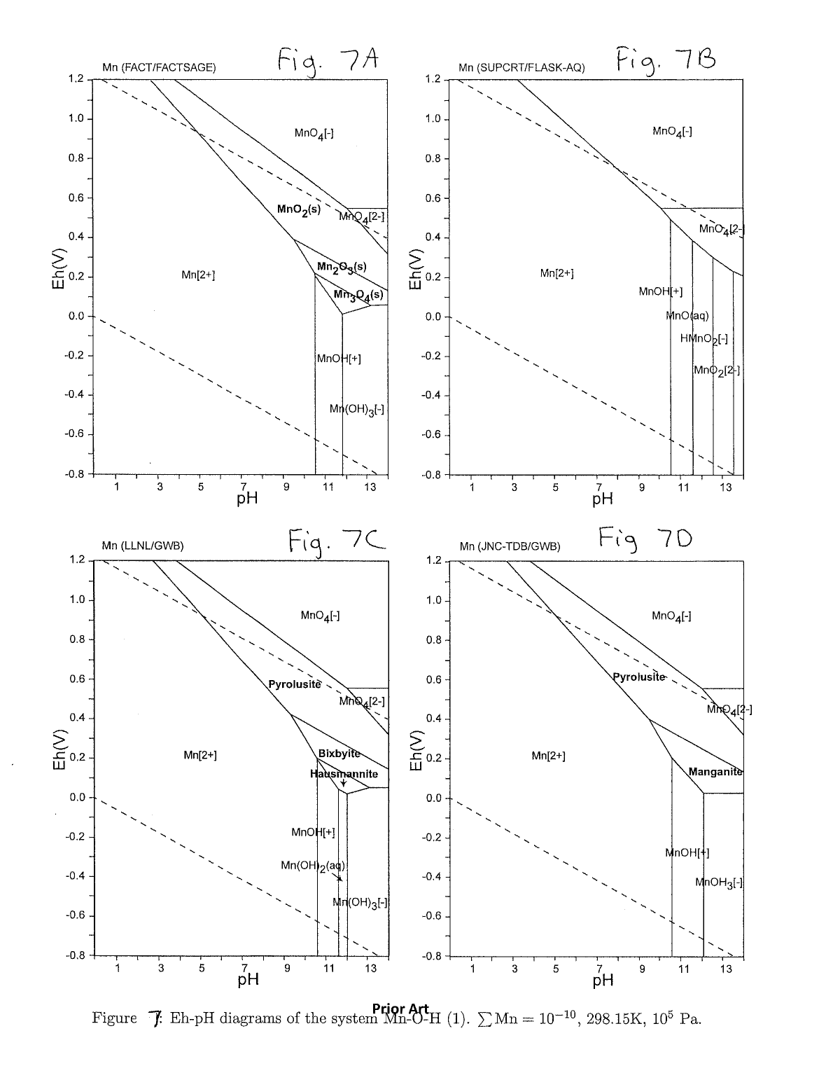

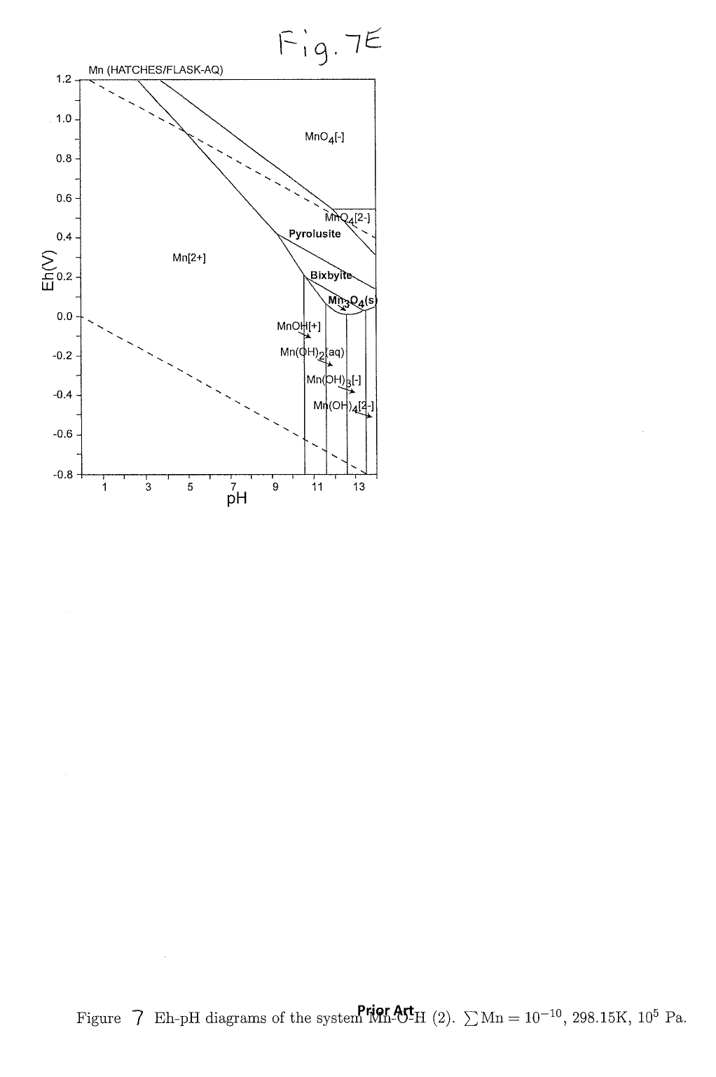

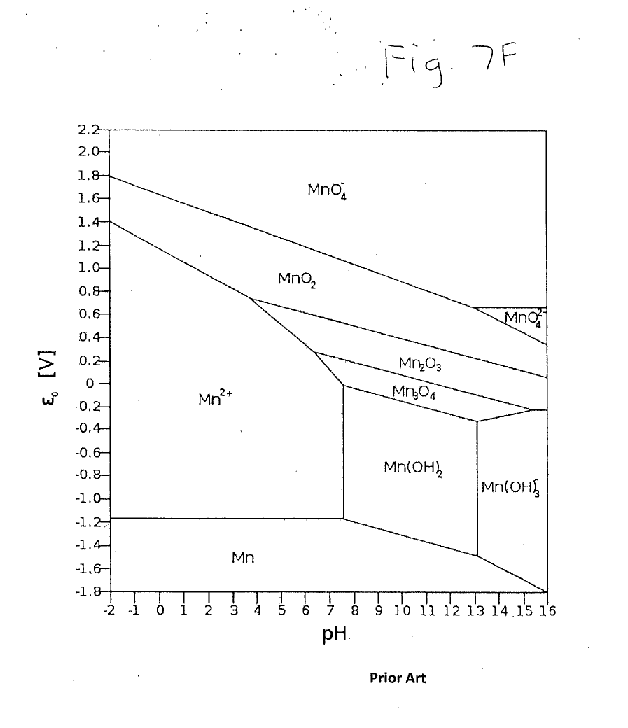

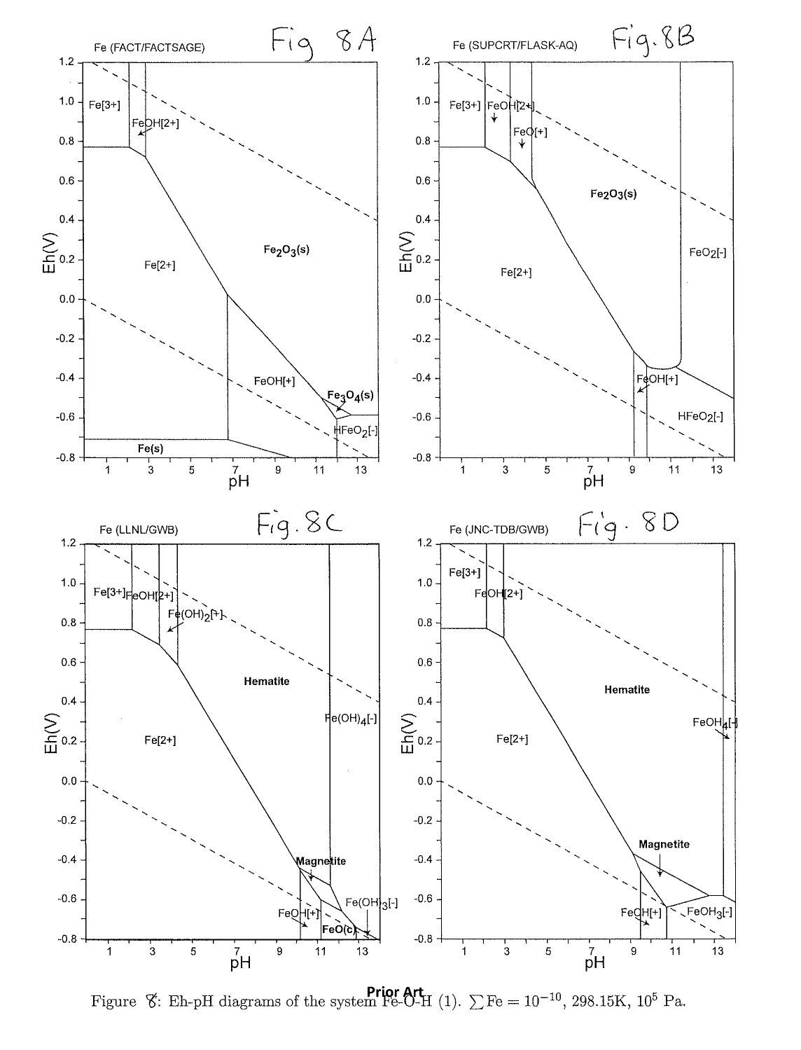

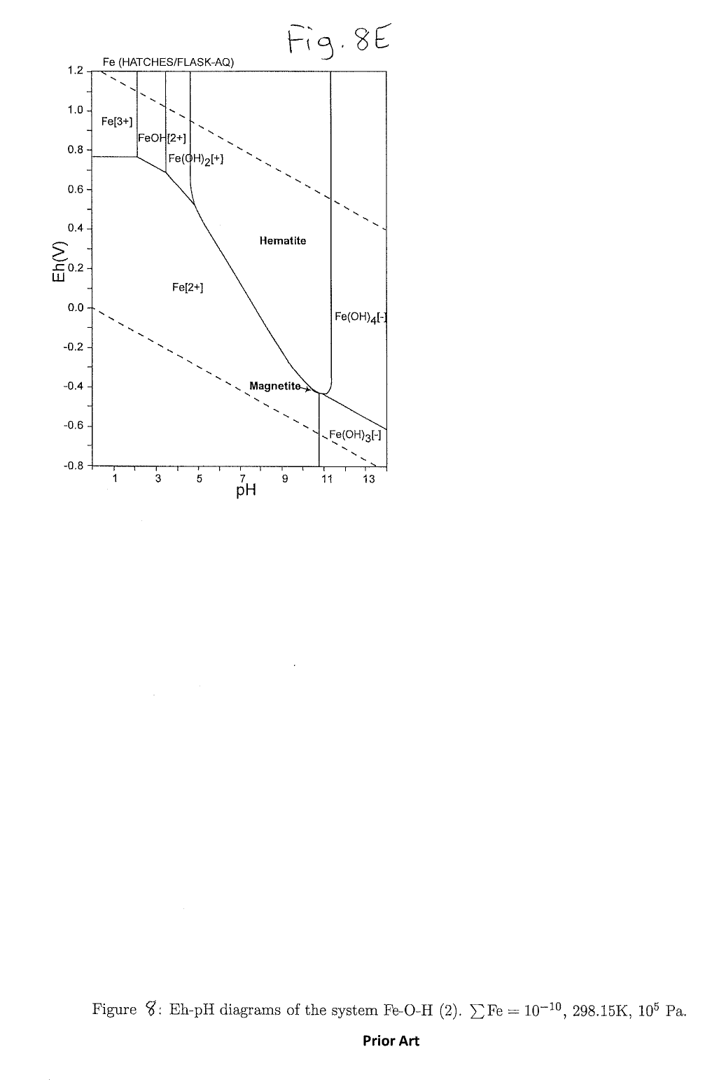

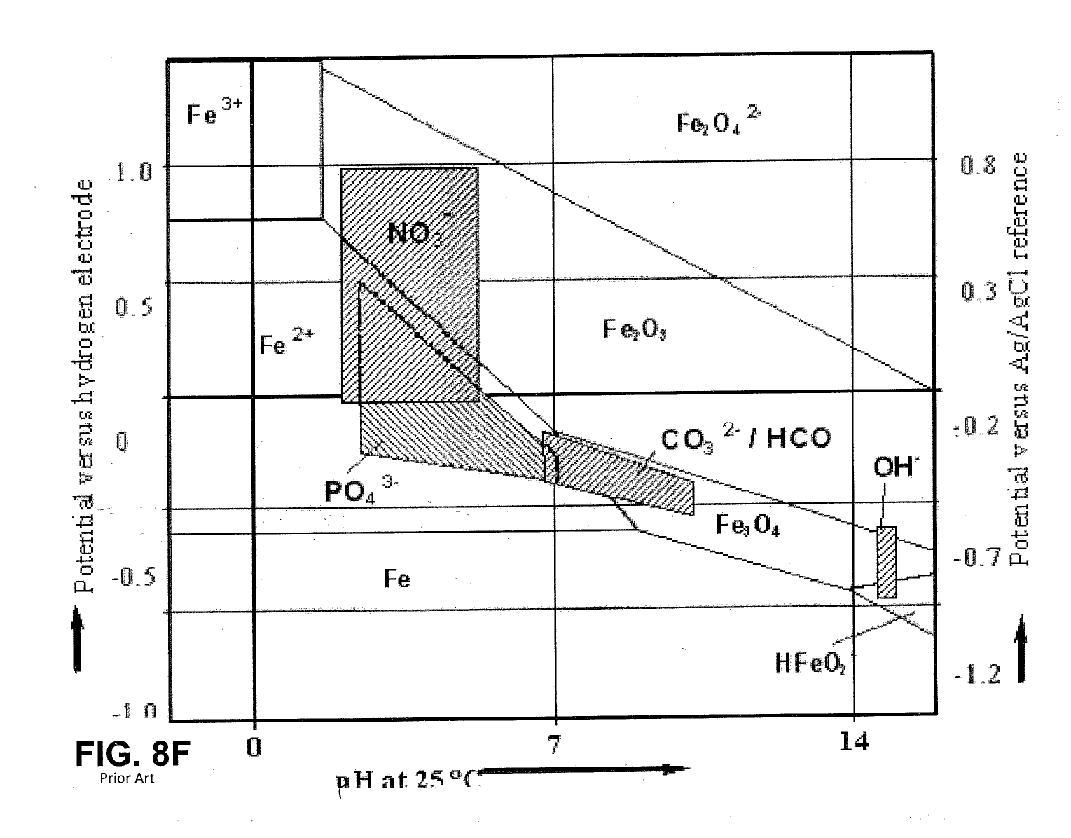

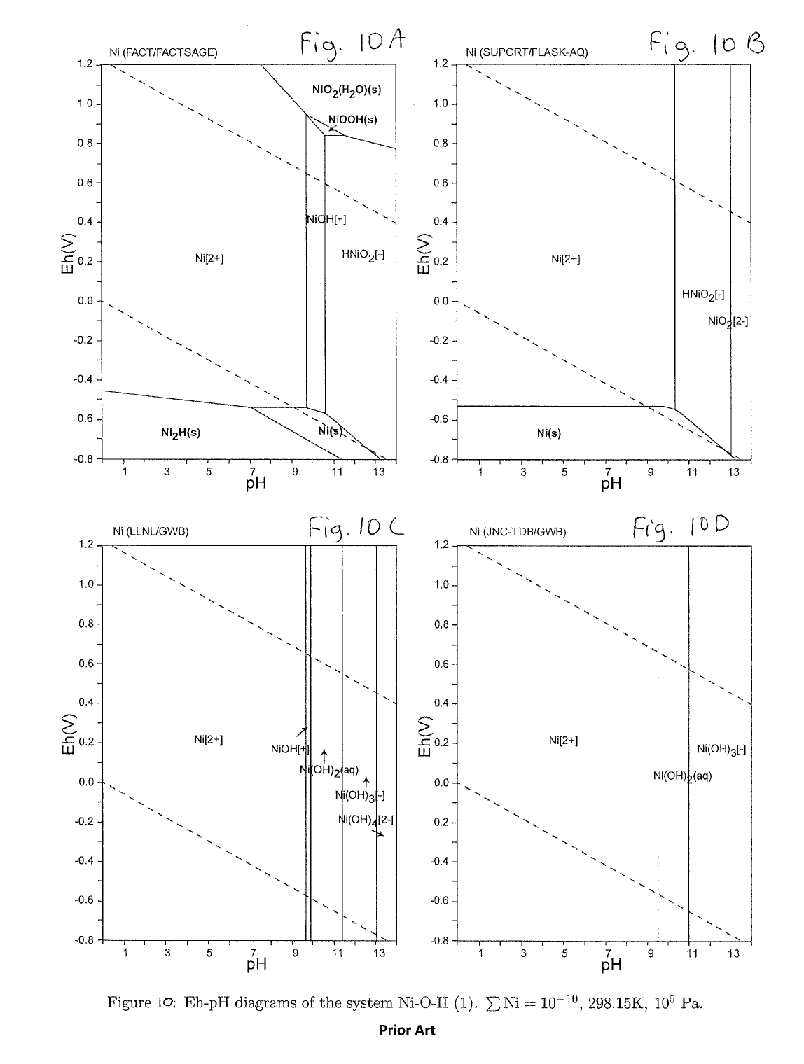

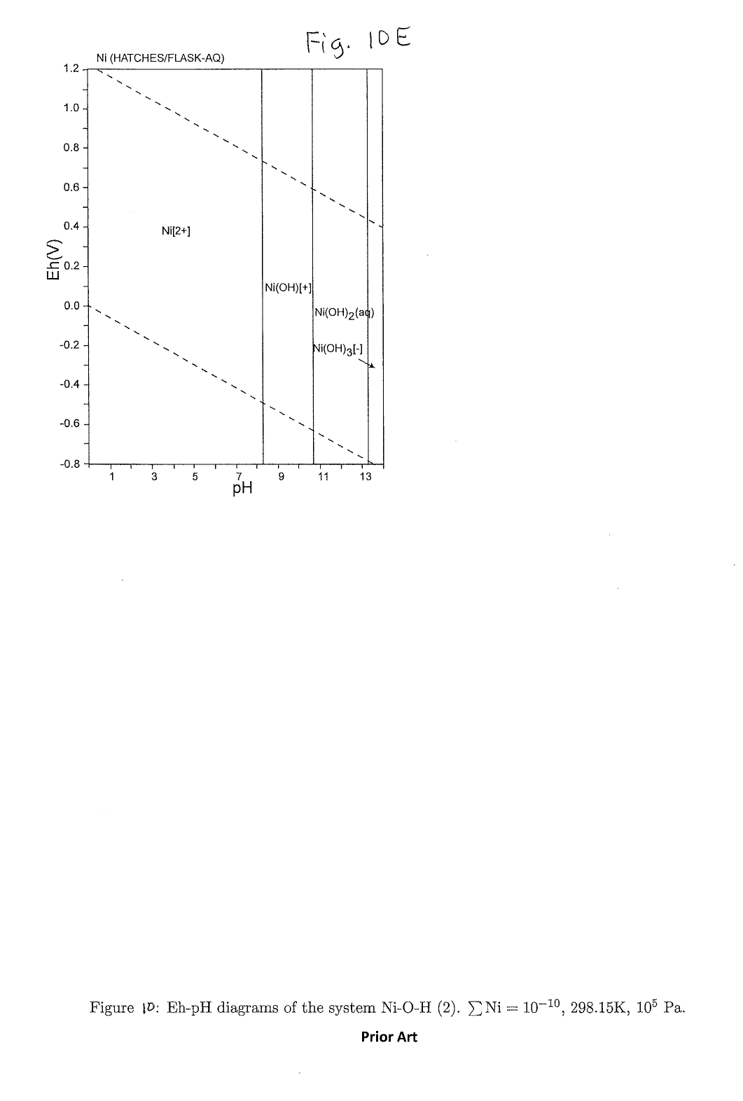

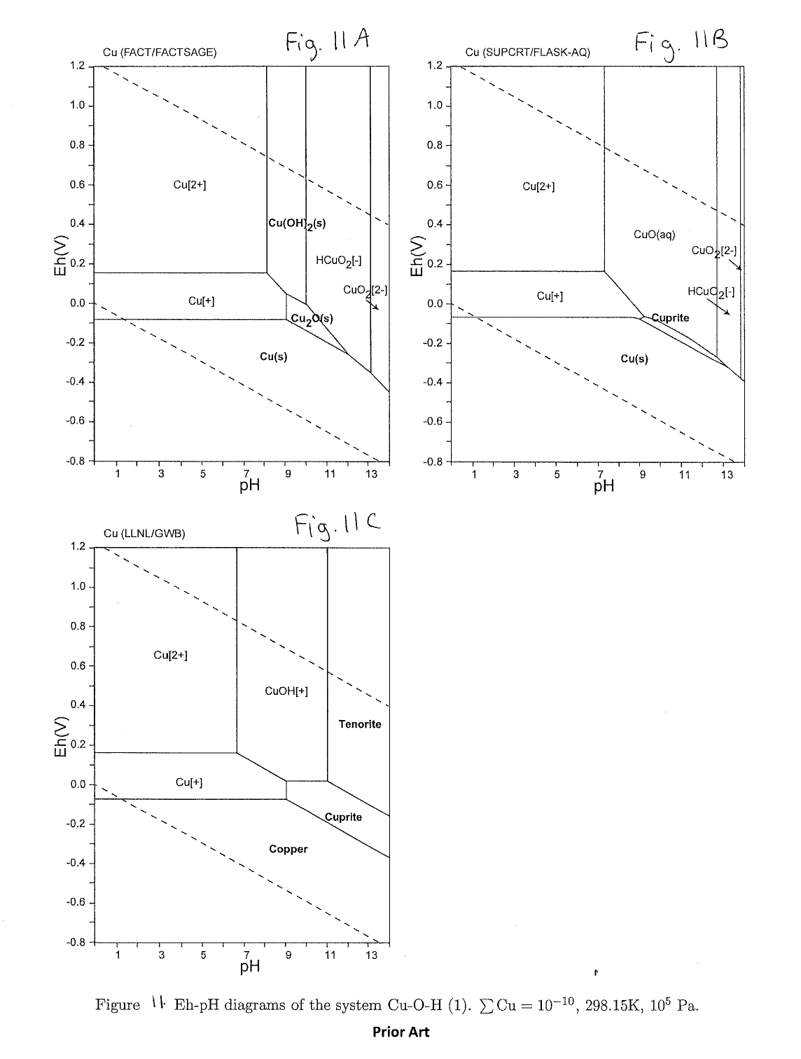

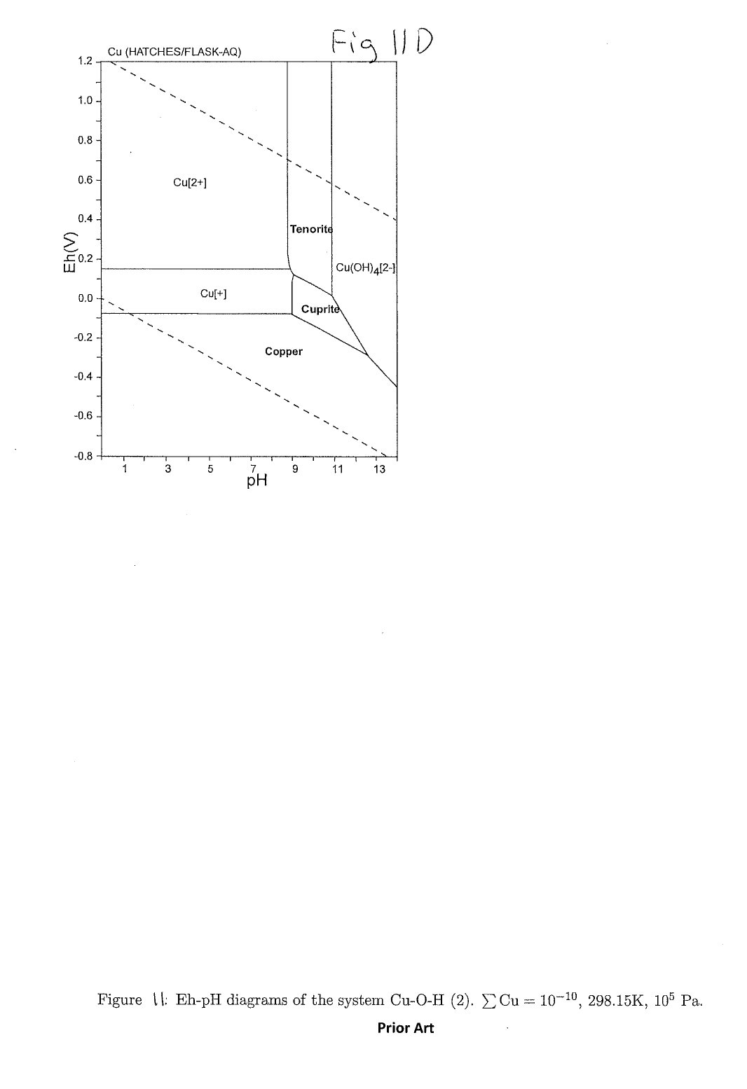

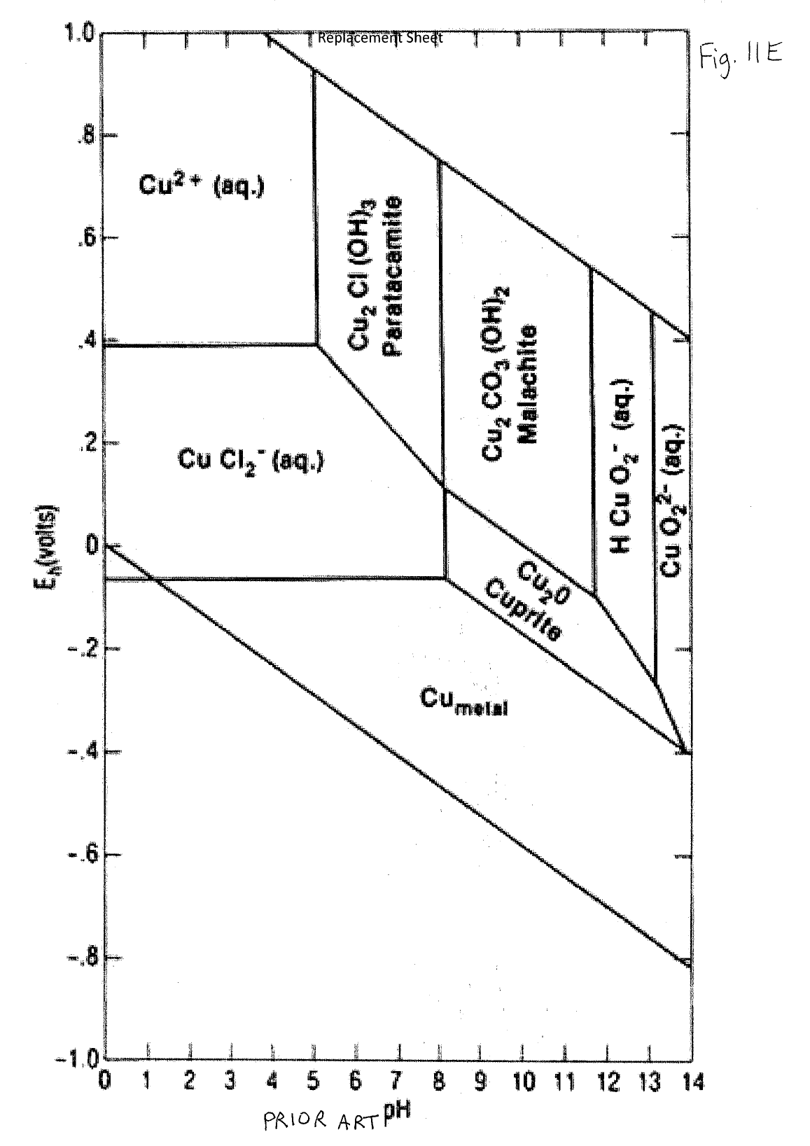

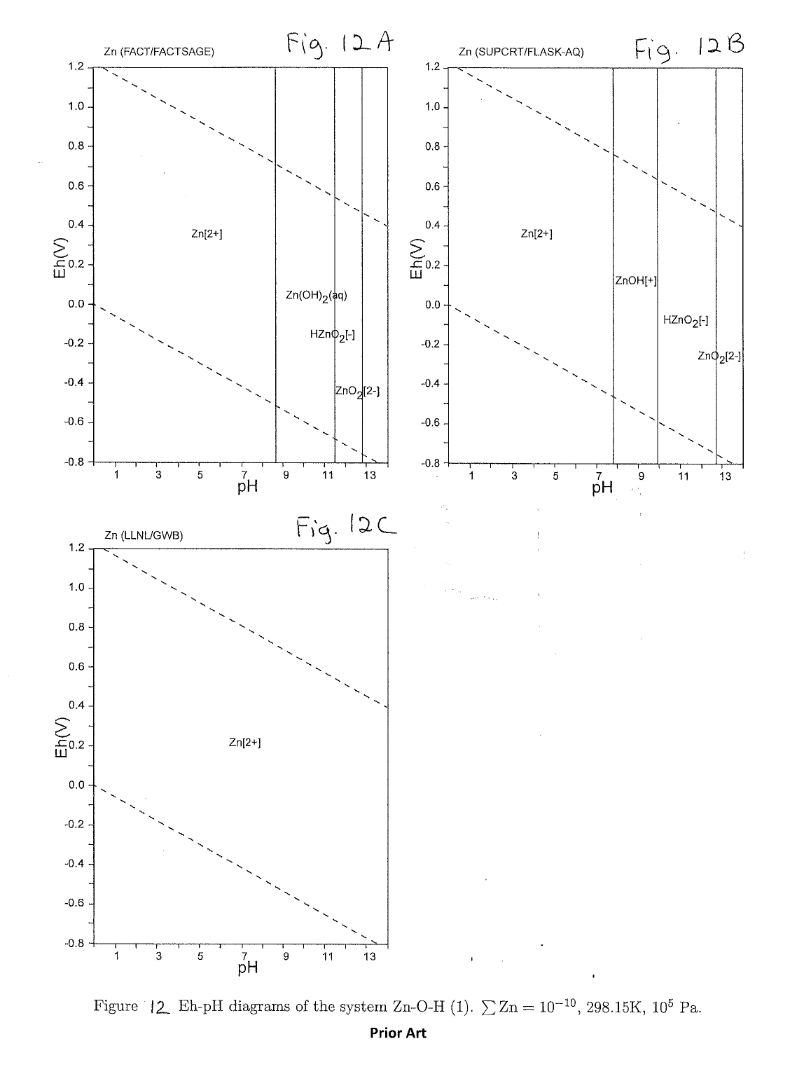

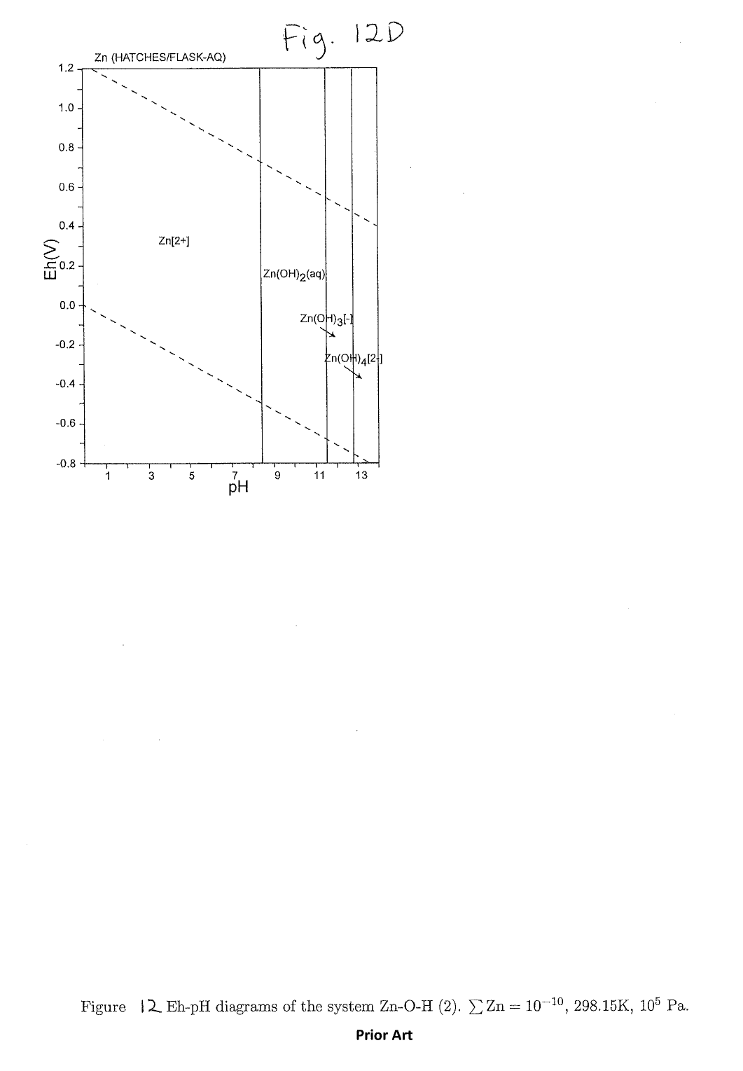

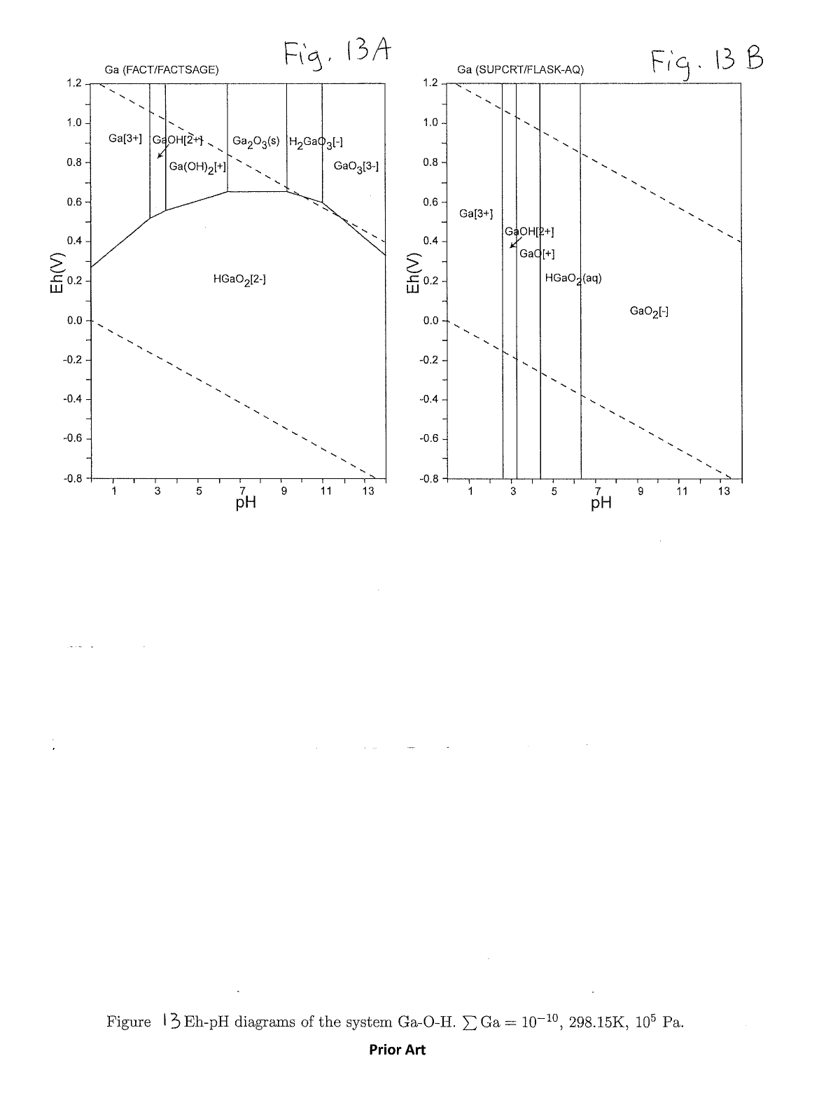

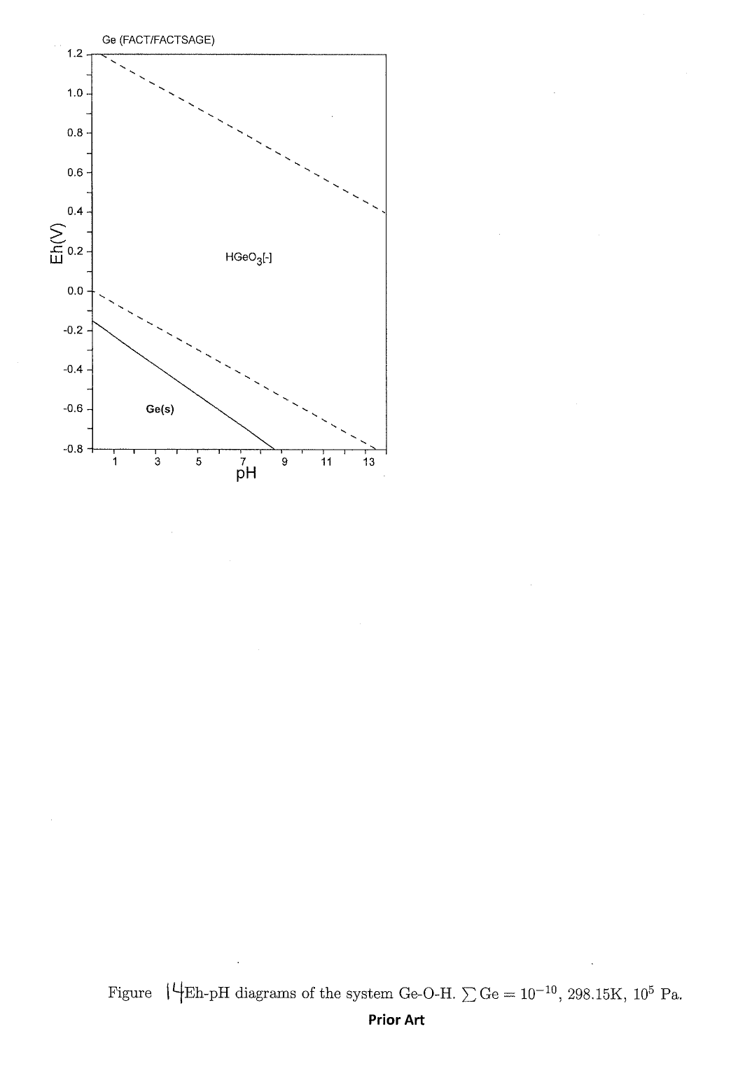

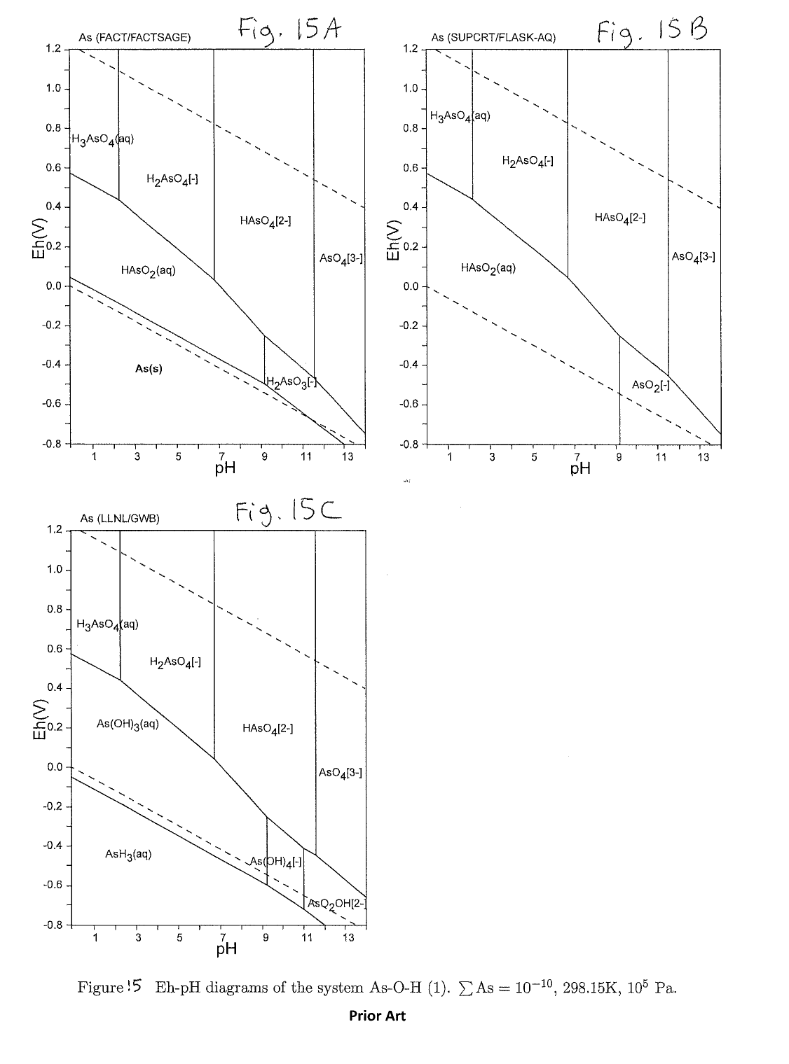

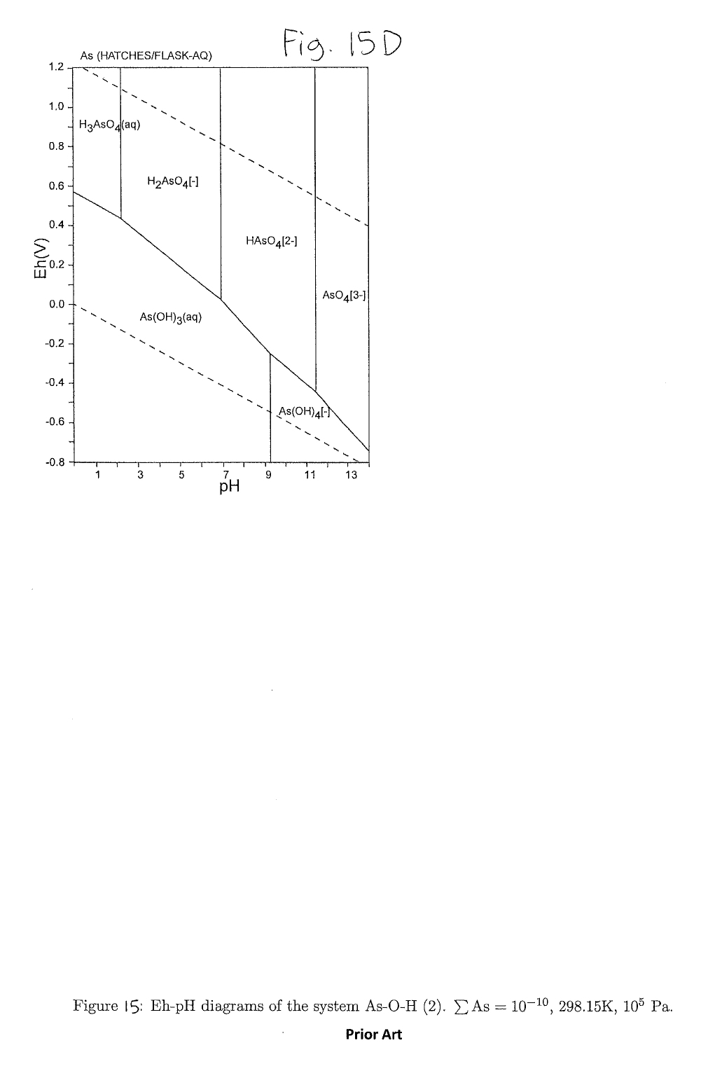

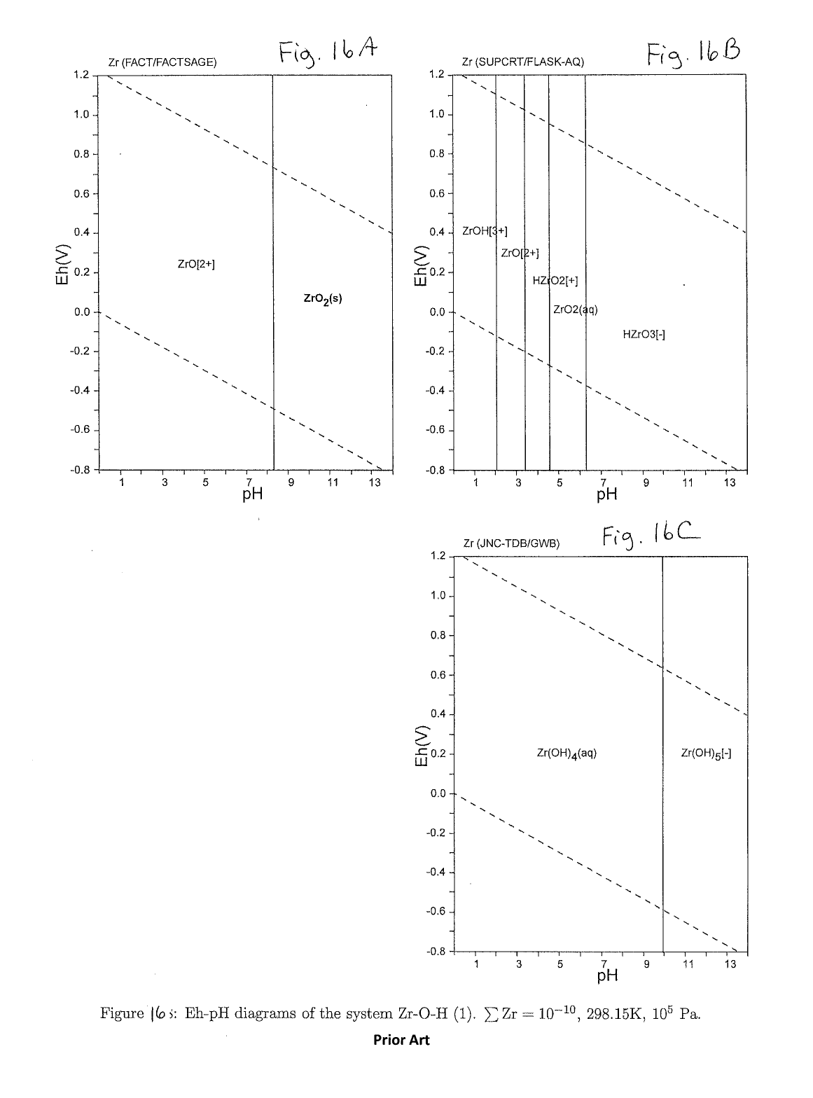

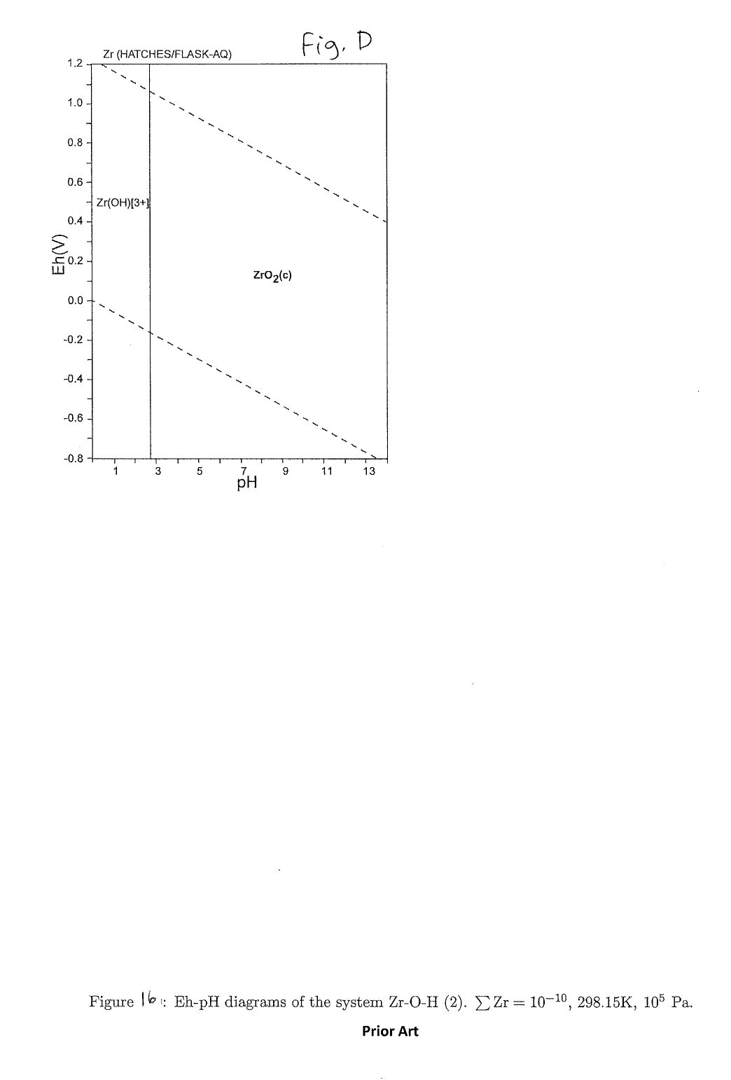

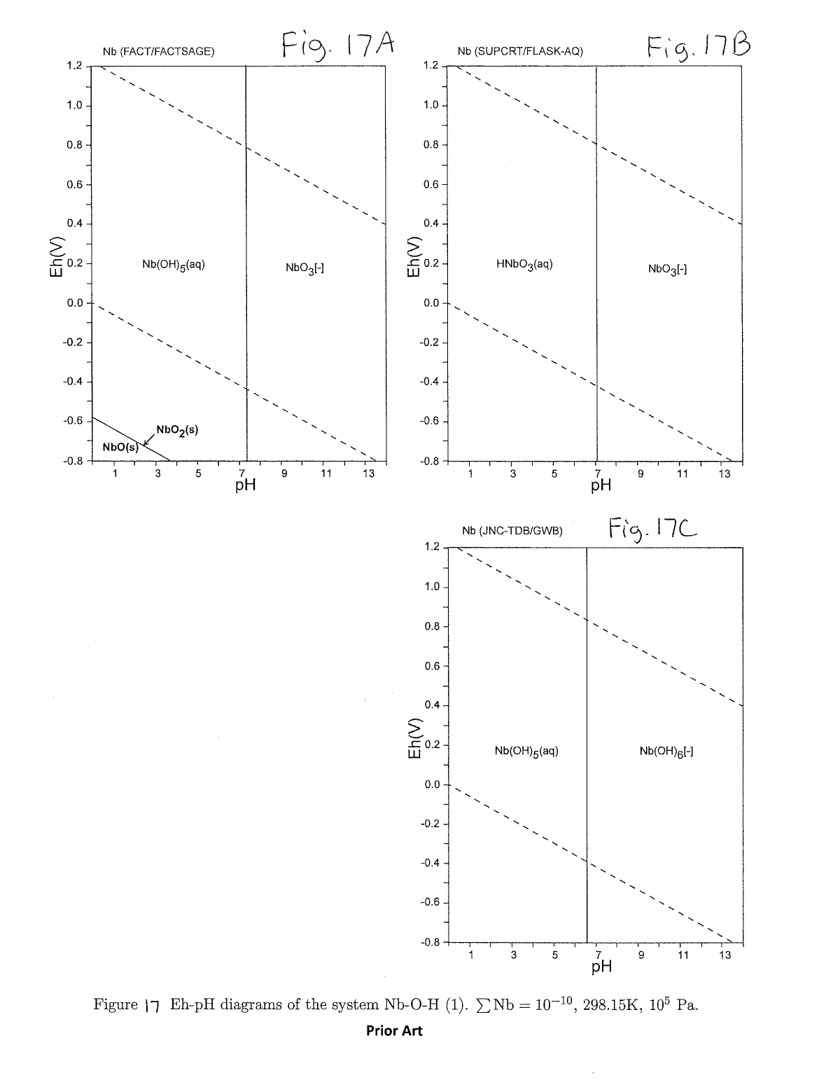

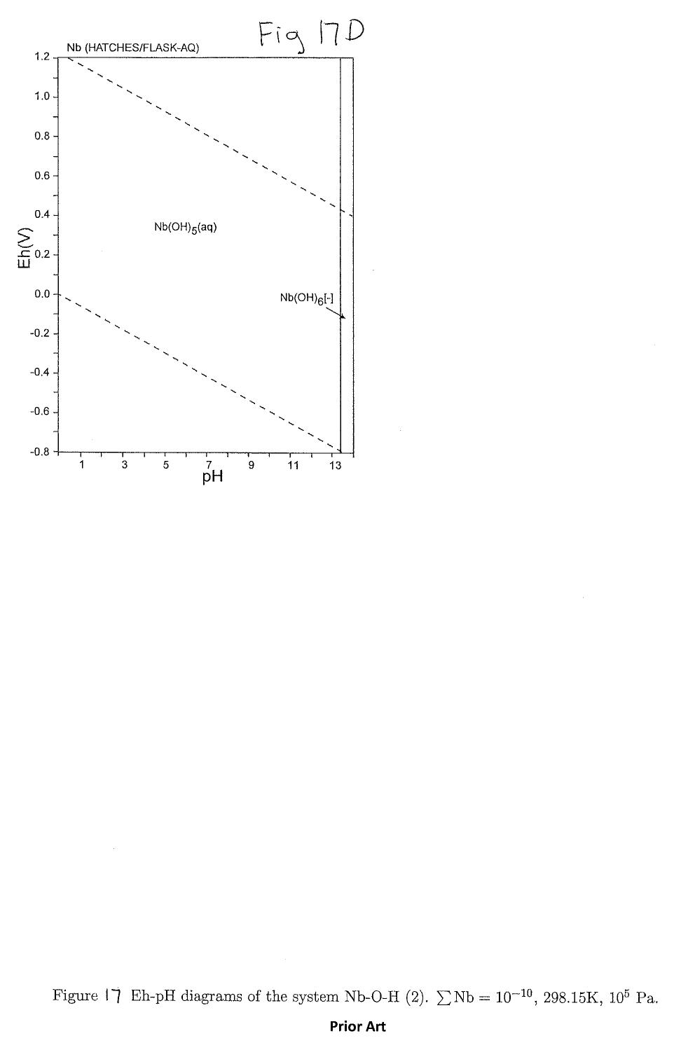

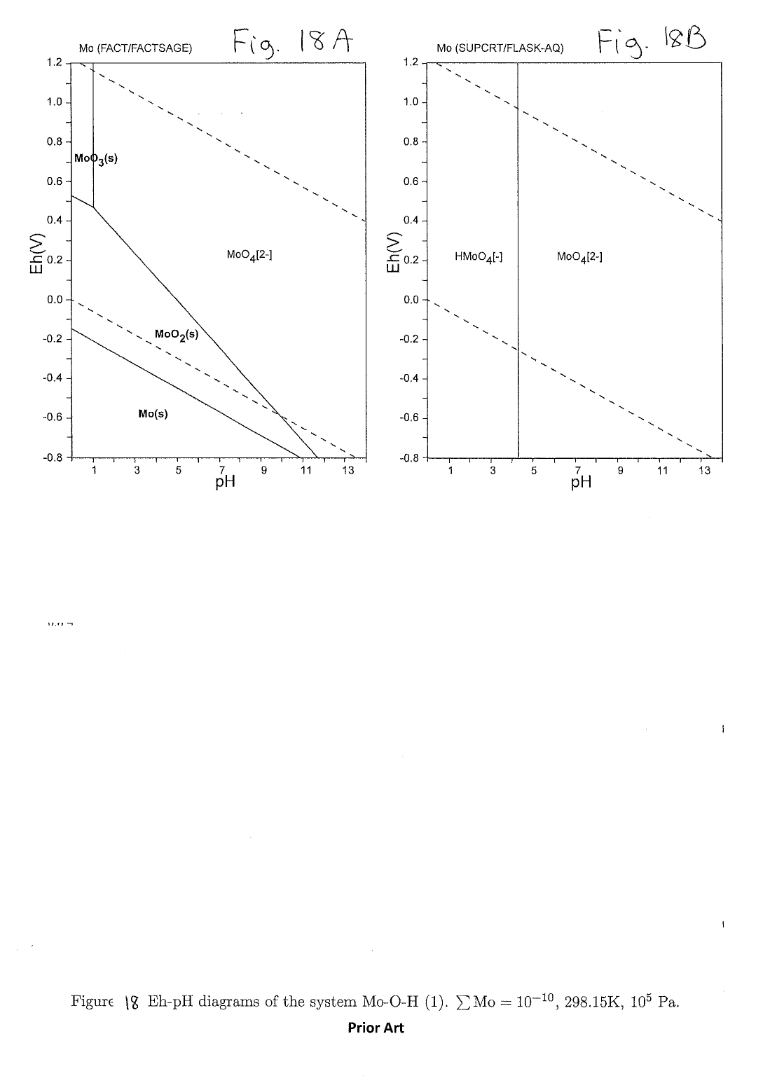

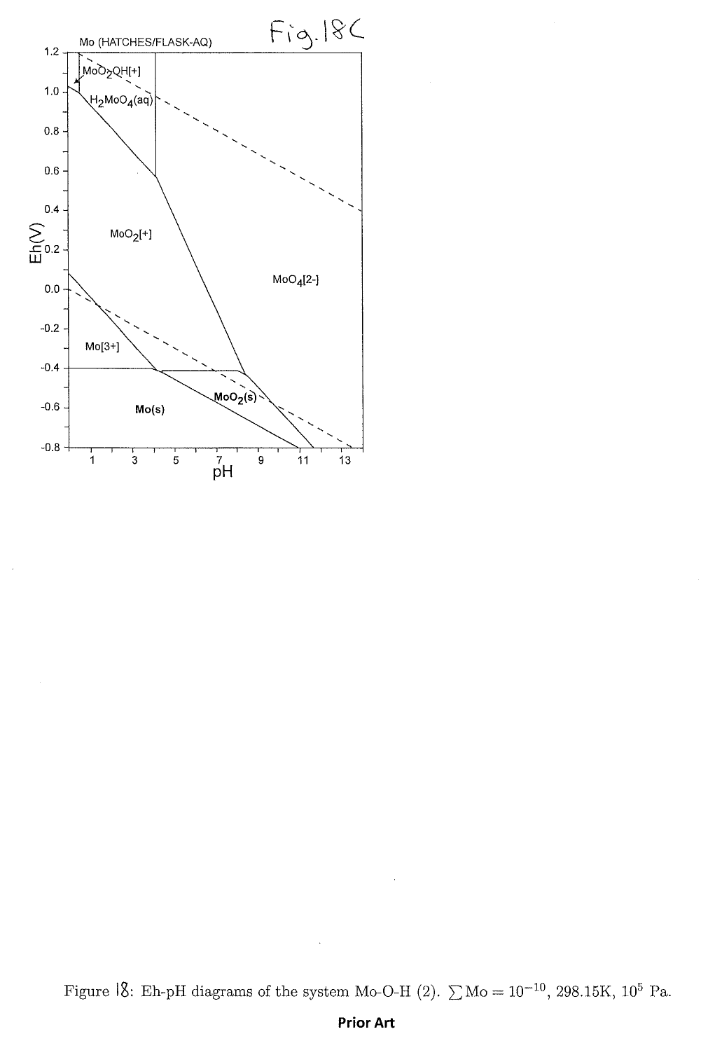

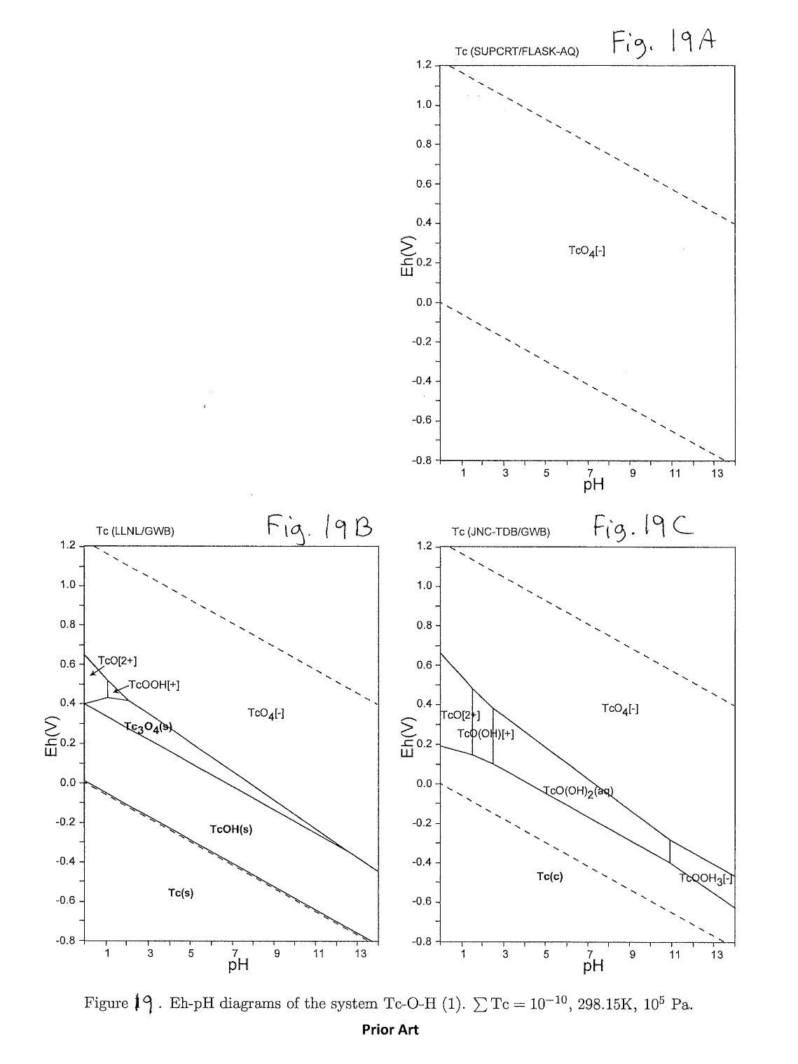

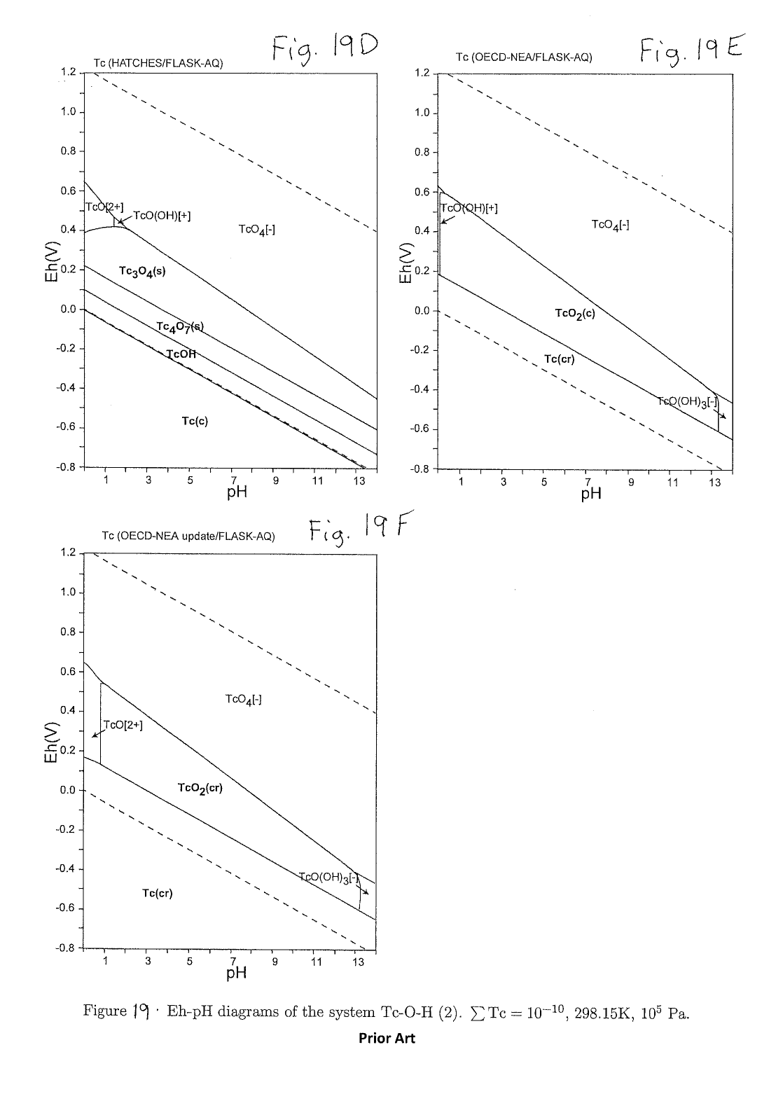

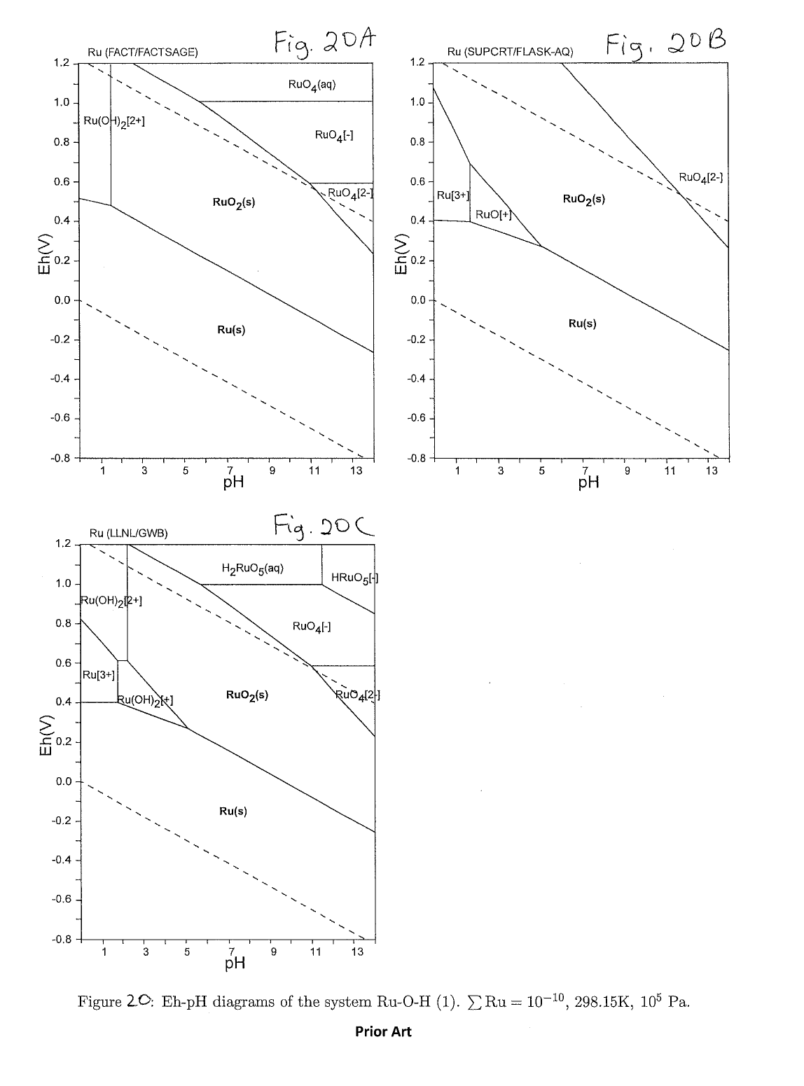

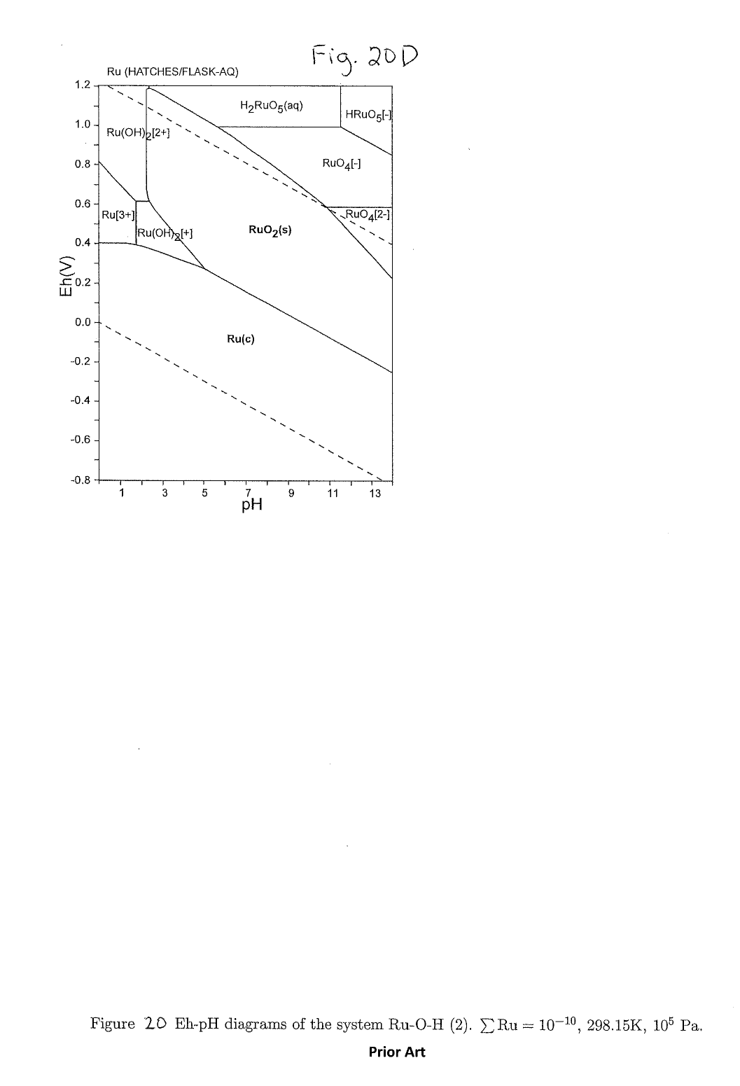

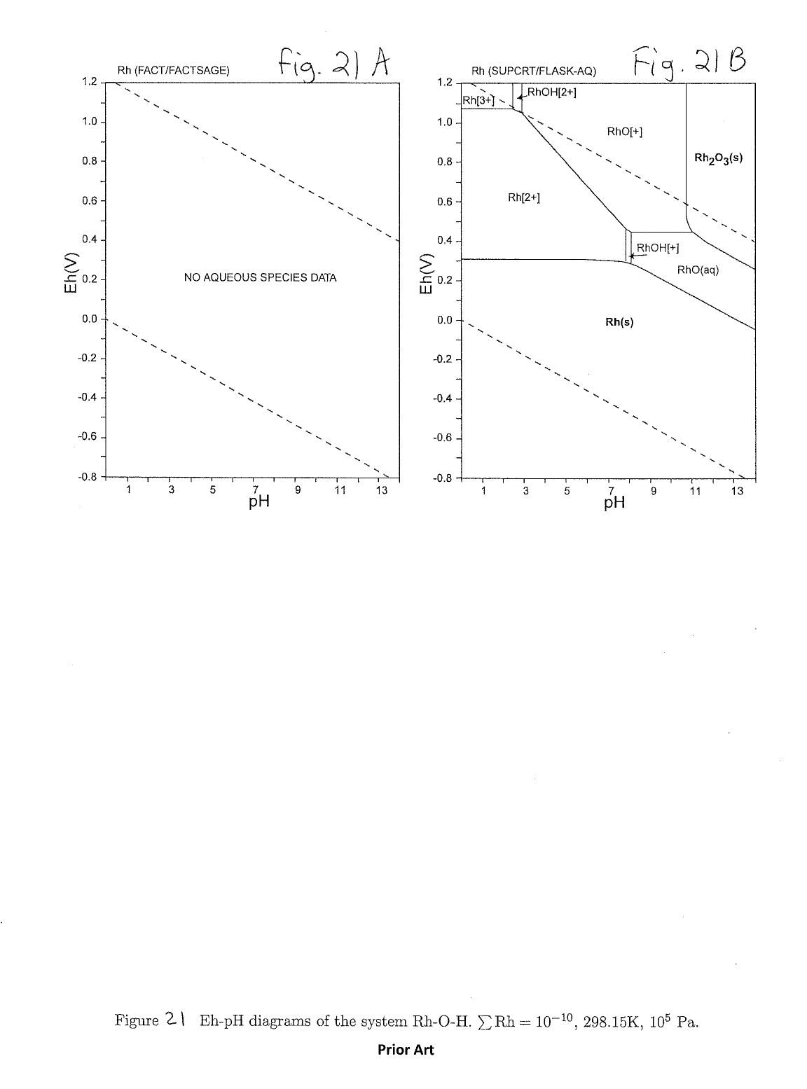

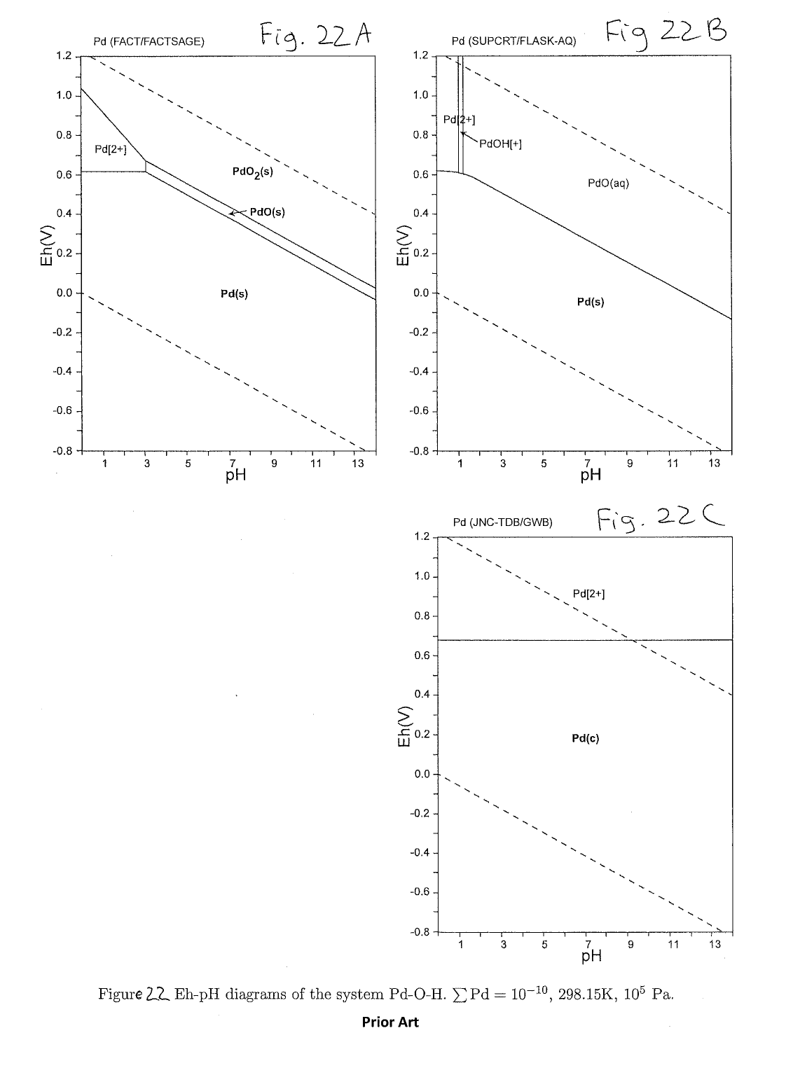

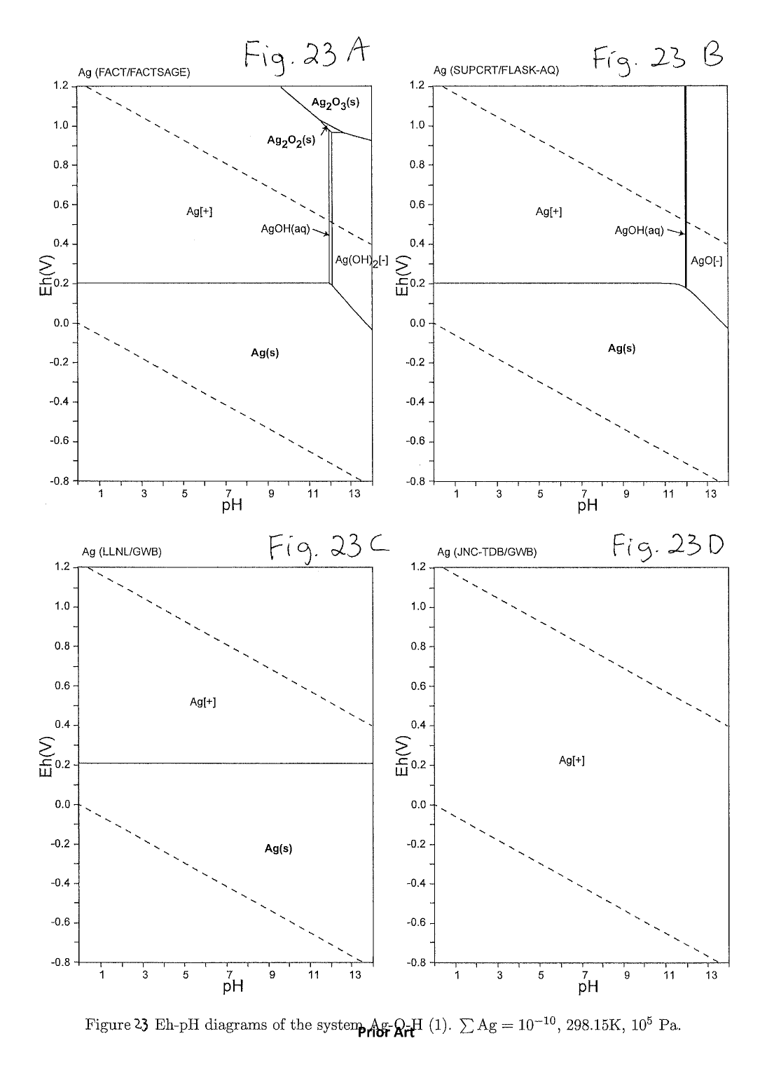

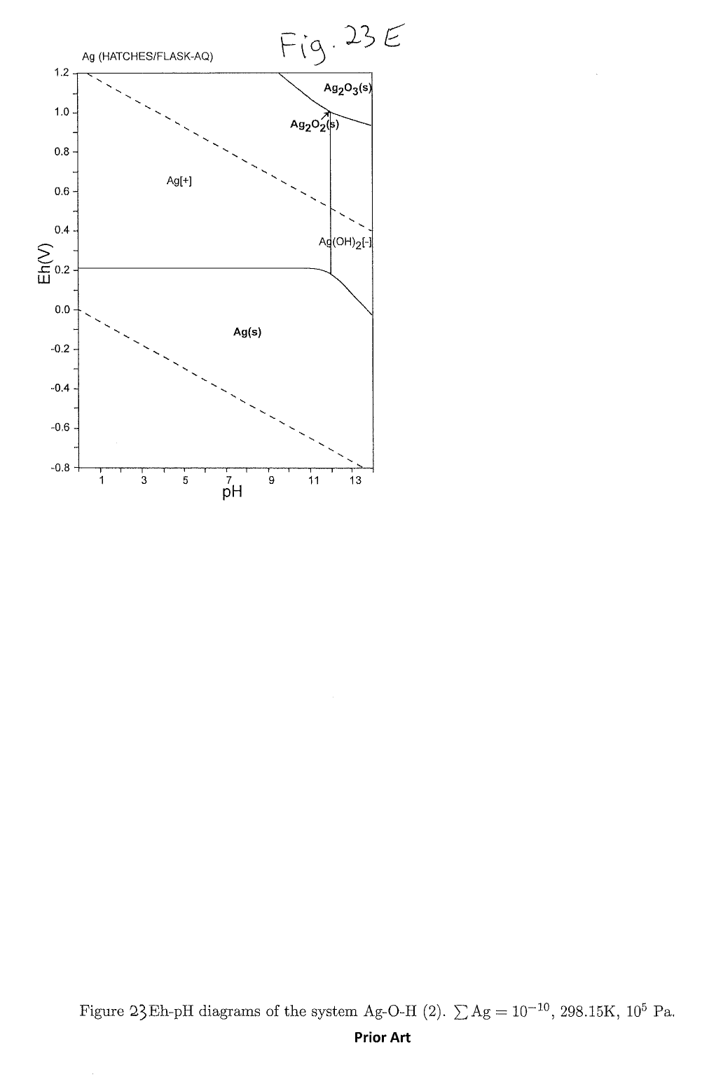

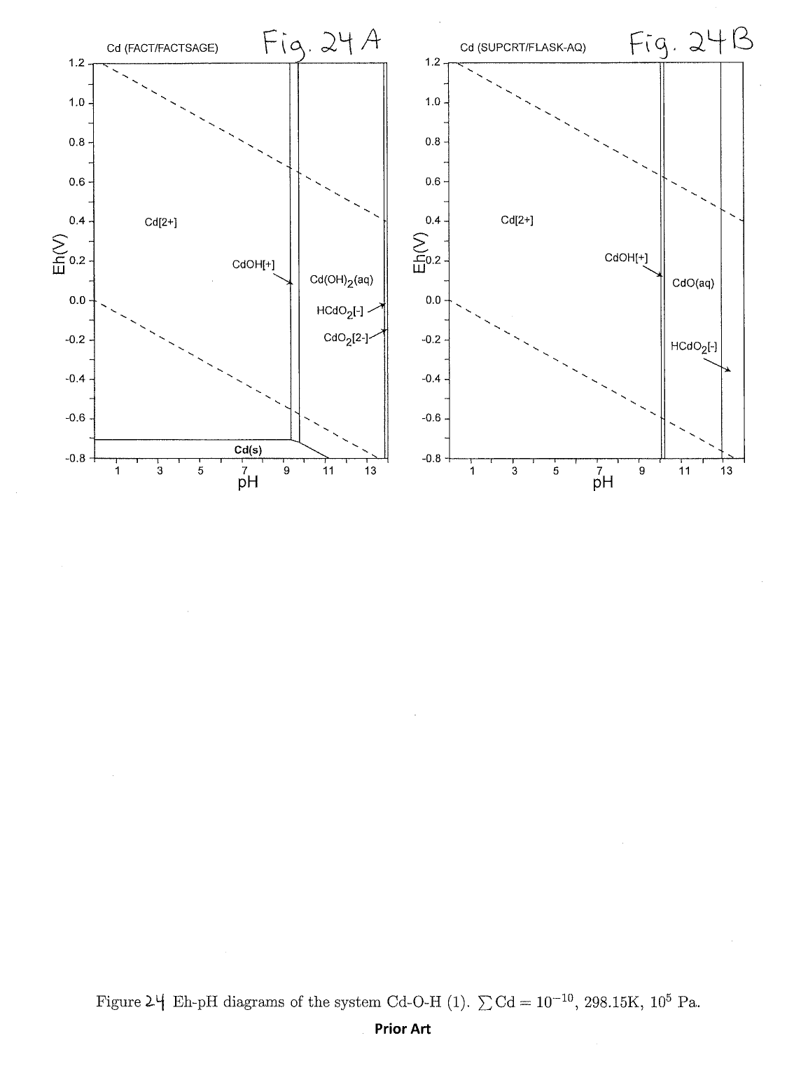

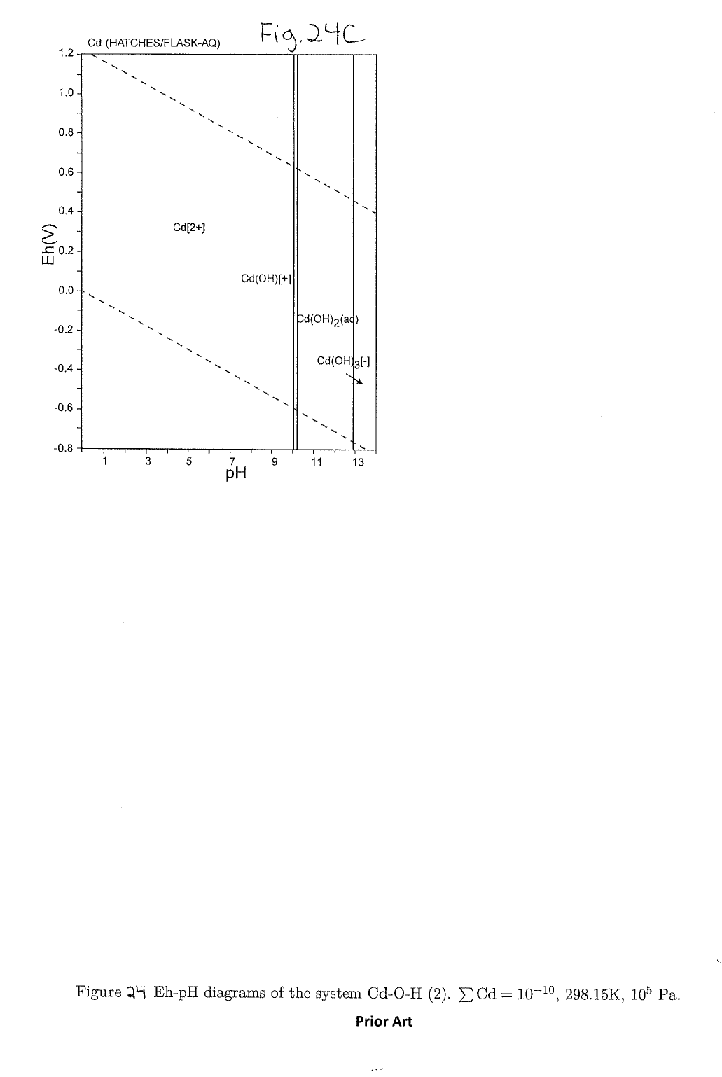

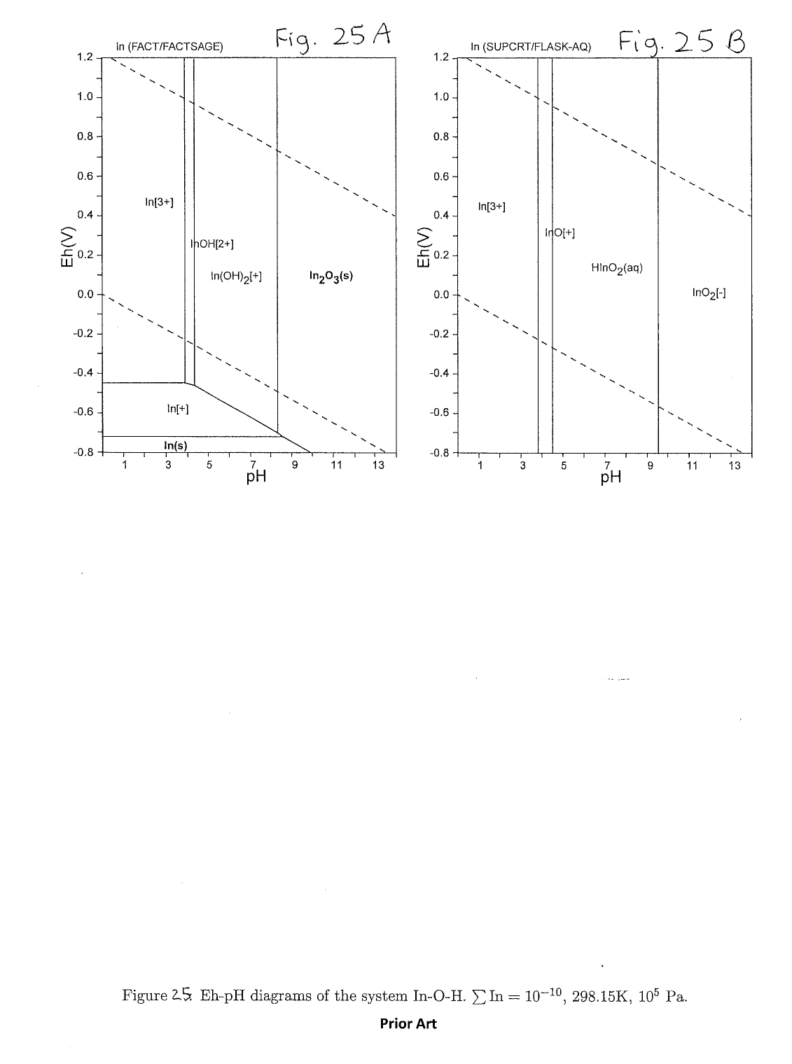

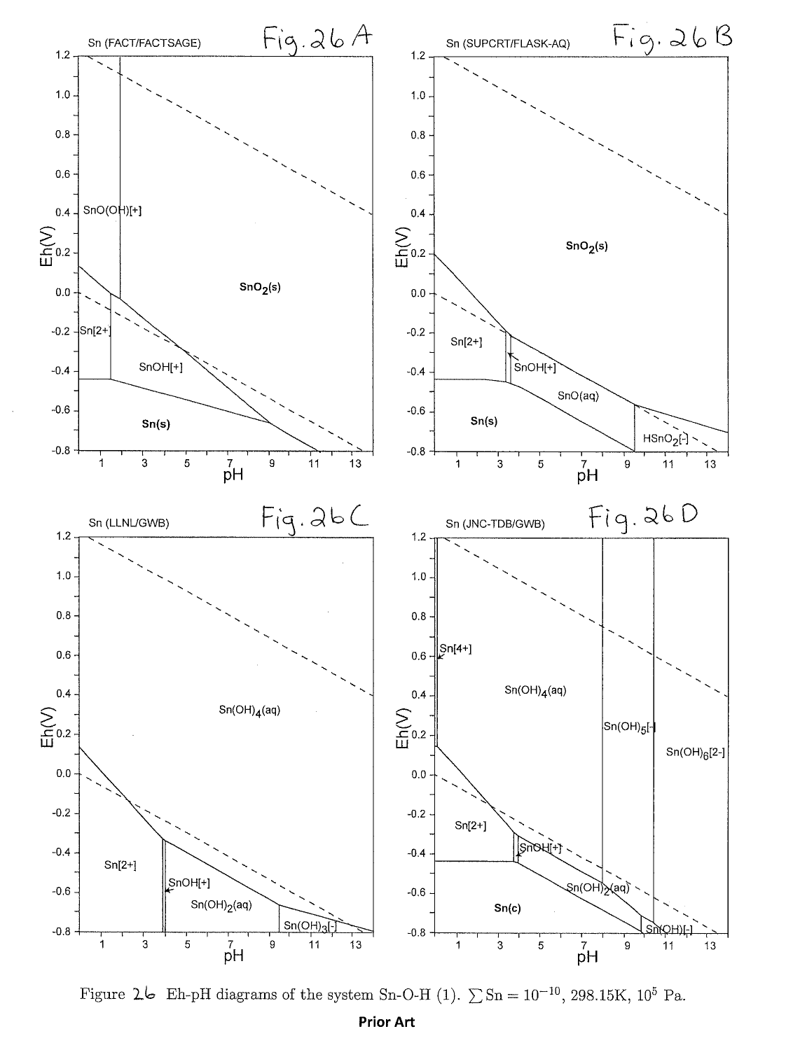

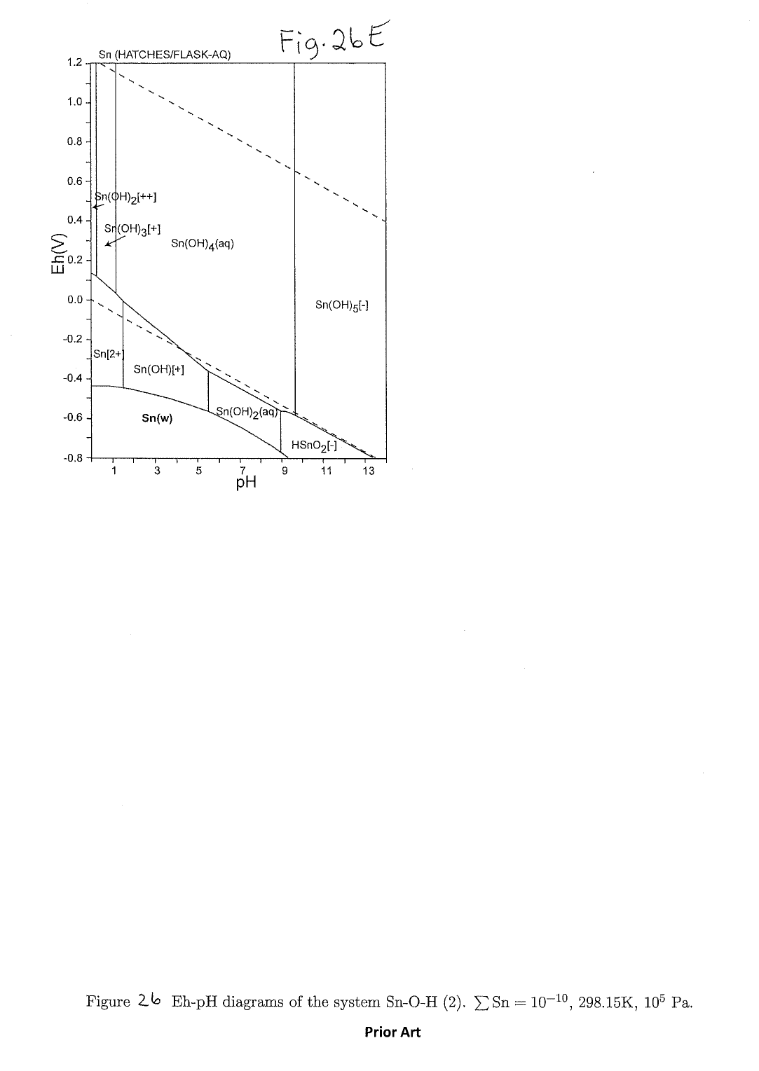

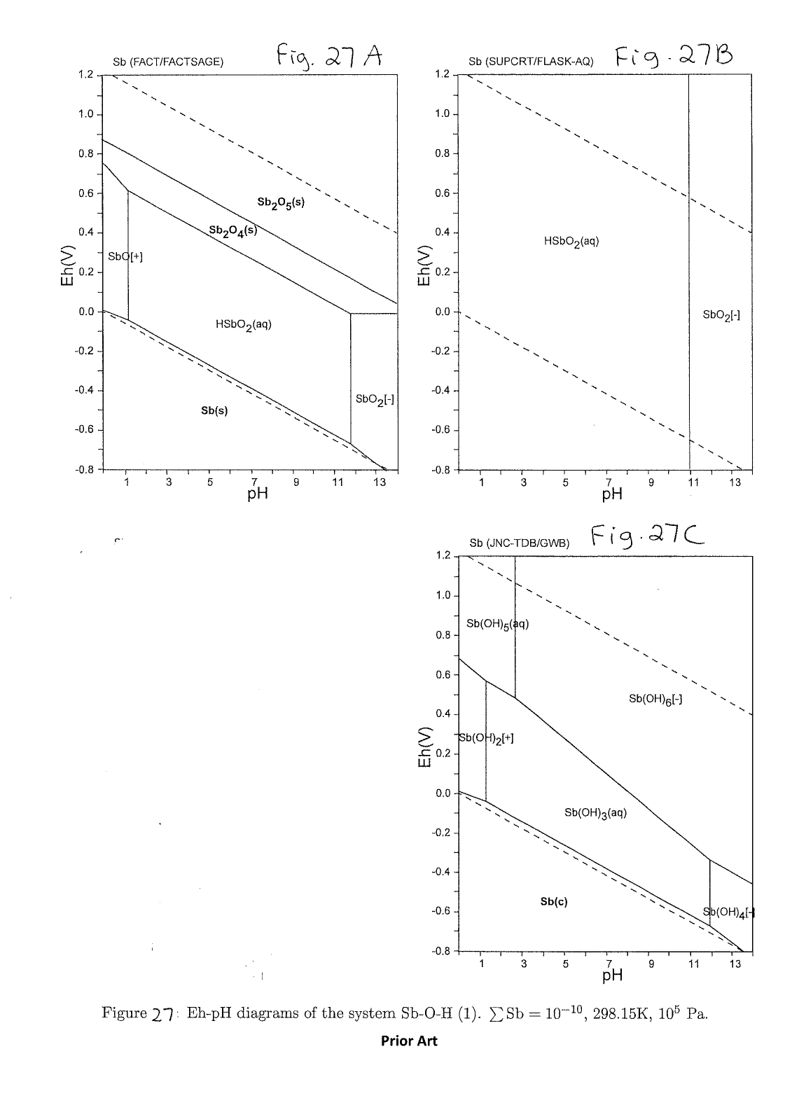

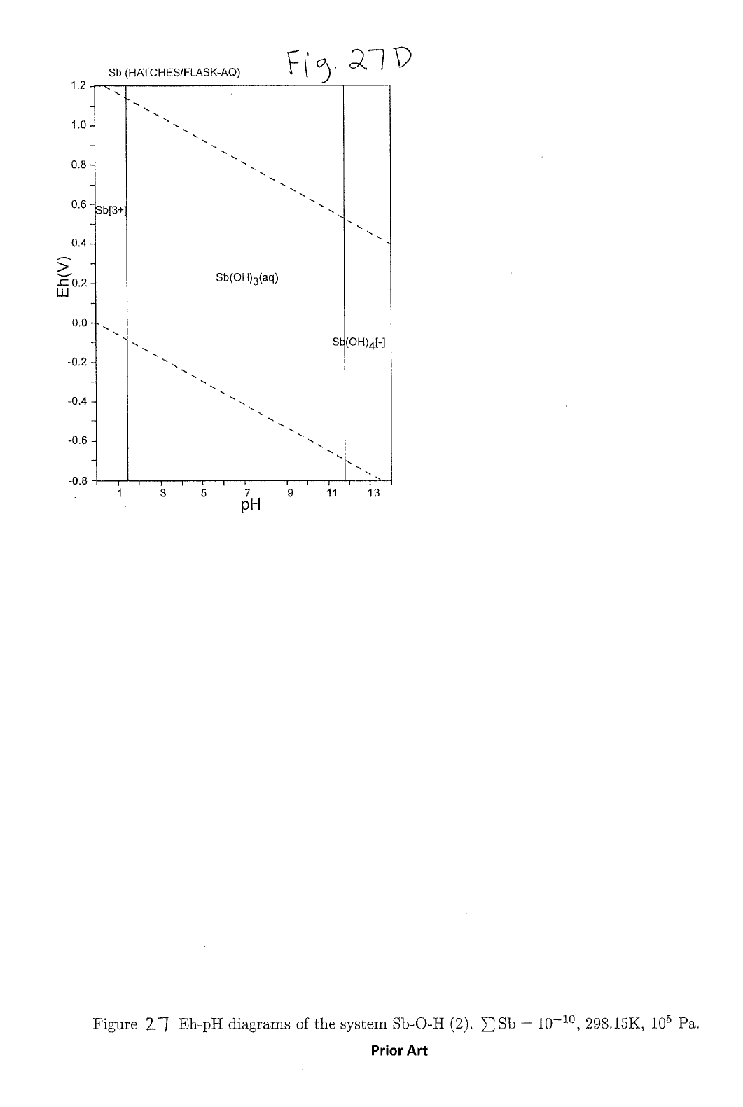

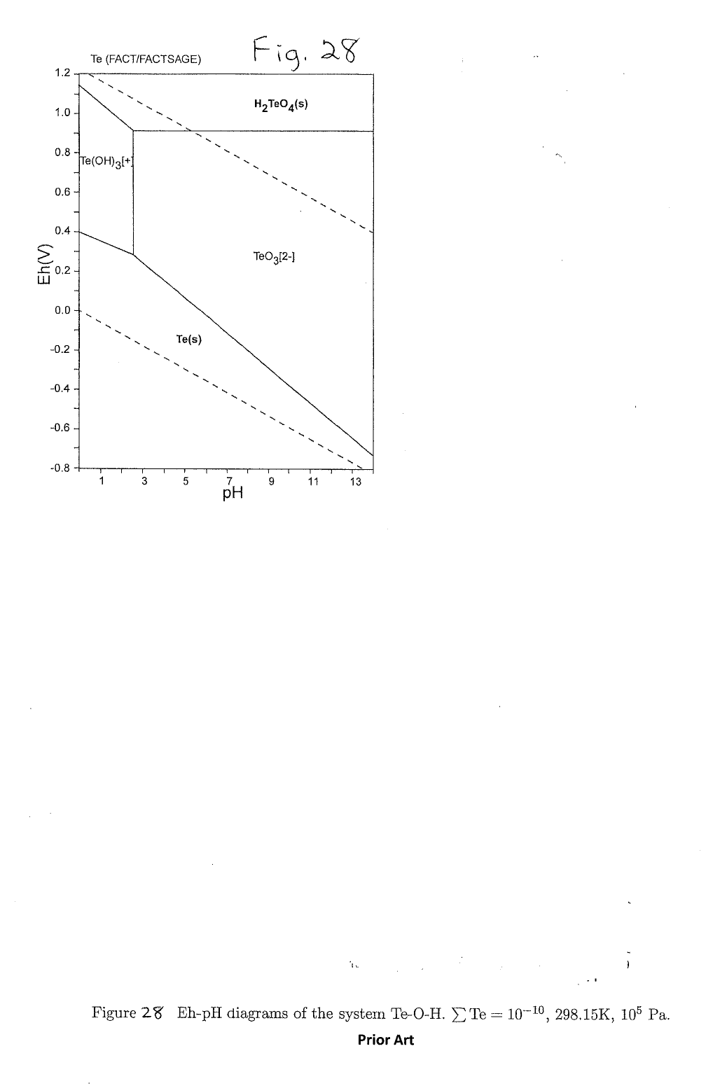

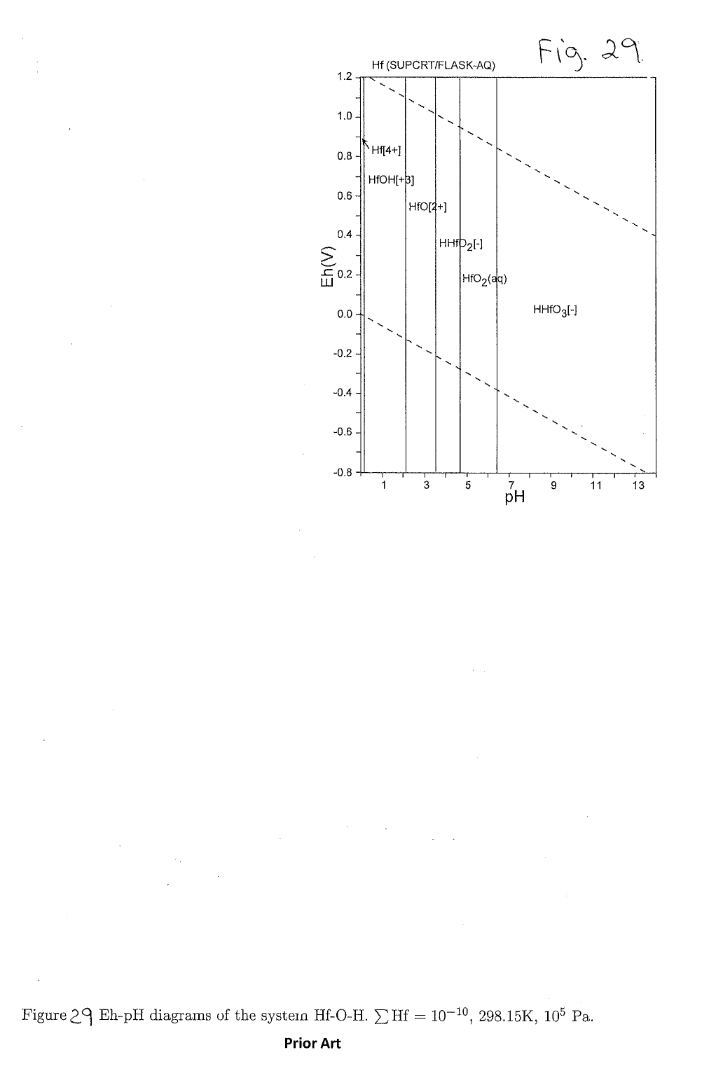

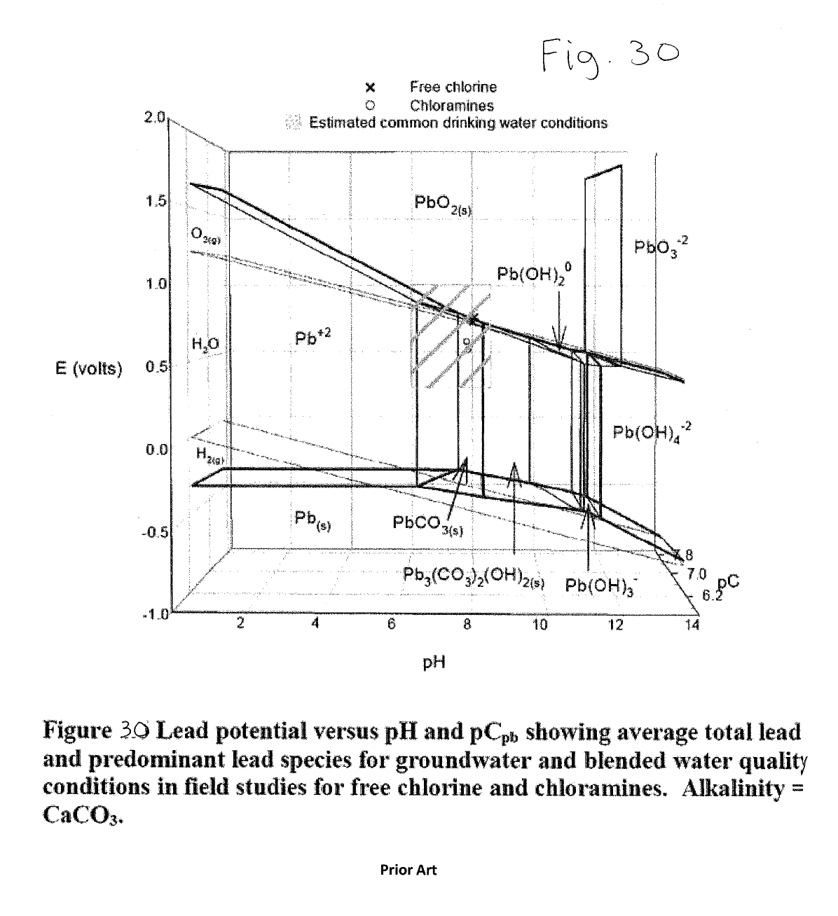

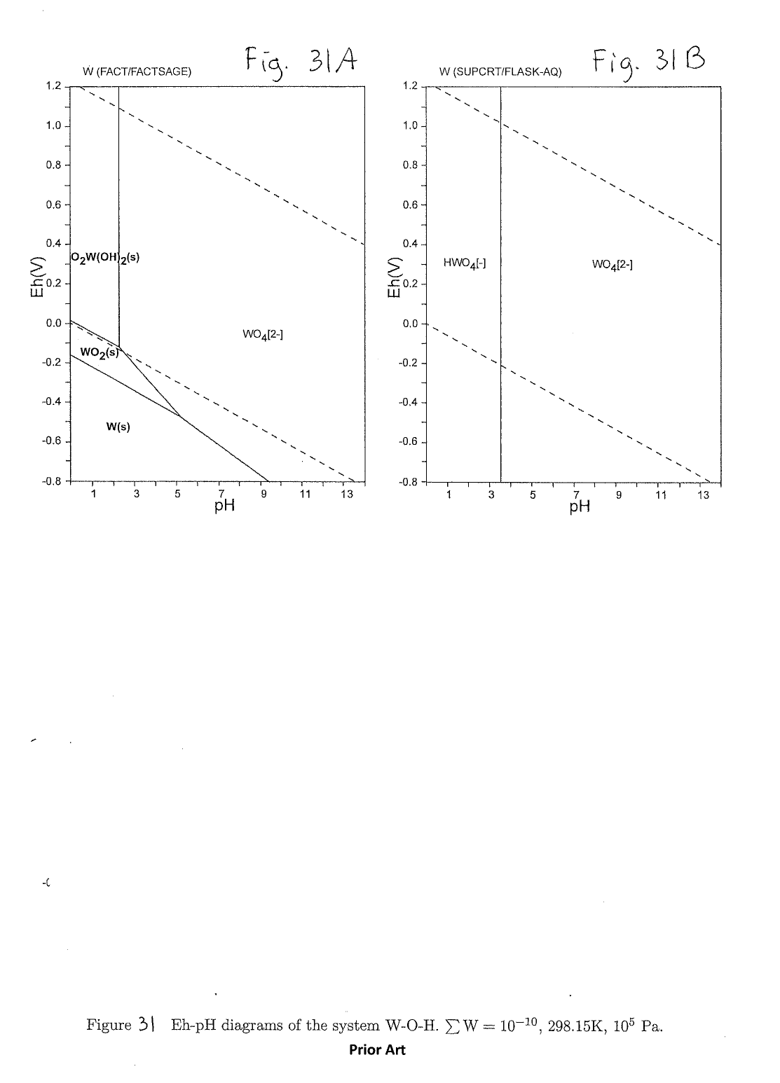

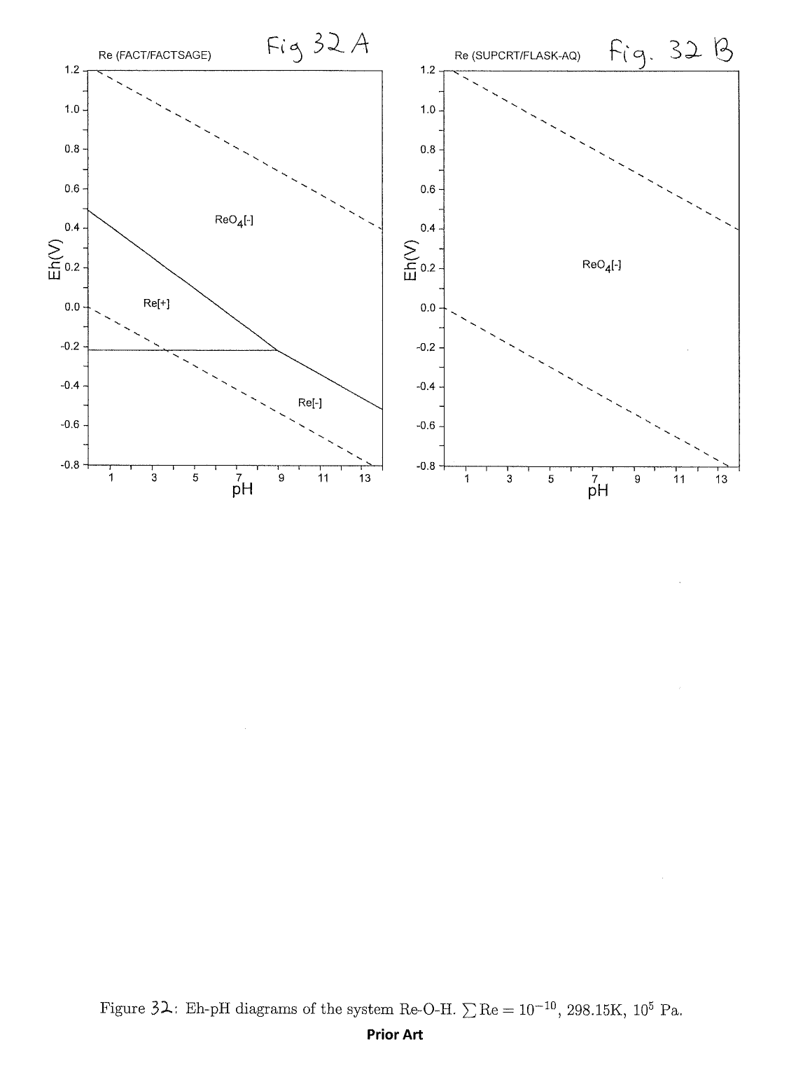

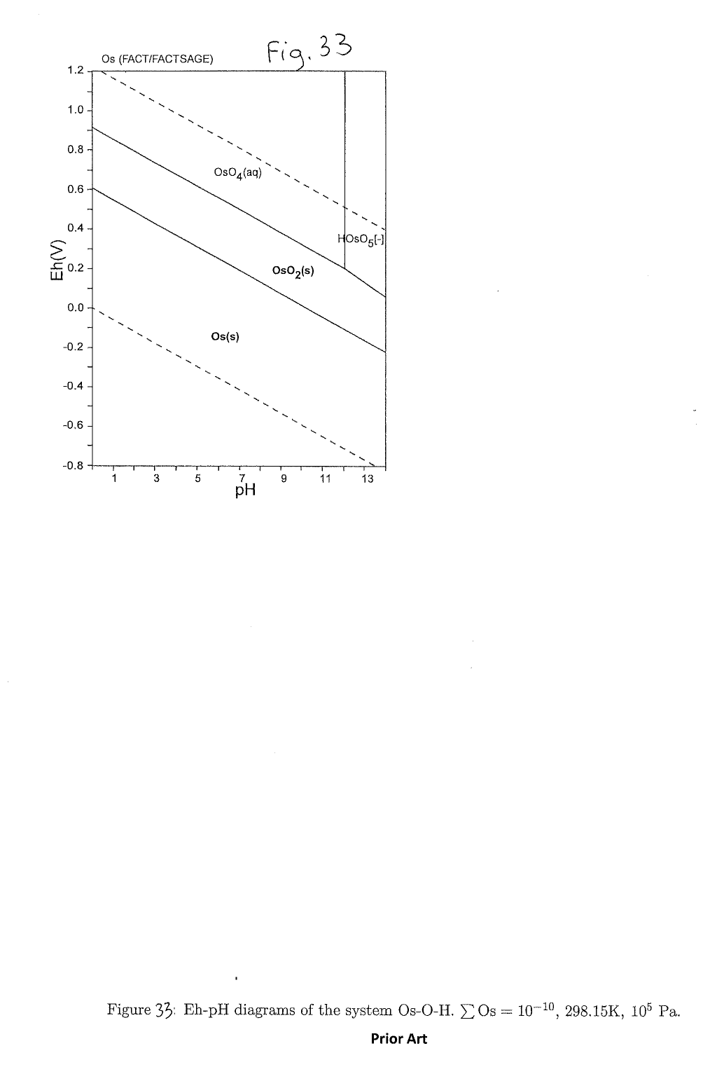

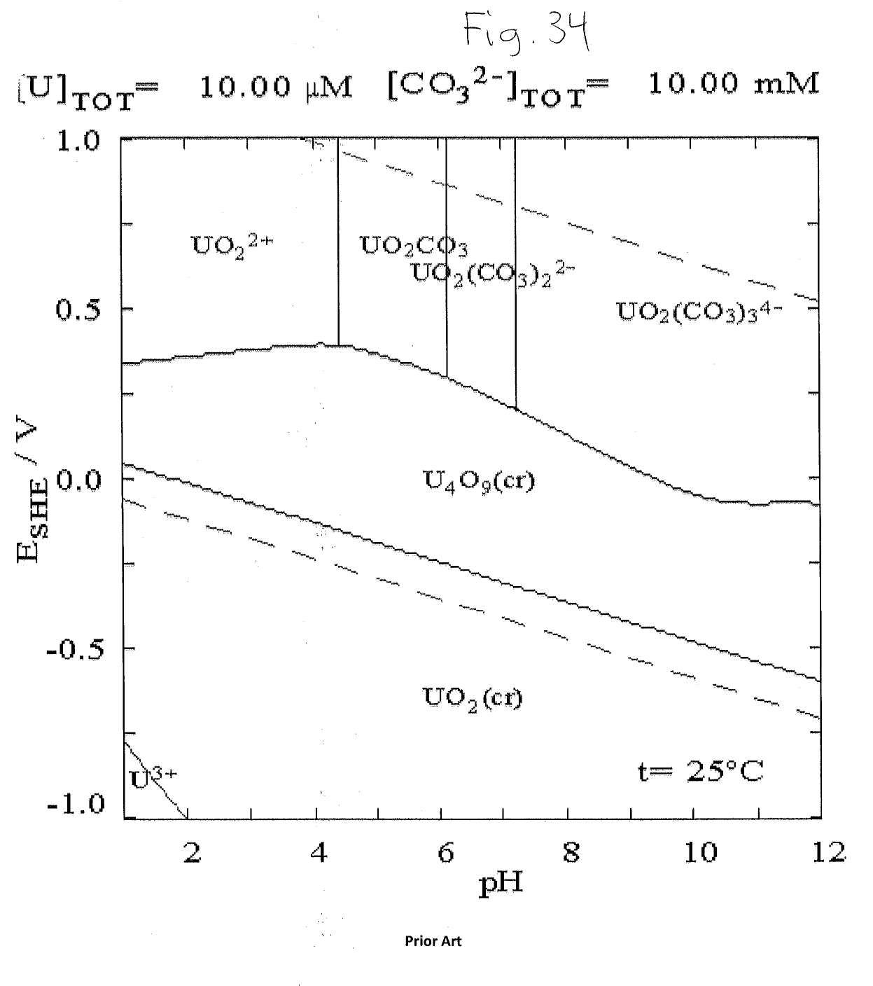

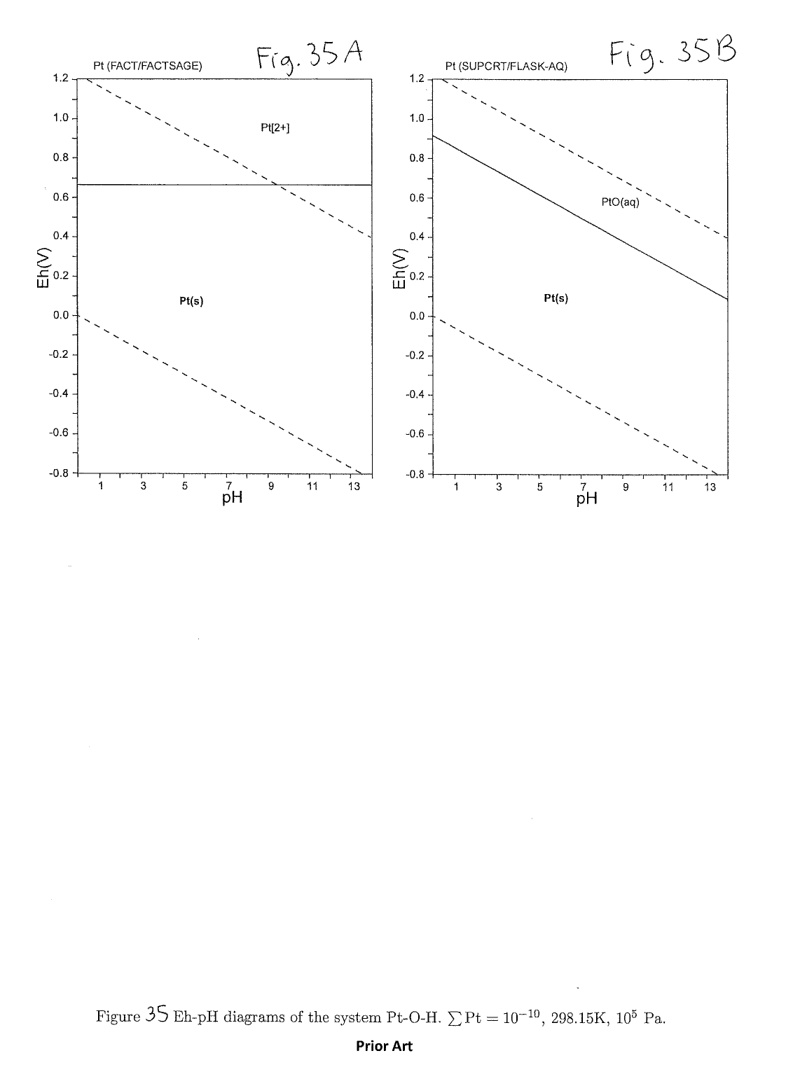

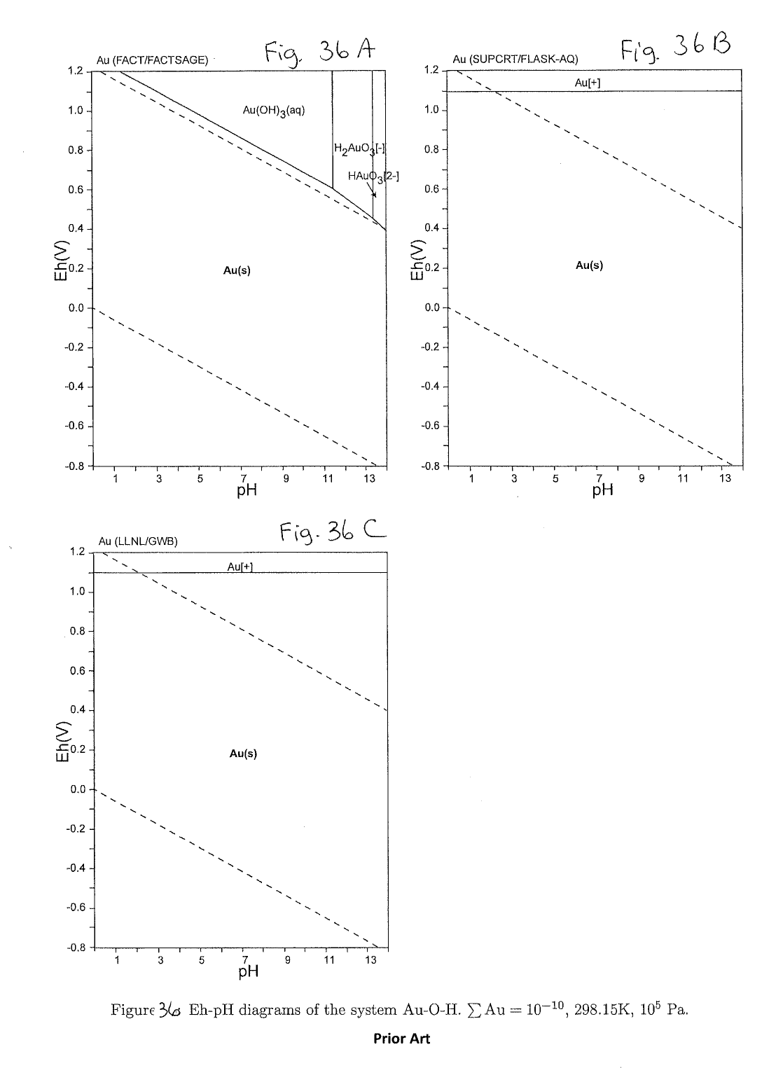

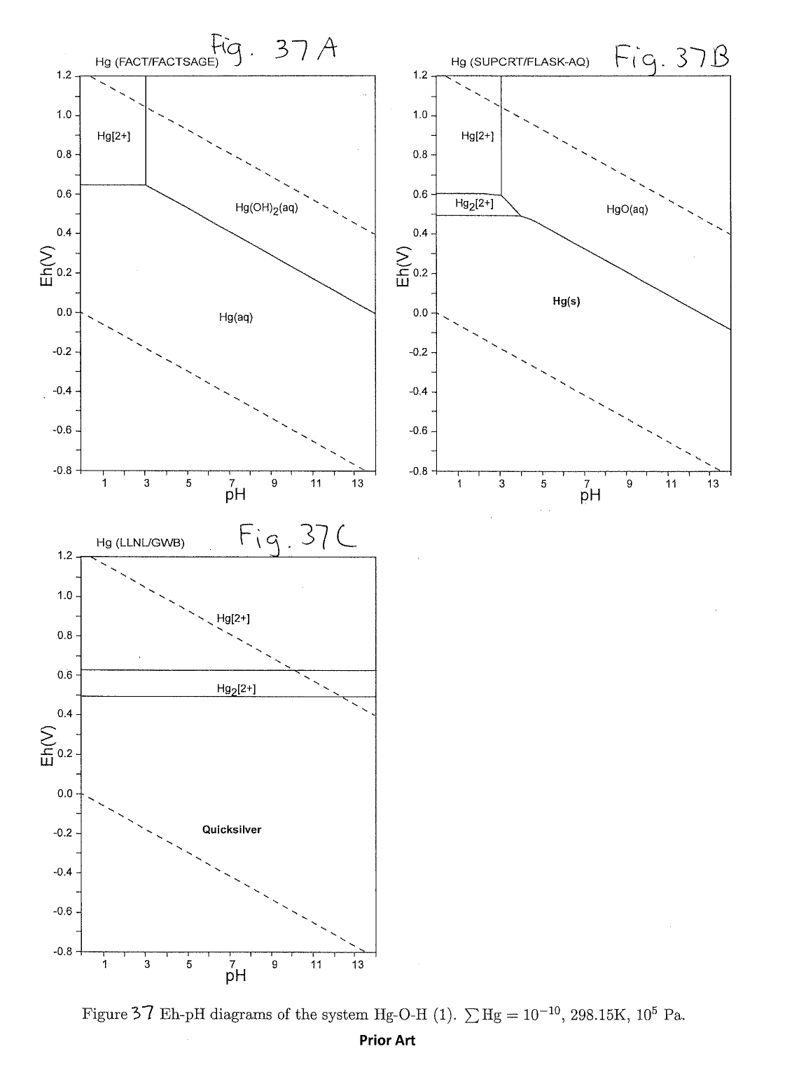

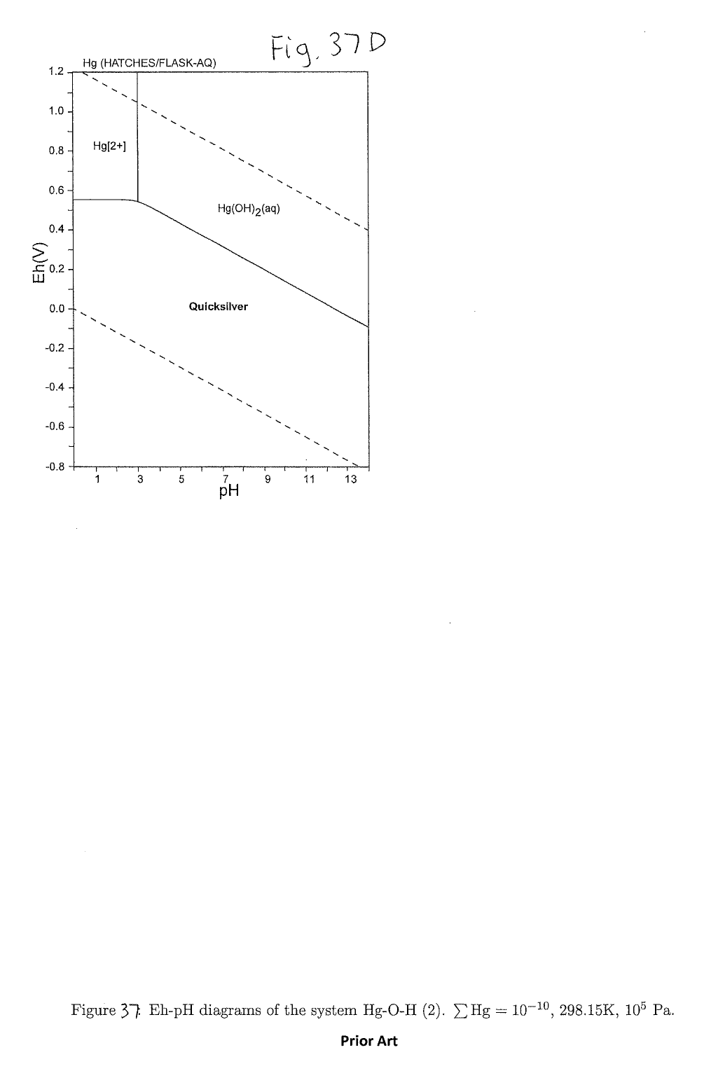

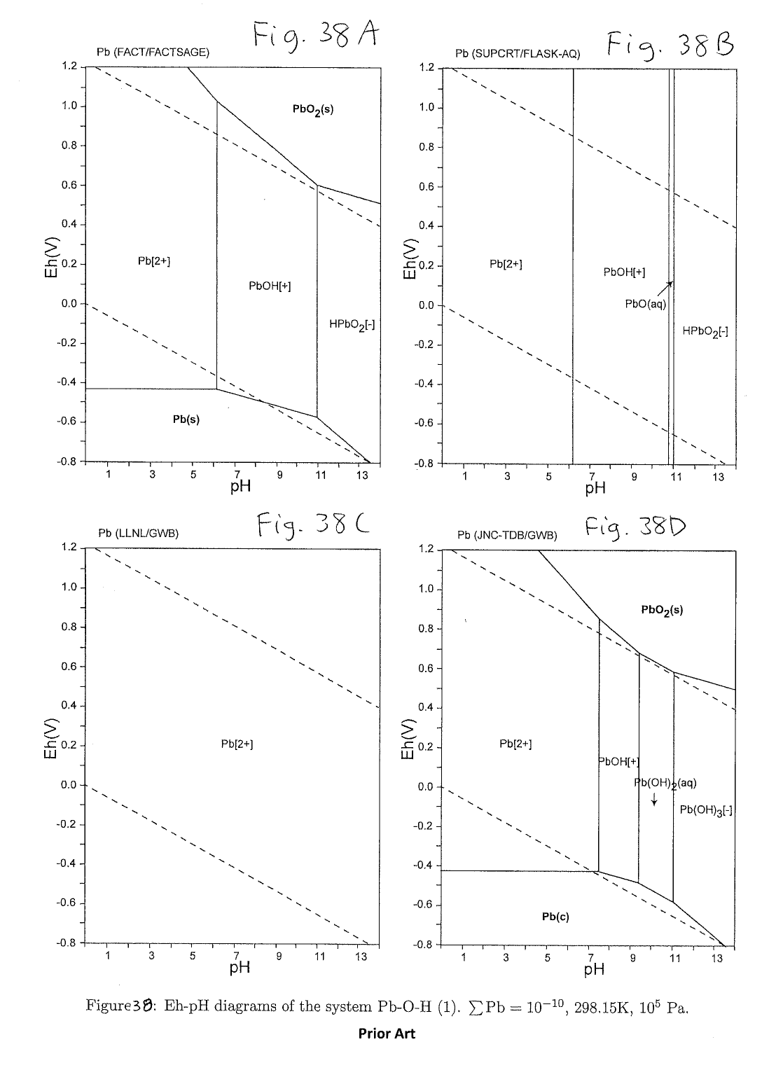

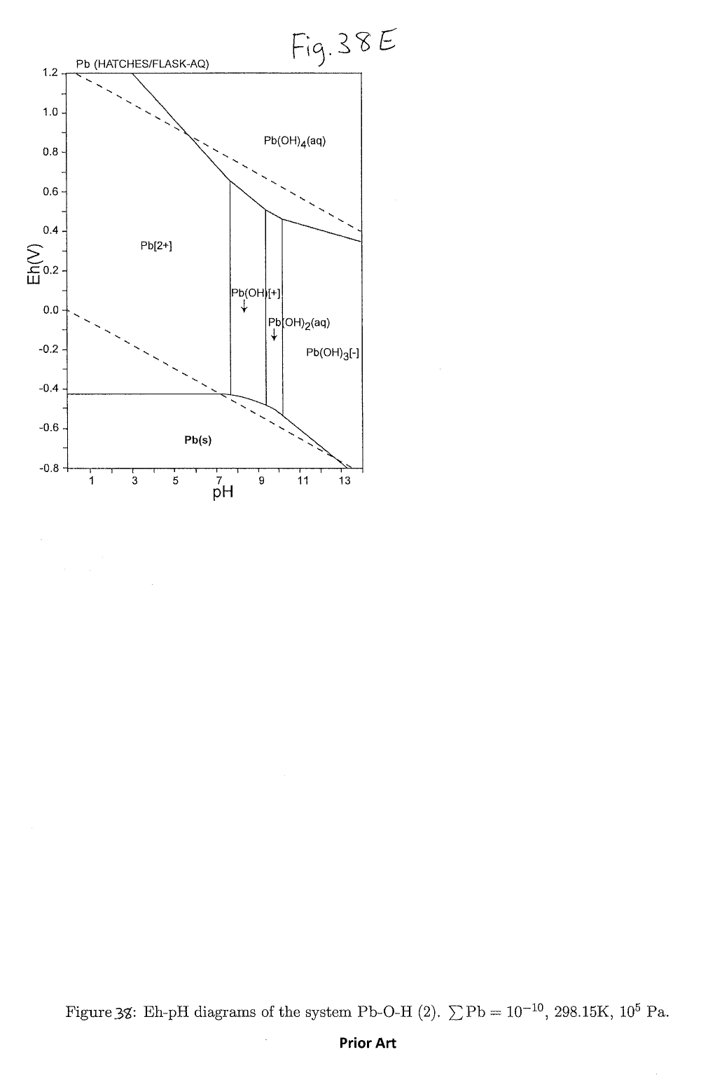

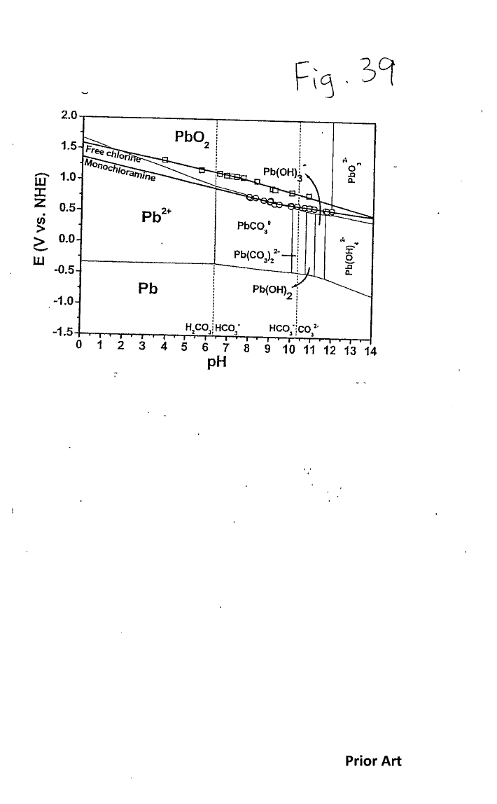

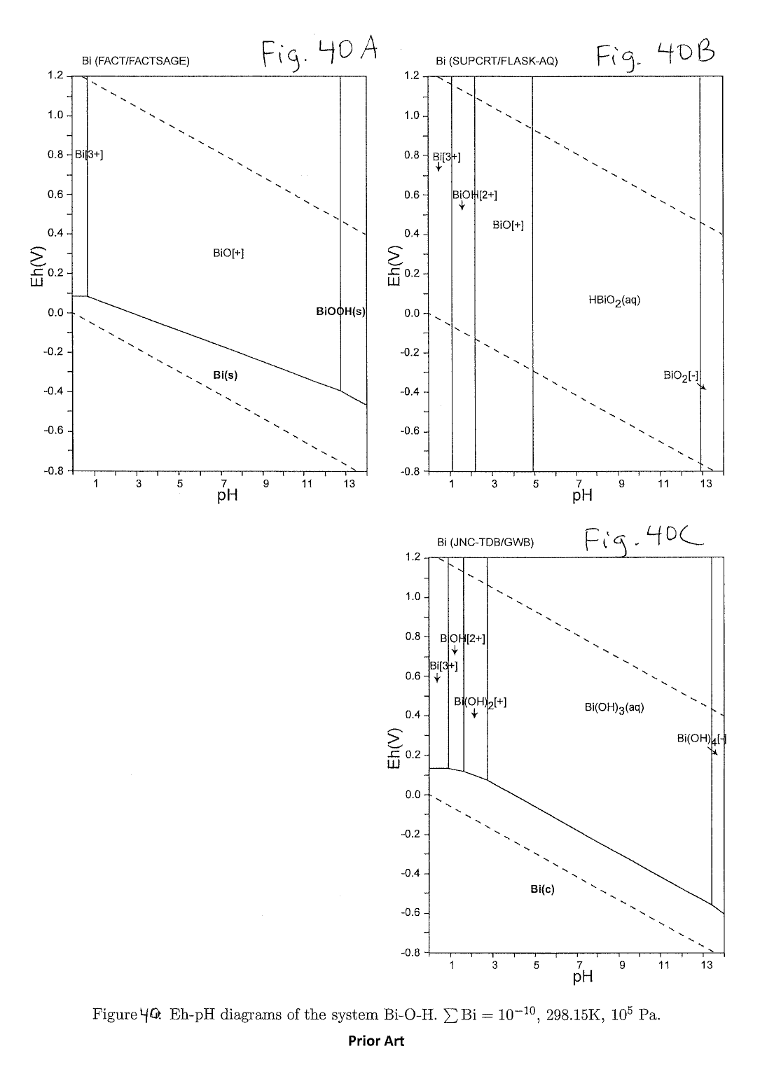

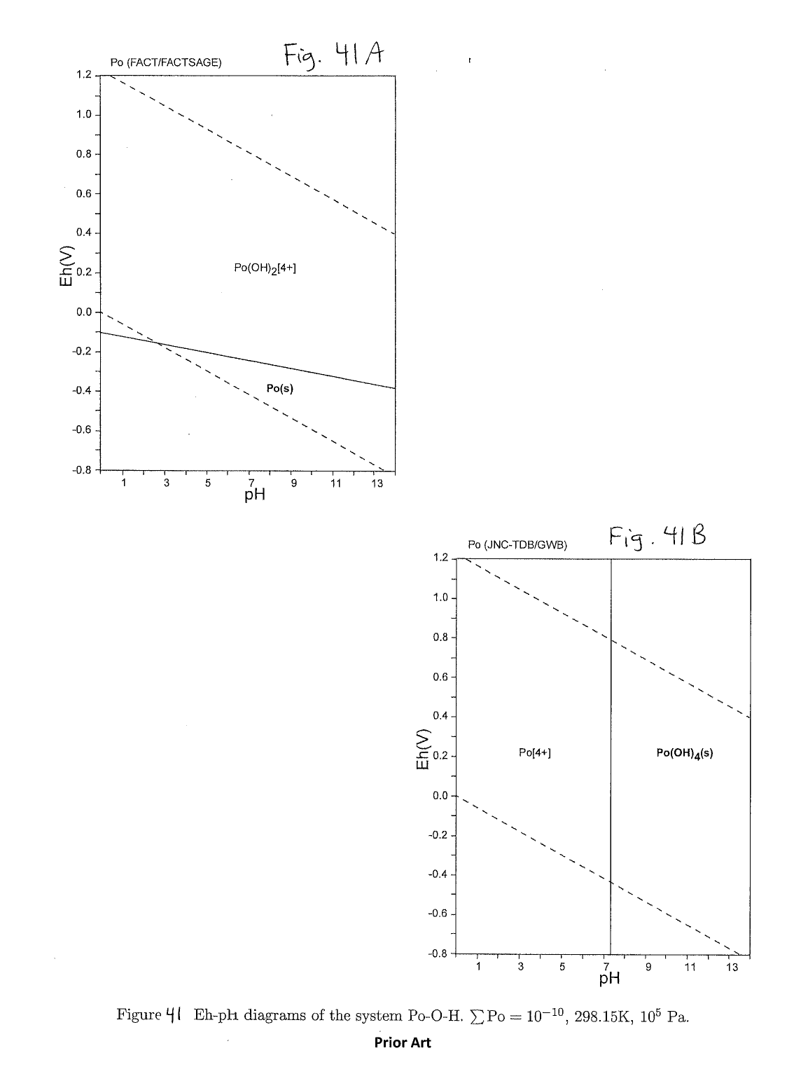

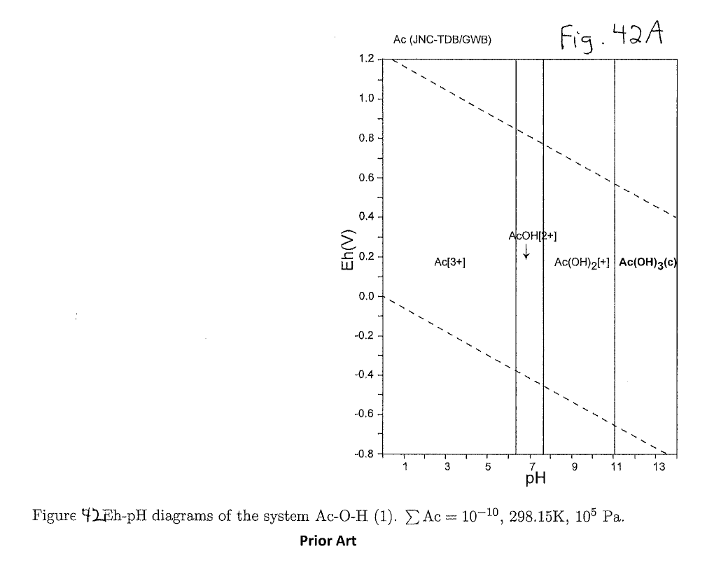

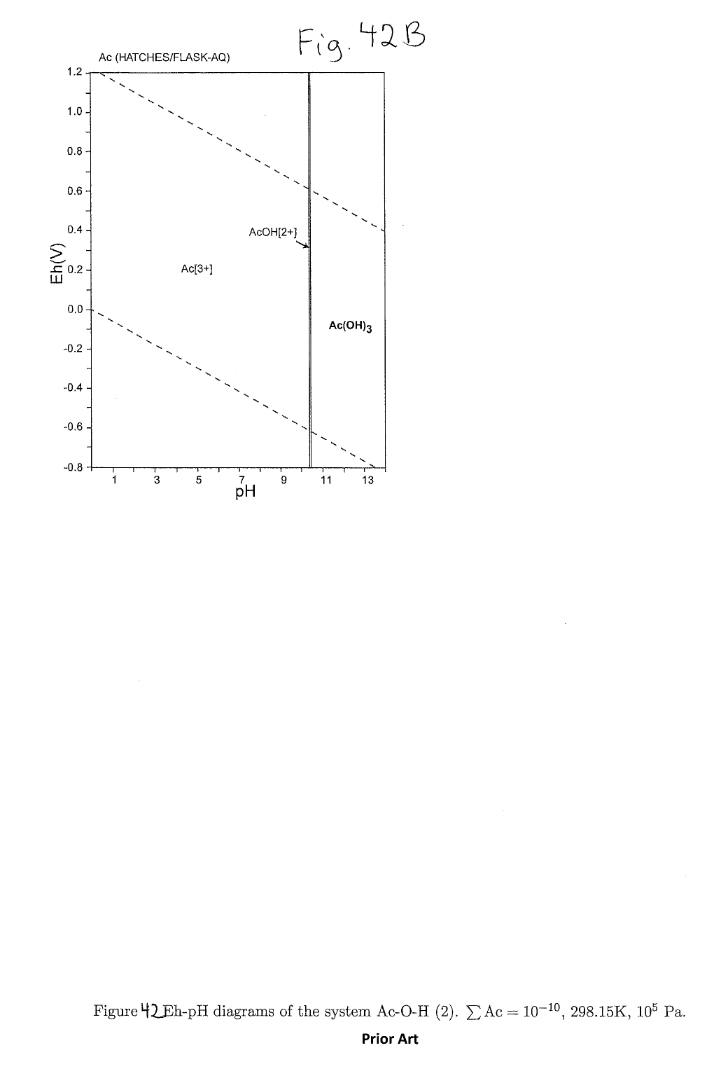

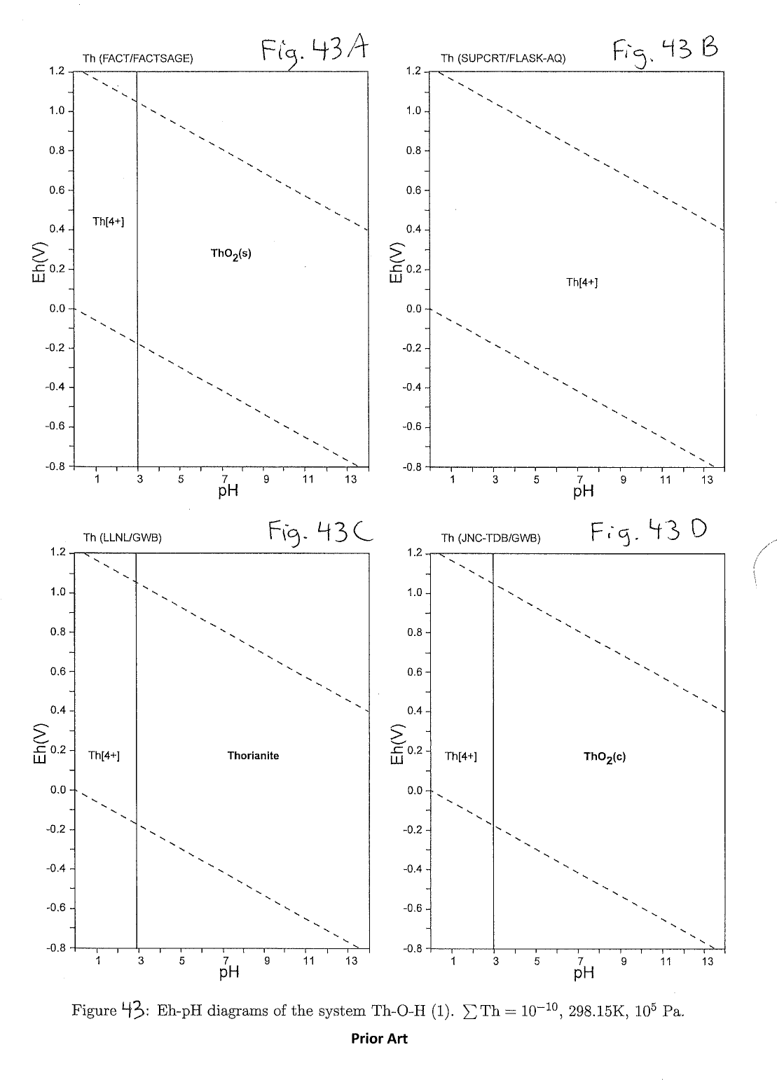

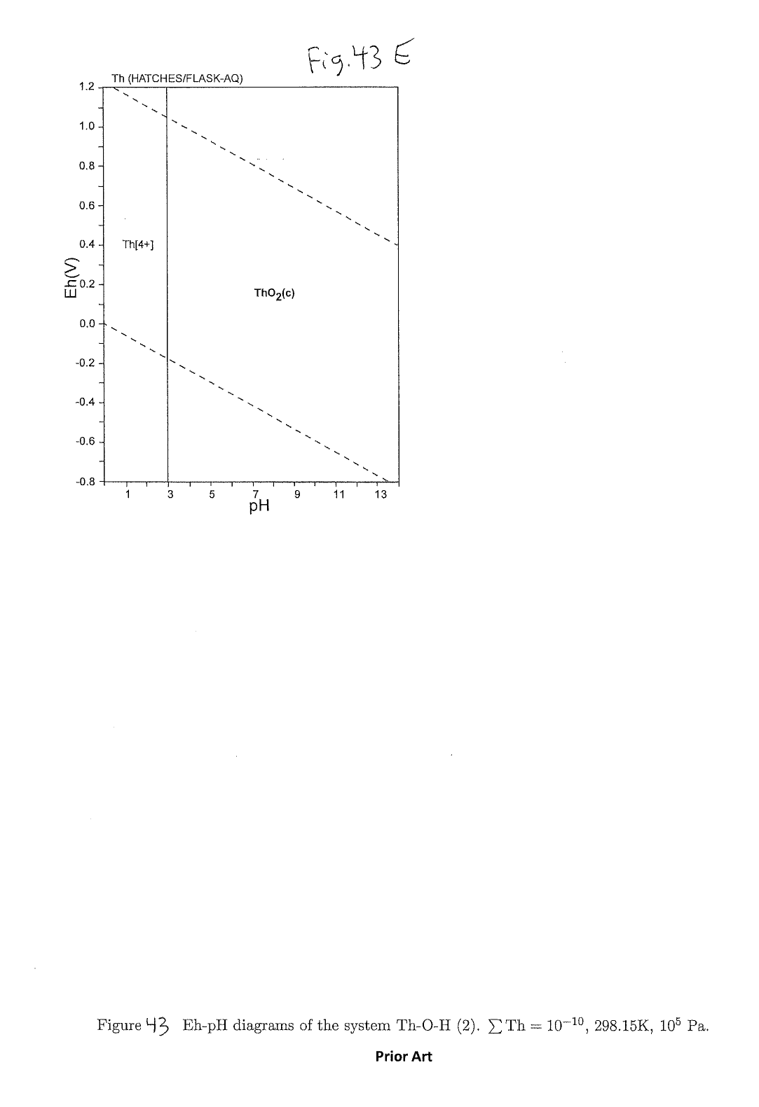

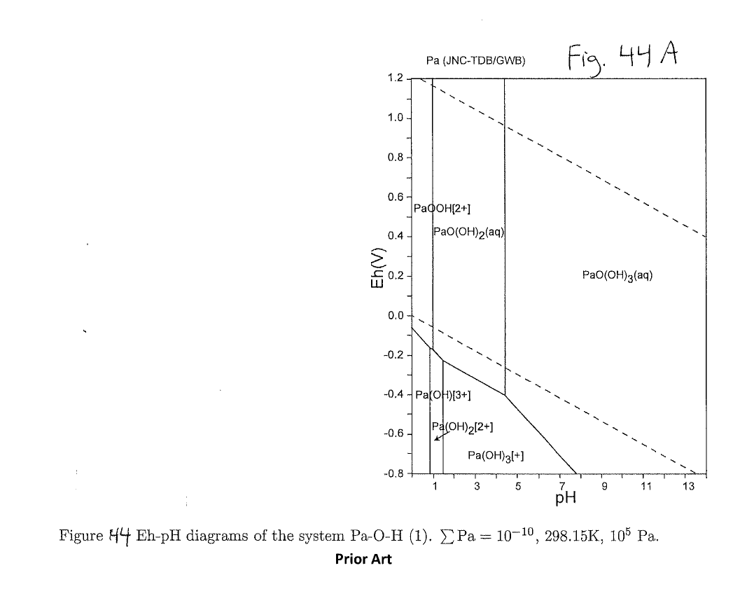

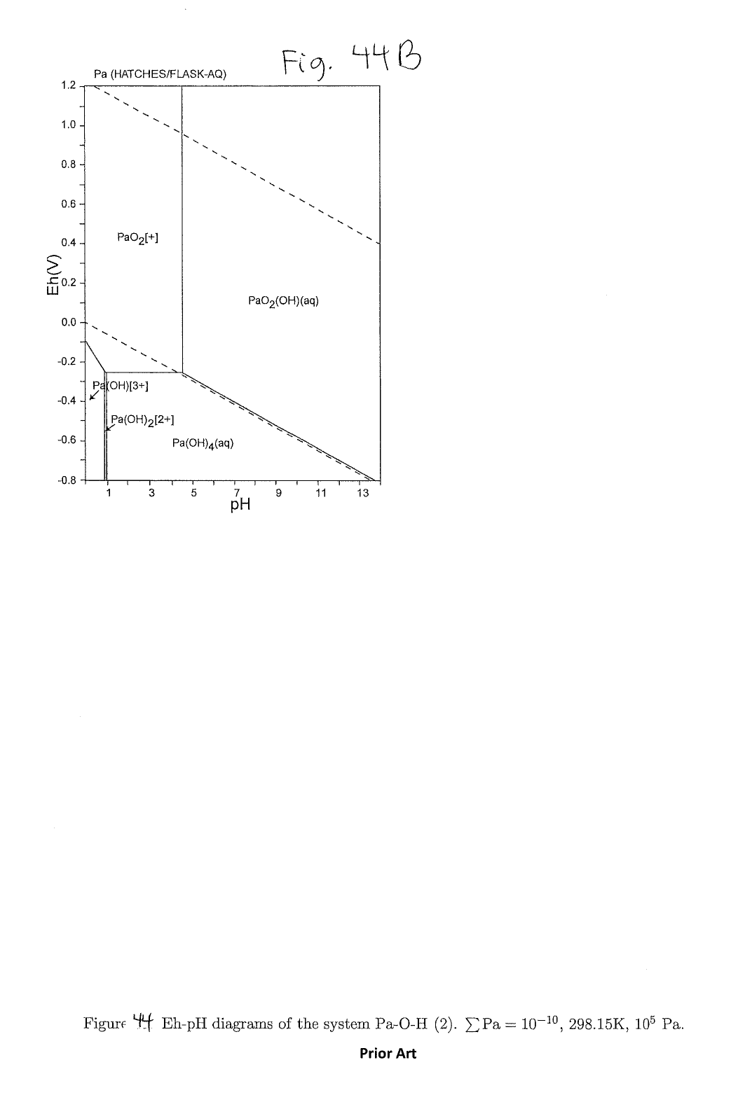

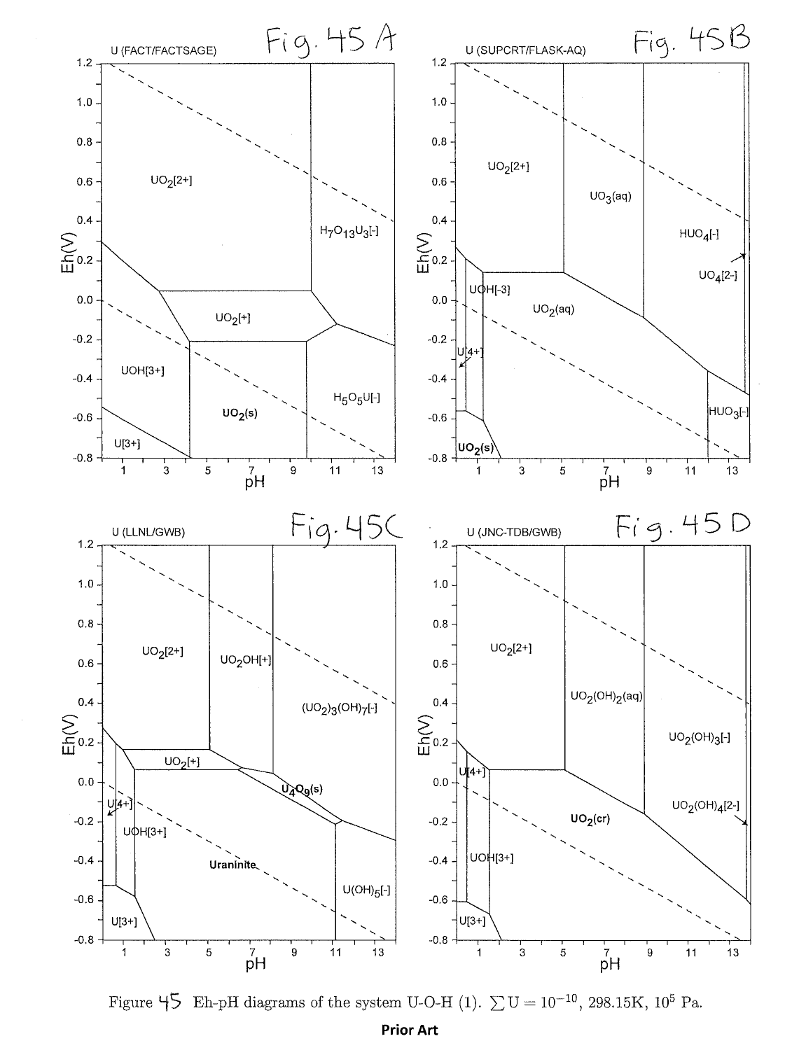

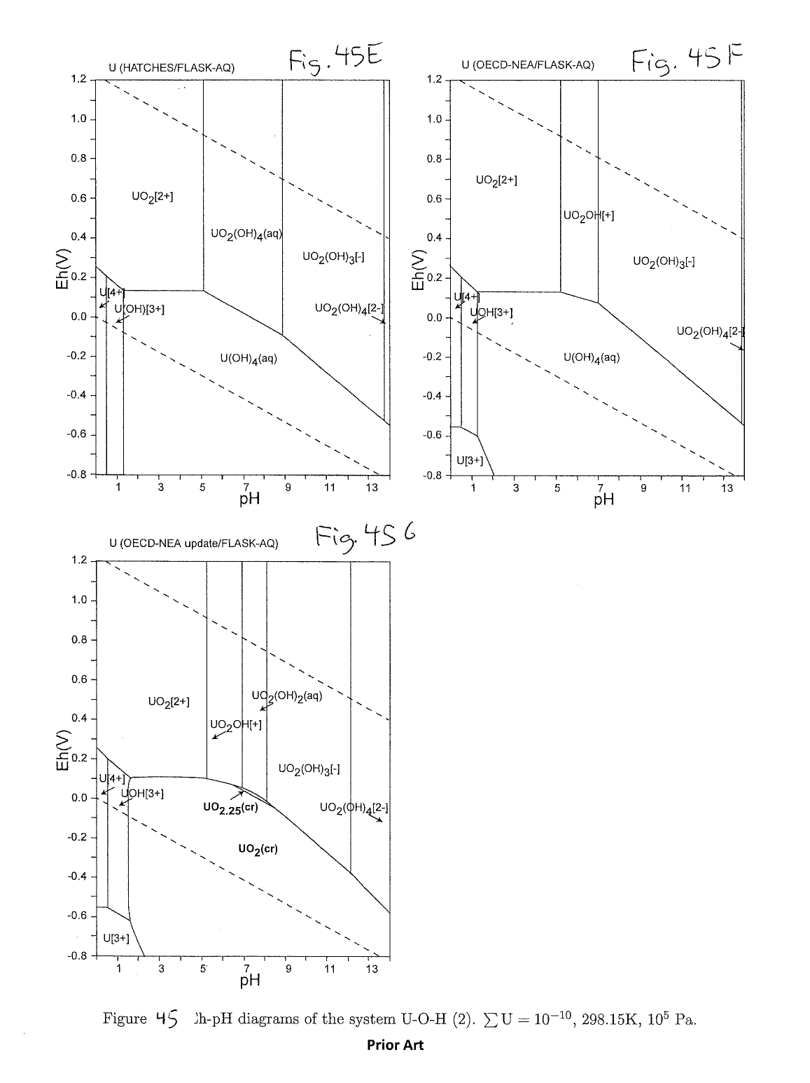

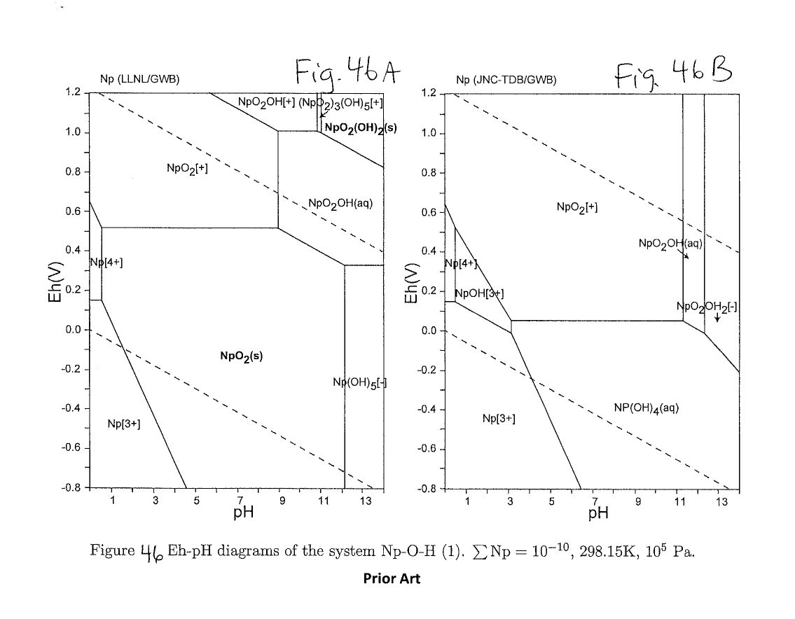

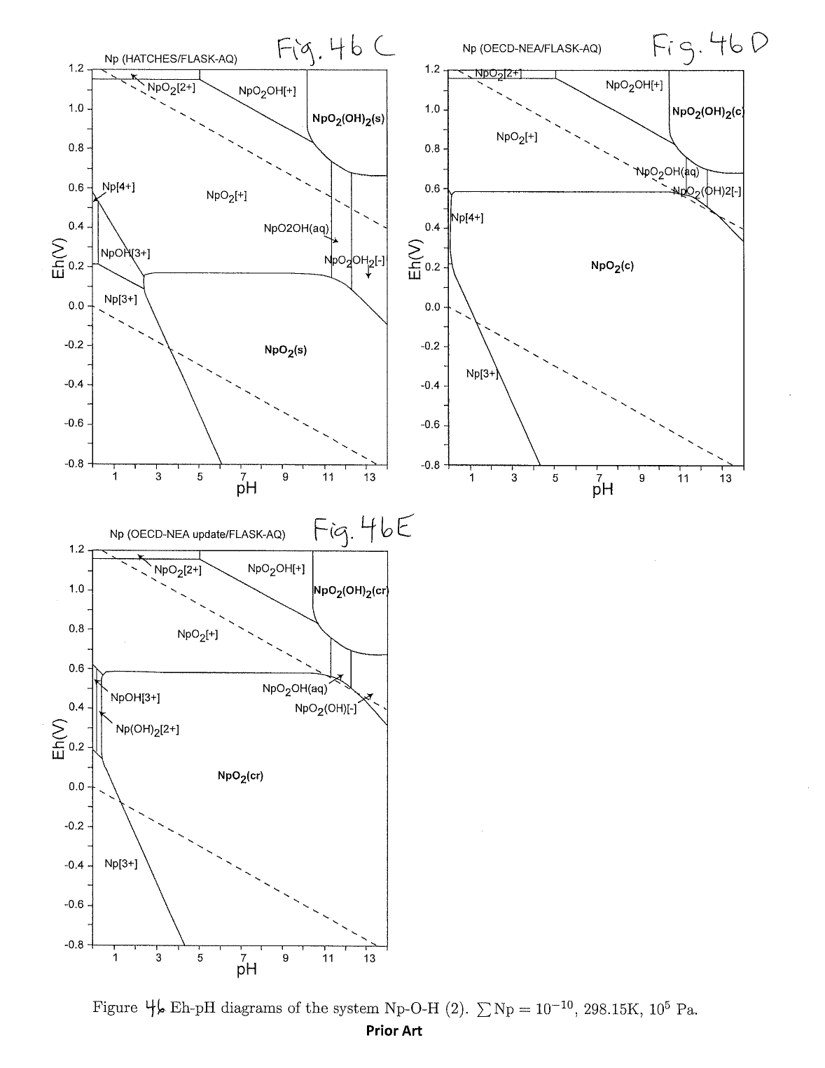

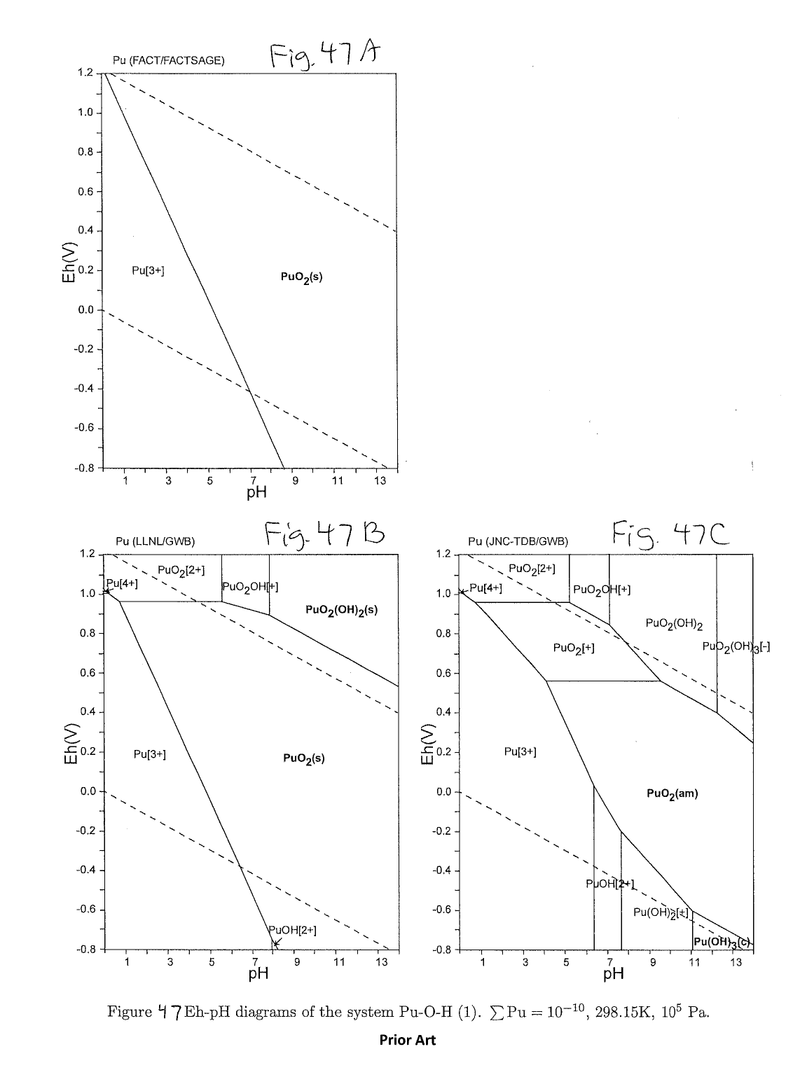

Pourbaix diagrams are depicted in FIGS. 2-47 for each of the metals, metalloids, and radioactive isotopes. FIGS. 2-47 depict the primary species of target material under different thermodynamic conditions of an aqueous solution. With reference to FIG. 39, the target material lead has the following species: Pb(H₂O)₆²⁺, Pb(H₂O)₄(O)₂, Pb(H₂O)₅CO₃, Pb(H₂O)₄(CO₃)₂²⁻, Pb(H₂O)₃(OH)₃⁻, Pb(H₂O)₄(OH)₂, Pb(H₂O)₂(OH)₄²″, and Pb(H₂O)(O)₃²⁻. The state of the lead compounds (whether solid₍ₛ₎ or aqueous_{(aq)}) are shown in the lead Pourbaix diagrams. Typically, the lead comprises lead having a +2 oxidation state. With reference to FIG. 27, the target material antimony has the following species: Sb(H₂O)₂(OH)₄¹⁻, Sb(H₂O)₄(OH)₂¹⁺, Sb(H₂O)₃(OH)₃, Sb(H₂O)(OH)₅, and Sb(OH)₆¹⁻. Typically, the antimony comprises antimony having one of a +5 or +3 oxidation state. With reference to FIG. 40, the target material bismuth has the following species: Bi(H₂O)₆³⁺, Bi(H₂O)₅(OH)²⁺, Bi(H₂O)₄(OH)₂¹⁺, Bi(H₂O)₃, and Bi(H₂O)₂(OH)₄¹⁻. Typically, the bismuth comprises bismuth having one of a +5 or +3 oxidation state.

There are a number of possible mechanisms for removing target materials. The precise mechanism may depend on a number of variables including the particular form and/or characteristics of the rare earth-containing composition, additive, and/or particle or particulate, the particular form and/or characteristics of the target material, the pH of the medium 104, the Eh of the medium 104, the temperature of the medium 104, the components in the medium 104, and other parameters known to those of skill in the art.

While not wishing to be bound by any theory, the anionic form of the target material may be one or more of sorbed, precipitated, complexed, ionically bound, inter-valance shell complexed (with any one or more hybridized or non-hybridized s, p, d or f orbitals), covalently bounded or a combination thereof with the rare earth-containing composition. The anionic forms may comprise an oxyanion, hydroxyl, hydrated or combination thereof of the target material having a net negative charge. While not wishing to be bound by any theory, the target material may selectively interact with a face or an edge of rare earth-containing composition particulate. Another theory, which we do not wish to be bound by, is that the anionic target material forms a substantially insoluble product with a rare earth. The rare earth may be in the form of a substantially water soluble rare earth-containing salt or in the form of a substantially water insoluble material that strongly sorbs, binds, chemically reacts or such with the anionic target material.

While not wishing to be bound by any theory, there are a number of mechanisms for removing cationic forms of the target materials. The cationic forms may comprise complexed, hydroxyl, hydrated or combination thereof of the target material having a net positive charge. While not wishing to be bound by any theory, the cationic form of the target material may be one or more of sorbed, precipitated, complexed, ionically bound, inter-valance shell complexed (with any one or more hybridized or non-hybridized s, p, d or f orbitals), covalently bounded or a combination thereof with the rare earth-containing composition. While not wishing to be bound by any theory, the target material may selectively interact with a face or an edge of rare earth-containing composition particulate. Another theory, which we do not wish to be bound by, is that the cationic target material form a substantially insoluble and/or stable product with rare earth cation.

While not wishing to be bound by any theory, another possible mechanism for the removal of anionic, cationic, or uncharged species containing the target material is that a species, such as a water of hydration, hydroxyl radical, hydroxide ion, or carbonate species, compounded, complexed, or otherwise attached to the target material acts as a chemical entity that attaches, sorbs and/or chemically bonds to the rare earth or rare earth-containing composition. While not wanting to be limited by theory and/or by way of illustration, a possible cationic metal or metalloid adsorption process may comprise, as show in chemical equation (2):

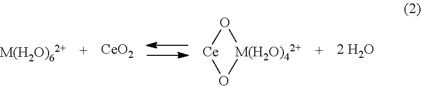

The rare earth may be in the form of a substantially water soluble rare earth-containing salt or in the form of a substantially water insoluble material that strongly sorbs, binds, chemically reacts or otherwise attaches to the cationic target material, as shown in chemical equation (3).

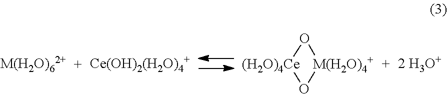

where M has an atomic number commonly of one of 5, 13, 22-33, 40-52, 72-84, and 89-94 and more commonly one of 5, 13, 22 to 33, 40 to 52, 72, 80-84, and 90-94. Although the number of waters of hydration is shown as “4” for ceria oxide, it is to be understood that more or less waters of hydration may be present depending on the application.

While not wanting to be limited by theory and by way of further example, a possible cationic lead adsorption process may comprise, as show in chemical equation (4):

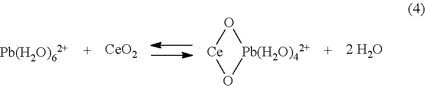

The rare earth cations may be in the form of a substantially water soluble rare earth-containing salt or in the form of a substantially water insoluble material that strongly sorbs, binds, chemically reacts or such with the cationic target material, as shown in chemical equation (5).

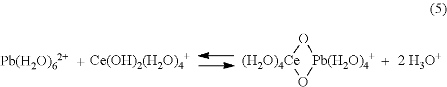

While not wishing to be bound by any theory, another possible mechanism the rare earth-containing additive, such as cerium (IV) oxide, may oxidize the target material and/or target material-containing species. The contacting of the rare earth-containing oxidizing agent and the target material-containing species may one or both: a) chemically interact with the target material-containing species and b) form a reduced rare earth and/or rare earth-containing oxidizing agent and an oxidized target material and/or target material-containing species. By way of illustration, a cerium (IV) oxidizing agent may be formed by contacting a first cerium-containing composition having cerium in a +3 oxidation state with an oxidant (as listed below) to form a second cerium-containing composition having cerium in a +4 oxidation state (or cerium (IV) oxidizing agent). Commonly, the second cerium-containing composition comprises CeO₂ particles. The cerium (IV) oxidizing agent then oxidizes the target material or target material-containing species forming the first (reduced) cerium (III)-containing composition.

Regardless of the precise mechanism, contact of the rare earth-containing additive with the target material-containing species forms a rare earth- and target material-containing product. The rare earth- and target material-containing product can be in the form of a material dissolved in the water or a solid material either contained within the water or a solid material phase separated from the water. The solid rare earth- and target material-containing product may be a precipitate, a solid particle suspended within the water, a flocculated solid particle, and combination thereof.

As can be seen from the Pourbaix diagrams in FIGS. 2-47, the primary species of a metal or metalloid in solution depends on pH and Eh. The values are commonly selected such that the water is electrochemically stable and the target material is a dissolved (not solid) species. Cationic forms of lead, for example, typically, but not necessarily, are present, as the primary species, in aqueous media having a pH of less than about pH 7 and Eh of less than about +1V. As discussed below, the form of metal or metalloid present in solution, and therefore the efficacy of precipitating, sorbing, or otherwise removing the metal or metalloid from, and/or detoxifying, the aqueous medium by treatment with the rare earth-containing composition, additive, and/or particle or particulate can be increased substantially by adjusting one or both of the pH and Eh of the medium. It can be appreciated that, while the efficacy of precipitating, sorbing, or removing the target material has been illustrated for various pH and Eh values, the concept of adjusting one or both of pH and Eh is applicable for effectively removing and/or detoxifying an aqueous solution for components, including interferents, other than the metal and/or metalloid-containing target materials.

In accordance with some embodiments, the target material is removed from the aqueous media having a selected pH value. Commonly, the selected pH value of the aqueous media may be from about pH 0 to about pH 14, more commonly the pH of the aqueous media may be from about pH 1 to about pH 13, even more commonly the pH of the aqueous media may be from about pH 2 to about pH 12, even more commonly the pH of the aqueous media may be from about pH 3 to about pH 11, yet even more commonly the pH of the aqueous media may be from about pH 4 to about pH 10, still yet even more commonly the pH of the aqueous media may be from about pH 5 to about pH 9, or still yet even more commonly the pH of the aqueous media may be from about pH 6 to about pH 8.

In one embodiment, the aqueous media typically has a selected pH value of from about pH 6 to about pH 9, and more typically the aqueous media has a pH of from about pH 6.5 to about pH 8.5

Commonly in other embodiments, the aqueous media may be substantially acidic having a selected pH of about pH 0, more commonly having a selected pH of about pH 1, even more commonly having a selected pH of about pH 2, yet even more commonly having a selected pH of about pH 3, or still yet even more commonly having a selected pH about pH 4. Even more commonly in other embodiments, the aqueous media may be substantially neutral having a selected pH of about pH 5, more commonly having a selected pH of about pH 6, even more commonly having a selected pH of about pH 7, yet even more commonly having a selected pH of about pH 8, or still yet even more commonly having a selected pH of about pH 9. Commonly in other embodiments, the aqueous media may be substantially basic having a selected pH of about pH 10, more commonly having a selected pH of about pH 11, even more commonly having a selected pH of about pH 12, yet even more commonly having a selected pH of about pH 13, or still yet even more commonly having a selected pH about pH 14.

In accordance with some embodiments, the target material is removed from the aqueous media having a selected Eh value with respect to standardized reference electrode, such as a standard hydrogen electrode (SHE). Commonly, the selected Eh of the aqueous medium is at least about −0.5 V, more commonly at least about −0.4 V, more commonly at least about −0.3 V, more commonly at least about −0.2 V, more commonly at least about −0.1V, more commonly at least about 0 V, more commonly at least about 0.1V, more commonly at least about 0.2 V, more commonly at least about 0.3 V, and more commonly at least about 0.4 V, and more commonly at least about 0.5 V. Commonly, the selected Eh of the aqueous medium is below the level at which water is not electrochemically stable, more commonly no more than about 1.7 V, more commonly no more than about 1.6 V, more commonly no more than about 1.5 V, more commonly no more than about 1.4 V, more commonly no more than about 1.3 V, more commonly no more than about 1.2 V, more commonly no more than about 1.1 V, more commonly no more than about 1.0 V, more commonly no more than about 0.9 V, more commonly no more than about 0.8 V, and more commonly no more than about 0.7 V.

The rare earth to target material ratio of the insoluble rare earth- and target material-containing product can also vary depending on the solution pH and/or Eh value. In other words, rare earths having a rare earth to target material ratio less than 1 have a greater molar removal capacity of target material than rare earths having a rare earth to target material ratio of 1 or more than 1. In some embodiments, the greater the pH value the greater the rare earth to target material ratio. In other embodiments, the greater the pH value the smaller the rare earth to target material ratio. In yet other embodiment, the rare earth to target material ratio is substantially unchanged over a range of pH values. In some embodiments, the rare earth to target material ratio is no more than about 0.1, the rare earth to target material ratio is no more than about 0.2, the rare earth to target material ratio is no more about 0.3, the rare earth to target material ratio is no more than about 0.4, the rare earth to target material ratio is no more than about 0.5, the rare earth to target material ratio is no more than about 0.6, the rare earth to target material ratio is no more than about 0.7, the rare earth to target material ratio is no more than about 0.8, the rare earth to target material ratio is no more than about 0.9, the rare earth to target material ratio is no more than about 1.0, the rare earth to target material ratio is no more than about 1.1, the rare earth to target material ratio is no more than about 1.2, the rare earth to target material ratio is no more than about 1.3, the rare earth to target material ratio is no more than about 1.4, the rare earth to target material ratio is no more than about 1.5, the rare earth to target material ratio is no more than about 1.6, the rare earth to target material ratio is no more than about 1.7, the rare earth to target material ratio is no more about 1.8, the rare earth to target material ratio is no more than about 1.9, the rare earth to target material ratio is no more than about 1.9, or the rare earth to target material ratio is more than about 2.0 at a pH value of no more than about pH −2, at a pH value of more than about pH −1, at a pH value of more than about pH 0, at a pH value of more than about pH 1, at a pH value of more than about pH 2, at a pH value of more than about pH 3, at a pH value of more than about pH 4, at a pH value of more than about pH 5, at a pH value of more than about pH 6, at a pH value of more than about pH 7, at a pH value of more than about pH 8, at a pH value of more than about pH 9, at a pH value of more than about pH 10, at a pH value of more than about pH 11, at a pH value of more than about pH 12, at a pH value of more than about pH 13, or at a pH value of more than about pH 14.

In some embodiments, the rare earth to target material ratio is no more than about 0.1, the rare earth to target material ratio is no more than about 0.2, the rare earth to target material ratio is no more about 0.3, the rare earth to target material ratio is no more than about 0.4, the rare earth to target material ratio is no more than about 0.5, the rare earth to target material ratio is no more than about 0.6, the rare earth to target material ratio is no more than about 0.7, the rare earth to target material ratio is no more than about 0.8, the rare earth to target material ratio is no more than about 0.9, the rare earth to target material ratio is no more than about 1.0, the rare earth to target material ratio is no more than about 1.1, the rare earth to target material ratio is no more than about 1.2, the rare earth to target material ratio is no more than about 1.3, the rare earth to target material ratio is no more than about 1.4, the rare earth to target material ratio is no more than about 1.5, the rare earth to target material ratio is no more than about 1.6, the rare earth to target material ratio is no more than about 1.7, the rare earth to target material ratio is no more about 1.8, the rare earth to target material ratio is no more than about 1.9, the rare earth to target material ratio is no more than about 1.9, or the rare earth to target material ratio is more than about 2.0 at a water pH value of no more than about pH −2, at a water pH value of more than about pH −1, at a water pH value of more than about pH 0, at a water pH value of more than about pH 1, at a water pH value of more than about pH 2, at a water pH value of more than about pH 3, at a water pH value of more than about pH 4, at a water pH value of more than about pH 5, at a water pH value of more than about pH 6, at a water pH value of more than about pH 7, at a water pH value of more than about pH 8, at a water pH value of more than about pH 9, at a water pH value of more than about pH 10, at a water pH value of more than about pH 11, at a water pH value of more than about pH 12, at a water pH value of more than about pH 13, or at a water pH value of more than about pH 14.

For CeO₂ as the rare earth-containing composition, additive, and/or particle or particulate, removal capacities of approximately 0.1 mg target material/g REO (e.g. CeO₂) or less can be encountered. These can have rare earth:target material ratios that are significantly larger than 2. For example, 0.1 mg is 0.0001 g, so 1 g CeO₂/0.0001 g target material =10,000. In such embodiments, the rare earth to target material ratio is commonly no more than about 50,000, the rare earth to target material ratio is more commonly no more than about 47,500, the rare earth to target material ratio is more commonly no more about 45,000, the rare earth to target material ratio is more commonly no more than about 42,500, the rare earth to target material ratio is more commonly no more than about 40,000, the rare earth to target material ratio is no more than about 37,500, the rare earth to target material ratio is more commonly no more than about 35,000, the rare earth to target material ratio is more commonly no more than about 35,000, the rare earth to target material ratio is more commonly no more than about 32,500, the rare earth to target material ratio is more commonly no more than about 30,000, the rare earth to target material ratio is more commonly no more than about 37,500, the rare earth to target material ratio is more commonly no more than about 35,000, the rare earth to target material ratio is more commonly no more than about 32,500, the rare earth to target material ratio is more commonly no more than about 30,000, the rare earth to target material ratio is more commonly no more than about 27,500, the rare earth to target material ratio is more commonly no more than about 25,000, the rare earth to target material ratio is more commonly no more than about 22,500, or the rare earth to target material ratio is more commonly no more about 20,000, at a water pH value of no more than about pH −2, at a water pH value of more than about pH −1, at a water pH value of more than about pH 0, at a water pH value of more than about pH 1, at a water pH value of more than about pH 2, at a water pH value of more than about pH 3, at a water pH value of more than about pH 4, at a water pH value of more than about pH 5, at a water pH value of more than about pH 6, at a water pH value of more than about pH 7, at a water pH value of more than about pH 8, at a water pH value of more than about pH 9, at a water pH value of more than about pH 10, at a water pH value of more than about pH 11, at a water pH value of more than about pH 12, at a water pH value of more than about pH 13, or at a water pH value of more than about pH 14.

The concentration of the target material and target material-containing species can vary depending on a number of factors. The concentration of either or both can be, for example, commonly at least about 5 ppm, more commonly at least about 50 ppm, more commonly at least about 100 ppm, more commonly at least about 500 ppm, more commonly at least about 1,000 ppm, more commonly at least about 5,000 ppm, more commonly at least about 10,000 ppm, and more commonly at least about 100,000 ppm.

### Medium Pre-Treatment

In step 108, the medium 104 is optionally pre-treated to produce a selected primary species of the target material. The selected primary species is generally more effectively removed by the rare earth-containing composition, additive, and/or particle than the primary species in the medium 104. For example, one or more of the Eh and pH values may be altered for more effective removal and/or detoxification of the target material. The primary species of lead, for instance, is elemental (Pbₛ) when the Eh is less (more negative) than about −0.3. By increasing the Eh and varying the pH value of the aqueous solution the primary species of lead can become one or more of Pb(H₂O)₆²⁺, Pb(H₂O)₅CO₃, Pb(H₂O)₄(CO₃)₂²⁺, Pb(H₂O)₅(OH)₂, or Pb(H₂O)₂(OH)₄²⁻. As will be appreciated, pH is a measure of the activity of hydrogen ions while Eh is a measure of the electrochemical (oxidation/reduction) potential.

The type of pre-treatment employed can depend on the application.

In one application, an acid, acid equivalent, base, or base equivalent is added to adjust the pH to a desired pH value. Examples of acids or acid equivalents include monoprotic acids and polyprotic acids, such as mineral acids, sulfonic acids, carboxylic acids, vinylogous carboxylic acids, nucleic acids, and mixtures thereof. Examples of bases and base equivalents include strong bases (such as potassium hydroxide, barium hydroxide, cesium hydroxide, sodium hydroxide, strontium hydroxide, calcium hydroxide, magnesium hydroxide, lithium hydroxide, and rubidium hydroxide), superbases, carbonates, ammonia, hydroxides, metal oxides (particularly alkoxides), and counteranions of weak acids.

In one application, oxidation and reduction reactions can be used to adjust the Eh value. Eh is a measure of the oxidation or reduction potential of the medium 104. The oxidation or reduction potential is commonly referred to as electromotive force or EMF. The EMF is typically measured with respect to a standardized reference electrode. Non-limiting examples of standardized reference electrodes are hydrogen electrode (commonly referred to as SHE), copper copper sulfate electrode, and silver/silver chloride to name a few.

In one variation, the target material or target material-containing species is contacted with an oxidizing agent to oxidize the target material or target material-containing species. The oxidizing agent may comprise a chemical oxidizing agent, an oxidation process, or combination of both.

A chemical oxidizing agent comprises a chemical composition in elemental or compounded form. The chemical oxidizing agent accepts an electron from the target material or target material-containing species. In the accepting of the electron, the oxidizing agent is reduced to form a reduced form of the oxidizing agent. Non-limiting examples of preferred chemical oxidizing agents are chlorine, chloroamines, chlorine dioxide, hypochlorites, trihalomethane, haloacetic acid, ozone, hydrogen peroxide, peroxygen compounds, hypobromous acid, bromoamines, hypobromite, hypochlorous acid, isocyanurates, tricholoro-s-triazinetriones, hydantoins, bromochloro-dimethyldantoins, 1-bromo-3-chloro-5,5-dimethyldantoin, 1,3-dichloro-5,5-dimethyldantoin, sulfur dioxide, bisulfates, and combinations thereof. It is further believed that in some configurations one or more the following chemical compositions may oxidize the target material or target material-containing species: bromine, BrCl, permanganates, phenols, alcohols, oxyanions, arsenites, chromates, trichloroisocyanuric acid, and surfactants. The chemical oxidizing agent may further be referred to as an “oxidant” or an “oxidizer”.

An oxidation process comprises a physical process that alone or in combination with a chemical oxidizing agent. The oxidation process removes and/or facilitates the removal an electron from the target material or target material-containing species. Non-limiting examples of oxidation processes are electromagnetic energy, ultra violet light, thermal energy, ultrasonic energy, and gamma rays.

In another variation, the target material or target material-containing species is contacted with a reducing agent to reduce the target material or target material-containing species. The oxidizing agent may comprise a chemical oxidizing agent, an oxidation process, or combination of both.

A chemical reducing agent comprises a chemical composition in elemental or compounded form. The chemical reducing agent donates an electron to the target material or target material-containing species. In the donating the electron, the reducing agent is oxidized to form an oxidized form of the oxidizing agent. Non-limiting examples of preferred chemical reducing agents are lithium aluminum hydride, nascent (atomic) hydrogen, sodium amalgam, sodium borohydride, compounds containing divalent tin ion, sulfite compounds, hydrazine, zinc-mercury amalgam, diisobutylaluminum hydride, Lindlar catalyst, oxalic acid, formic acid, ascorbic acid, phosphites, hypophosphites, phosphorous acids, dithiothreitols, and compounds containing the divalent iron ion. The chemical reducing agent may further be referred to as a “reductant” or a “reducer”.

A redox process is a physical process that alone or in combination with a chemical oxidizing agent transfers electrons to or form a target material or target material-containing species. Non-limiting examples of oxidation processes are electromagnetic energy, ultra violet light, thermal energy, ultrasonic energy, gamma rays, and biological processes.

In one variation, the medium is contacted with a halogenated species, such as chlorine, bromine, iodine, or an acid, base, or salt thereof. As will be appreciated, halogens impact the Eh of the medium. In some configurations, halogens can impact the pH value of the aqueous media.

Other types of pre-treatment may be employed to remove species from the medium that can impair removal of the target material or target material-containing species and/or adjustment of the pH and/or Eh of the medium.

The pre-treatment can comprise one or more of clarifying, disinfecting, coagulating, aerating, filtering, separating solids and liquids, digesting, and polishing processes. More specifically, the pre-treatment process can commonly comprise one of clarifying, disinfecting, coagulating, aerating, filtering, separating solids and liquids, digesting, and polishing processes, more commonly any two of clarifying, disinfecting, coagulating, aerating, filtering, separating solids and liquids, digesting, and polishing processes arranged in any order, even more commonly any three of clarifying, disinfecting, coagulating, aerating, filtering, separating solids and liquids, digesting, and polishing processes arranged in any order, yet even more commonly any four of clarifying, disinfecting, coagulating, aerating, filtering, separating solids and liquids, digesting, and polishing processes arranged in any order, still yet even more commonly any five of clarifying, disinfecting, coagulating, aerating, filtering, separating solids and liquids, digesting, and polishing processes arranged in any order, still yet even more commonly any six of clarifying, disinfecting, coagulating, aerating, filtering, separating solids and liquids, digesting, and polishing processes arranged in any order, still yet even more commonly any seven of clarifying, disinfecting, coagulating, aerating, filtering, separating solids and liquids, digesting, and polishing processes arranged in any order, still yet even more commonly any eight of clarifying, disinfecting, coagulating, aerating, filtering, separating solids and liquids, digesting, and polishing processes arranged in any order, still yet even more commonly any nine of clarifying, disinfecting, coagulating, aerating, filtering, separating solids and liquids, digesting, and polishing processes arranged in any order, still yet even more commonly any ten of clarifying, disinfecting, coagulating, aerating, filtering, separating solids and liquids, digesting, and polishing processes arranged in any order, still yet even more commonly any eleven of clarifying, disinfecting, coagulating, aerating, filtering, separating solids and liquids, digesting, and polishing processes arranged in any order, and yet still even more commonly each of clarifying, disinfecting, coagulating, aerating, filtering, separating solids and liquids, digesting, and polishing process arranged in any order. In some configurations, the pre-treatment may comprise or may further comprise processing by one or more of the additional process equipment of the water-handling system.

### Contact of Medium with Rare Earth-Containing Additive

In step 112, the optionally pre-treated medium is contacted with the rare earth-containing composition, additive, or particle or particulate to form a rare earth- and target material-containing product. As noted, the rare earth-containing composition, additive, and/or particle or particulate chemically and/or physically reacts with, sorbs, precipitates, chemically transforms, or otherwise deactivates or binds with the target material or target material-containing species. In one configuration, the rare earth-containing additive reacts with, sorbs, precipitates, chemically transforms, or otherwise deactivates or binds with at least about 25%, more commonly at least about 50%, more commonly more commonly more than about 50%, more commonly at least about 75%, and even more commonly at least about 95% of the target material or target material-containing species. The rare earth- and target material-containing product includes the rare earth, the target material, and, depending on the materials involved, potentially one or more other constituents or components of the rare earth-containing composition and/or target material-containing species. While not wishing to be bound by any theory, it is believed that the binding mechanism, in some processes, is by waters of hydration, hydroxyl radical, hydroxide ion, or carbonate species, compounded, complexed, or otherwise attached to the target material acts as a chemical entity that attaches, sorbs and/or chemically bonds to the rare earth or rare earth-containing composition.

The temperature of the medium 104, during the contacting step, can vary. Typically, the temperature of the aqueous solution can vary during the contacting step. For example, the temperature of the aqueous solution can vary depending on the water. Commonly, the temperature of the aqueous solution is ambient temperature. Typically, the solution temperature ranges from about −5 degrees Celsius to about 50 degrees Celsius, more typically from about 0 degrees Celsius to about 45 degrees Celsius, yet even more typically from about 5 degrees Celsius to about 40 degrees Celsius and still yet even more typically from about 10 degrees Celsius to about 35 degrees Celsius. It can be appreciated that each of the waters comprising each of the clarifying, disinfecting, coagulating, aerating, filtering, separating solids and liquids, digesting, and polishing processes may include optional processing units and/or operations that heat and/or cool one or more of each of the waters. In some configurations, each of the waters may be heated to have a temperature of typically at least about 20 degrees Celsius, more typically at least about 25 degrees Celsius, even more typically at least about 30 degrees Celsius, yet even more typically of at least about 35 degrees Celsius, still yet even more typically of at least about 40 degrees Celsius, still yet even more typically of at least about 45 degrees Celsius, still yet even more typically of at least about 50 degrees Celsius, still yet even more typically of at least about 60 degrees Celsius, still yet even more typically of at least about 70 degrees Celsius, still yet even more typically of at least about 80 degrees Celsius, still yet even more typically of at least about 90 degrees Celsius, still yet even more typically of at least about 100 degrees Celsius, still yet even more typically of at least about 110 degrees Celsius, still yet even more typically of at least about 120 degrees Celsius, still yet even more typically of at least about 140 degrees Celsius, still yet even more typically of at least about 150 degrees Celsius, or still yet even more typically of at least about 200 degrees Celsius. In some configurations, each of the waters comprising each of the clarifying, disinfecting, coagulating, aerating, filtering, separating solids and liquids, digesting, and polishing processes may be cooled to have a temperature of typically of no more than about 110 degrees Celsius, more typically of no more than about 100 degrees Celsius, even more typically of no more than about 90 degrees Celsius, yet even more typically of no more than about 80 degrees Celsius, still yet even more typically of no more than about 70 degrees Celsius, still yet even more typically of no more than about 60 degrees Celsius, still yet even more typically of no more than about 50 degrees Celsius, still yet even more typically of no more than about 45 degrees Celsius, still yet even more typically of no more than about 40 degrees Celsius, still yet even more typically of no more than about 35 degrees Celsius, still yet even more typically of no more than about 30 degrees Celsius, still yet even more typically of no more than about 25 degrees Celsius, still yet even more typically of no more than about 20 degrees Celsius, still yet even more typically of no more than about 15 degrees Celsius, still yet even more typically of no more than about 10 degrees Celsius, still yet even more typically of no more than about 5 degrees Celsius, or still yet even more typically of no more than about 0 degrees Celsius.

### Separation of the Rare Earth- and Target Material-Containing Product from Medium

In optional step 116, the product is removed from the medium 104 to form a treated medium 124. In one configuration, commonly at least about 25%, more commonly at least about 50%, more commonly more commonly more than about 50%, more commonly at least about 75%, and even more commonly at least about 95% of the rare earth- and target material-containing product is removed from the medium. It can be appreciated that, in such instances, the product comprises an insoluble material.

The solid rare earth- and target material-containing product may be removed by any suitable technique, such as by a liquid/solid separation system. Non-limiting examples of liquid/solid separation systems are filtration, floatation, sedimentation, cyclone, and centrifuging. Alternatively, the rare earth-containing additive is in the form of a particulate bed or supported porous and permeable matrix, such as a filter, through which the media passes.

Alternatively, the rare earth- and target material-containing product dissolved in the water may remain in the water in a de-activated form. Non-limiting examples of de-activated rare earth- and target material-containing product that may remain dissolved are environmentally stable co-ordination complexes of a target material-containing species and the rare earth-containing composition.

In accordance with some embodiments, the treated medium 124 has a lower content of at least one target material compared to the target material-containing medium 104. Commonly, the treated medium 124 content is at least about 0.9 of the medium target material-containing medium 104, more commonly the treated medium 124 content is at least about 0.8 of the medium target material-containing medium 104, even more commonly the treated medium 124 content is at least about 0.7 of the target material-containing medium 104, yet even more commonly the treated medium 124 content is at least about 0.6 of the target material-containing medium 104, still yet even more commonly the treated medium 124 content is at least about 0.5 of the target material-containing medium 104, still yet even more commonly the treated medium 124 content is at least about 0.4 of the target material-containing medium 104, still yet even more commonly the treated medium 124 content is at least about 0.3 of the target material-containing medium 104, still yet even more commonly the treated medium 124 content is at least about 0.2 of the target material-containing medium 104, still yet even more commonly the treated medium 124 content is at least about 0.1 of the target material-containing medium 104, still yet even more commonly the treated aqueous media 124 content is at least about 0.05 of the target material-containing medium 104, still yet even more commonly the treated medium 124 content is at least about 0.01 of the target material-containing medium 104, still yet even more commonly the treated 124 content is at least about 0.005 of the target material-containing medium 104, still yet even more commonly the treated medium 124 content is at least about 0.001 of the target material-containing medium 104, still yet even more commonly the treated medium 124 content is at least about 0.5 of the target material-containing medium 104, still yet even more commonly the treated medium 124 content is at least about 0.0005 of the target material-containing medium 104, still yet even more commonly the treated medium 124 content is at least about 0.0001 of the target material-containing medium 104, still yet even more commonly the treated medium 124 content is at least about 5×10⁻⁵ of the target material-containing medium 104, still yet even more commonly the treated medium 124 content is at least about 1×10⁻⁵ of the target material-containing medium 104, still yet even more commonly the treated medium 124 content is at least about 5×10⁶ of the target material-containing medium 104, and still yet even more commonly the treated medium 124 content is at least about 1×10⁶ of the target material-containing medium 104. Typically, the target material content in the treated medium 124 content is no more than about 100,000 ppm, more typically the target material content in the treated medium 124 content is no more than about 10,000 ppm, even more typically the target material content in the treated medium 124 content is no more than about 1,000 ppm, yet even more typically the target material content in the treated medium 124 content is no more than about 100 ppm, still yet even more typically the target material content in the treated medium 124 content is no more than about 10 ppm, still yet even more typically the target material content in the treated medium 124 content is no more than about 1 ppm, still yet even more typically the target material content in the treated medium 124 content is no more than about 100 ppb, still yet even more typically the target material content in the treated medium 124 content is no more than about 10 ppb, still yet even more typically the target material content in the treated medium 124 content is no more than about 1 ppb, and yet still even more typically the target material content in the treated medium 124 content is no more than about 0.1 ppb.

Step 116 can include optional treatment steps.

The treatment can comprise one or more of clarifying, disinfecting, coagulating, aerating, filtering, separating solids and liquids, digesting, and polishing processes. More specifically, the treatment process can commonly comprise one of clarifying, disinfecting, coagulating, aerating, filtering, separating solids and liquids, digesting, and polishing, more commonly any two of clarifying, disinfecting, coagulating, aerating, filtering, separating solids and liquids, digesting, and polishing arranged in any order, even more commonly any three of clarifying, disinfecting, coagulating, aerating, filtering, separating solids and liquids, digesting, and polishing arranged in any order, yet even more commonly any four of clarifying, disinfecting, coagulating, aerating, filtering, separating solids and liquids, digesting, and polishing arranged in any order, still yet even more commonly any five of clarifying, disinfecting, coagulating, aerating, filtering, separating solids and liquids, digesting, and polishing arranged in any order, still yet even more commonly any six of clarifying, disinfecting, coagulating, aerating, filtering, separating solids and liquids, digesting, and polishing arranged in any order, still yet even more commonly any seven of clarifying, disinfecting, coagulating, aerating, filtering, separating solids and liquids, digesting, and polishing arranged in any order, still yet even more commonly any eight of clarifying, disinfecting, coagulating, aerating, filtering, separating solids and liquids, digesting, and polishing arranged in any order, still yet even more commonly any nine of clarifying, disinfecting, coagulating, aerating, filtering, separating solids and liquids, digesting, and polishing arranged in any order, still yet even more commonly any ten of clarifying, disinfecting, coagulating, aerating, filtering, separating solids and liquids, digesting, and polishing arranged in any order, still yet even more commonly any eleven of clarifying, disinfecting, coagulating, aerating, filtering, separating solids and liquids, digesting, and polishing arranged in any order, and yet still even more commonly each of clarifying, disinfecting, coagulating, aerating, filtering, separating solids and liquids, digesting, and polishing arranged in any order.

### Regeneration of Rare Earth in Rare Earth- and Target Material-Containing Product for Recycle

The separated rare earth- and target material-containing product may be subjected to suitable processes for removal of the target material from the rare earth to enable the rare earth to be recycled to step 112. Regeneration processes include, for example, desorbtion, oxidation, reduction, thermal processes, irradiation, and the like.

As used herein cerium (III) may refer to cerium (+3), and cerium (+3) may refer to cerium (III). As used herein cerium (IV) may refer to cerium (+4), and cerium (+4) may refer to cerium (IV).

### EXAMPLES

The following examples are provided to illustrate certain embodiments and are not to be construed as limitations on the embodiments, as set forth in the appended claims. All parts and percentages are by weight unless otherwise specified.

### Example 1

A set of tests were conducted to determine a maximum arsenic loading capacity of soluble cerium (III) chloride CeCl₃ in an arsenic-containing stream to reduce the arsenic concentration to less than 50 ppm. As shown by Table 1, arsenic-containing streams (hereinafter alkaline leach solutions) tested had the following compositions:

TABLE 1

| | Volume | | | | |
|---|---|---|---|---|---|
| Test | of DI | Na₂CO₃ | Na₂SO₄ | Na₂HAsO₄—7H₂O | |
| Number | (mL) | (g) | (g) | (g) | Asg/L |
| 1 | 500 | 10 | 8.875 | 1.041 | 0.5 |
| 2 | 500 | 10 | 8.875 | 2.082 | 1 |
| 3 | 500 | 10 | 8.875 | 4.164 | 2 |
| 4 | 500 | 10 | 8.875 | 6.247 | 3 |
| 5 | 500 | 10 | 8.875 | 8.329 | 4 |
| 6 | 500 | 10 | 8.875 | 10.411 | 5 |
| 7 | 500 | 10 | 8.875 | 12.493 | 6 |

The initial pH of the seven alkaline leach solutions was approximately pH 11, the temperatures of the solutions were approximately 70 to 80° C., and the reaction times were approximately 30 minutes.

Seven alkaline leach solutions were made with varying arsenic (V) concentrations, which can be seen in Table 1 above. Each solution contained the same amount of sodium carbonate (20 g/L) and sodium sulfate (17.75 g/L). In a first series of tests, 3.44 mL of cerium chloride (CeCl₃) were added to every isotherm and equates to 0.918 g CeO₂ (approximately 0.05 mole Ce) In a second series of tests, 6.88 mL of cerium chloride was added to every test and equates to 1.836 g CeO₂ (approximately 0.1 mole Ce). Below is the guideline on how each isotherm test was performed.

In a first step, 200 mL of solution were measured out by weight and transferred into a 400 mL Pyrex beaker. The beaker was then placed on hot/stir plate and heated to 70-80° C. while being stirred.

In a second step, 3.44 mL of cerium chloride were measured out, by weight, and poured into the mixing beaker of hot alkaline leach solution. Upon the addition of cerium chloride, a white precipitate formed instantaneously. To ensure that the white precipitate was not cerium carbonate [Ce₂(CO₃)₃.xH₂O], step three was performed.

In the third step, 4.8 mL of concentrated HCl were slowly added dropwise. Fizzing was observed. The solution continued to mix for 30 minutes and was then allowed to cool for 4 hours before sampling.

The results are shown in Table 2:

Analysis using ICP-AES

TABLE 2

| Approx- | | | | | | |
|---|---|---|---|---|---|---|
| imate | | Molar | Final As | | Loading | Percent |
| Moles of | | Ratio | Concen- | Arsenic | Capac- | Arsenic |
| Cerium | Arsenic | (Ce/ | tration | Removed | ity | Re- |
| Added | (g/L) | As) | (mg/L) | (mg) | (mg/g) | moved |
| 0.005 | 0.5 | 4.2 | 0 | 100 | 104 | 100 |
| | 1.0 | 2.1 | 8 | 199 | 206 | 99 |
| | 2.0 | 1.0 | 159 | 367 | 380 | 92 |
| | 3.0 | 0.7 | 903 | 412 | 426 | 69 |
| | 4.0 | 0.5 | 1884 | 408 | 422 | 51 |
| | 5.0 | 0.4 | 2663 | 445 | 461 | 45 |
| | 6.0 | 0.4 | 3805 | 409 | 422 | 34 |
| 0.01 | 0.5 | 8.3 | 0 | 102 | 53 | 100 |
| | 1.0 | 4.2 | 0 | 201 | 104 | 100 |
| | 2.0 | 2.1 | 55 | 388 | 201 | 97 |
| | 3.0 | 1.4 | 109 | 577 | 299 | 96 |
| | 4.0 | 1.1 | 435 | 709 | 367 | 89 |
| | 5.0 | 0.8 | 1149 | 759 | 392 | 76 |
| | 6.0 | 0.7 | 1861 | 810 | 419 | 67 |

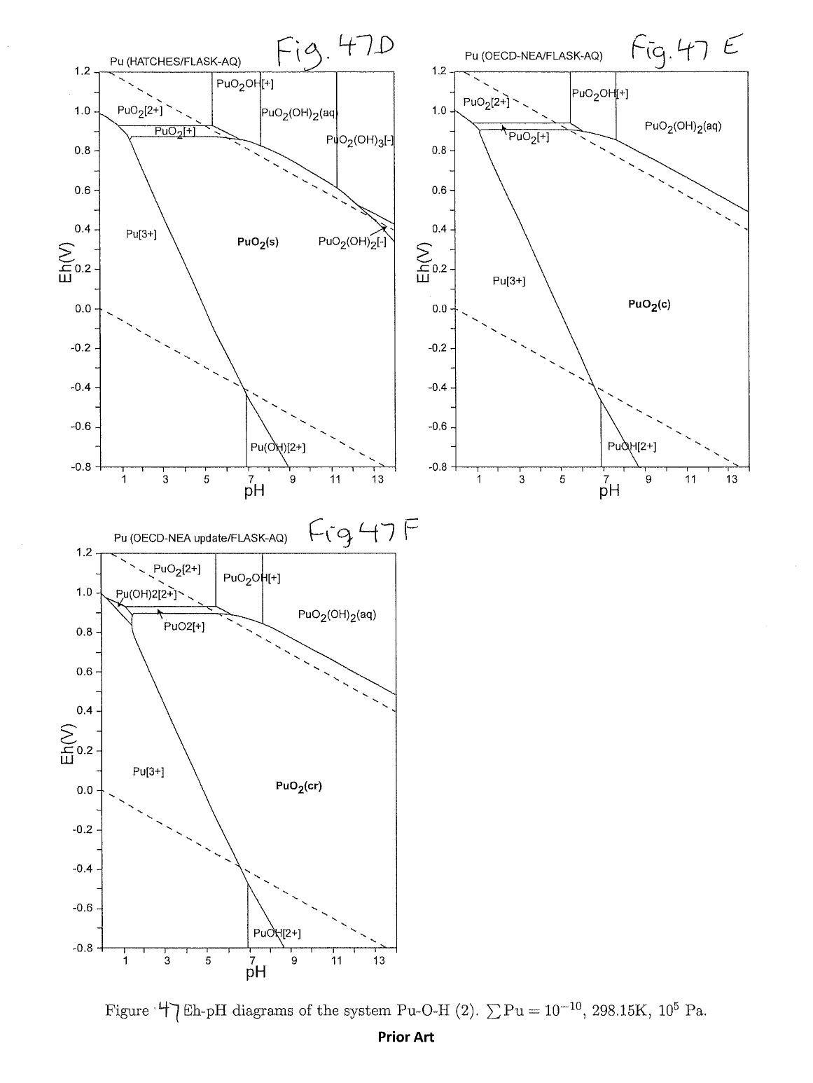

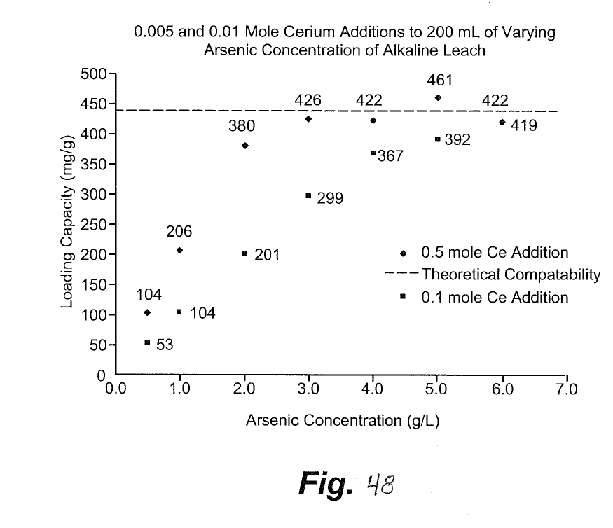

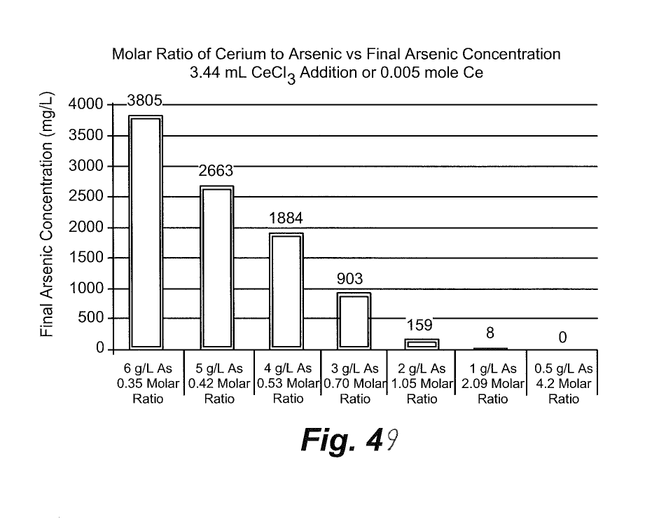

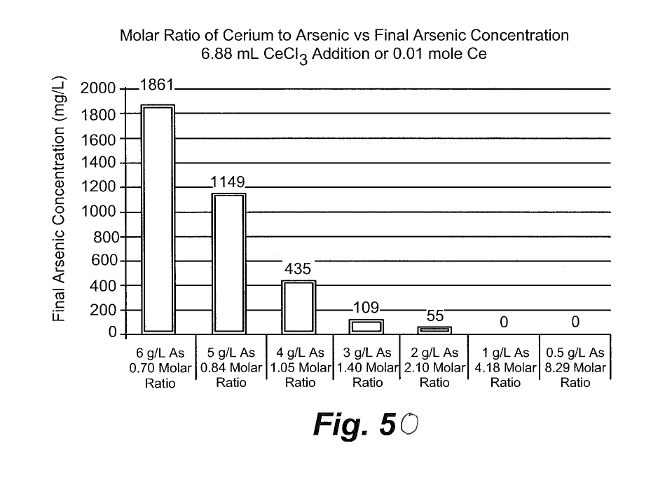

FIG. 48 shows that the loading capacity begins to level off at the theoretical capacity of 436 mg/g if cerium arsenate (CeAsO₄) was formed, leading one to believe it was formed. FIG. 49 displays that the molar ratio of cerium to arsenic required to bring down the arsenic concentration to less than 50 ppm lies somewhere between a 1 molar and 2 molar ratio. However, at a 2 molar ratio a loading capacity of 217 was achieved. FIG. 50 shows very similar results (essentially double the addition of CeCl₃); at a molar ratio between 1 and 2, the dissolved arsenic concentration can be below 50 ppm. This capacity may be improved with a lower molar ratio and tighter pH control.

### Example 2

In this example, the product of cerium and arsenic was shown to contain more arsenic than would be anticipated based upon the stoichiometry of gasparite, the anticipated product of cerium and arsenic. Furthermore, the X-ray diffraction pattern suggests that the product is amorphous or nanocrystalline and is consistent with ceria or, possibly, gasparite. The amorphous or nanocrystalline phase not only permits the recycling of process water after arsenic sequestration but does so with a far greater arsenic removal capacity than is observed from other forms of cerium addition, decreasing treatment costs and limiting environmental hazards.

Eight 50 mL centrifuge tubes were filled with 25 mL each of a fully oxidized solution of arsenate/sulfate/NaOH while another eight 50 mL centrifuge tubes were filled with 25 mL each of a fully reduced solution of arsenite/sulfide/NaOH that had been sparged with molecular oxygen for 2 hours. Both solutions contained 24 g/L arsenic, 25 g/L NaOH, and the equivalent of 80 g/L sulfide. Each sample was then treated with either cerium (IV) nitrate or cerium (III) chloride. The cerium salt solutions were added in doses of 1, 2, 3, or 5 mL. No pH adjustments were made, and no attempt was made to adjust the temperature from ambient 22° C.

Fifteen of sixteen test samples showed the rapid formation of a precipitate that occupied the entire ˜25 mL volume. The reaction between the two concentrated solutions took place almost immediately, filling the entire solution volume with a gel-like precipitate. The sixteenth sample, containing 5 mL of cerium (IV) remained bright yellow until an additional 5 mL of 50% NaOH was added, at which point a purple solid formed.

Solids formed from the reaction of cerium and arsenic were given an hour to settle with little clarification observed. The samples were then centrifuged at 50% speed for 5 minutes. At this point, the total volume of the solution and the volume of settled solids were recorded, and a 5 mL sample was collected for analysis. Since little more than 5 mL of supernatant solution was available (the concentration of arsenic was 24 g/L, meaning that the concentration of cerium was also quite elevated), the samples were filtered using 0.45 micron papers. The four samples with 5 mL of cerium salt added were not filtered. The supernatant solutions were collected and the volume recorded.

The filter cake from the reaction was left over the weekend in plastic weight boats atop a drying oven. Seventy-two hours later, the content of each boat was weighed, and it was determined that the pellets were still very moist (more mass present than was added to the sample as dissolved solids). The semi-dry solids of the samples with 2 mL of cerium salt solution were transferred to a 130° C. drying oven for one hour, then analyzed by XRD.

The XRD results are shown in FIG. 51. XRD results are presented for gasparite (the expected product) and the various systems that were present during the experiments, with “ceria” corresponding to cerium dioxide. As can be seen from FIG. 51, the XRD analysis did not detect any crystalline peaks or phases of arsenic and cerium solids in the various systems. The only crystalline material present was identified as either NaCl, NaNO₃ (introduced with the rare earth solutions) or Na₂SO₄ that was present in the samples prepared from Na₂SO₄. However, the broad diffraction peaks at about 29, 49, and 57 degrees 2-Theta could be indicative of very small particles of ceria or, possibly, gasparite.

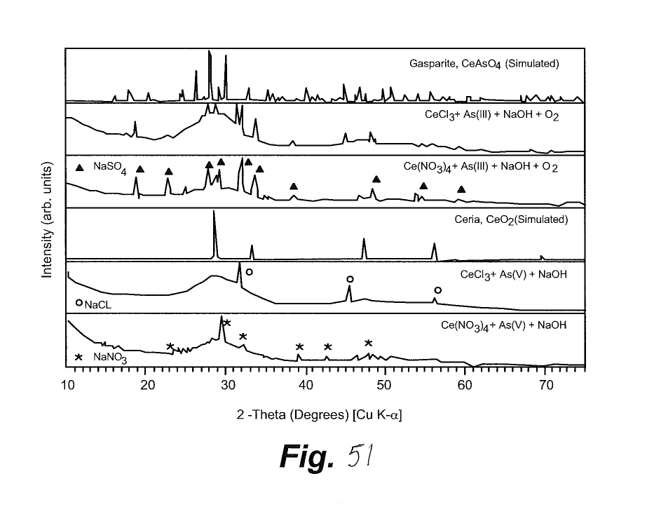

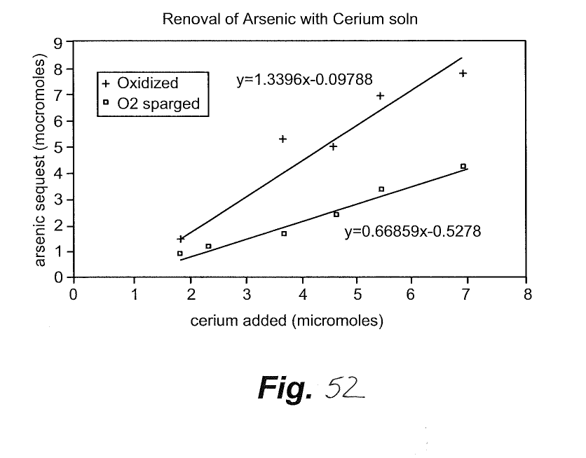

The arsenic content of supernatant solutions was measured using ICP-AES. It was observed that both cerium (IV) and cerium (III) effectively removed arsenic from the system to about the same extent. As can be seen from Table 3 below and FIG. 52, a greater difference in arsenic removal was found between the fully oxidized system, and the system which was fully reduced before molecular oxygen sparging. FIG. 52 shows a plot for arsenic micromoles removed in an “oxidized” system staring with arsenate and a “molecular oxygen sparged” system starting with arsenite, which was subsequently oxidized to arsenate through molecular oxygen sparging.

TABLE 3

| | | | Arsenite/sulfide/ | | Arsenate/sulfate/ | |
|---|---|---|---|---|---|---|
| | | | NaOH + O2 | | NaOH | |
| | | | | As | | As |
| Cerium | mL | CeO₂ | As | capacity | As | capacity |
| Additive | Ce | (g) | ppm | (mg/g) | ppm | (mg/g) |
| cerium (III) | 1 | 0.33 | 21200 | 242 | 20000 | 276 |
| chloride | 2 | 0.65 | 18800 | 271 | 8700 | 576 |
| | 3 | 0.98 | 11200 | 324 | 1000 | 596 |
| cerium (IV) | 1 | 0.26 | 21600 | 265 | 19200 | 429 |
| nitrate | 2 | 0.52 | 18800 | 237 | 8000 | 764 |
| | 3 | 0.77 | 13600 | 322 | 3200 | 672 |

| | | | | |
|---|---|---|---|---|
| control | 0 | 0.0 | 25200 | 24400 |

FIG. 52 shows the amount of arsenic consumed by the formation of precipitated solids, plotted as a function of the amount of cerium added. The resultant soluble arsenic concentrations from this experiment can be divided into two groups: samples containing fully oxidized arsenate and sulfate and samples containing arsenite and sulfite that was sparged with molecular oxygen. The oxidation state of the cerium used as the soluble fixing agent had considerably less impact on the efficacy of the process, allowing both Ce(III) and Ce(IV) data to be fit with a single regression line for each test solution. In the case of the fully oxidized solution, arsenic sequestration with the solids increases in an arsenic to cerium molar ratio of 1:3, potentially making a product with a stoichiometry of Ce₃As₄.

### Example 3

A series of experiments were performed, the experiments embody the precipitation of arsenic, in the As (V) state, from a highly concentrated waste stream of pH less than pH 2 by the addition of a soluble cerium salt in the Ce (III) state followed by a titration with sodium hydroxide (NaOH) solution to a range of between pH 6 and pH 10.

In a first test, a 400 mL solution containing 33.5 mL of a 0.07125 mol/L solution of NaH₂AsO₄ was stirred in a beaker at room temperature. The pH was adjusted to roughly pH 1.5 by the addition of 4.0 mol/L HNO₃, after which 1.05 g of Ce(NO₃)₃.6H₂O was added. No change in color or any precipitate was observed upon the addition of the cerium (III) salt. NaOH (1.0 mol/L) was added to the stirred solution at a dropwise pace to bring the pH to pH 10.1. The pH was held at pH 10.2±0.2 for a period of 1.5 hours under magnetic stir. After the reaction, the solution was removed from the stir plate and allowed to settle undisturbed for 12 to 18 hours. The supernatant was decanted off and saved for ICP-MS analysis of Ce and As. The solids were filtered through a 0.4 μm cellulose membrane and washed thoroughly with 500 to 800 mL of de-ionized water. The solids were air-dried and analyzed by X-ray diffraction.

In a second test, a simulated waste stream solution was prepared with the following components: As (1,200 ppm), F (650 ppm), Fe (120 ppm), S (80 ppm), Si (50 ppm), Ca (35 ppm), Mg (25 ppm), Zn (10 ppm), and less than 10 ppm of Al, K, and Cu. The pH of the solution was titrated down to pH 0.4 with concentrated HCl (12.1 mol/L), and the solution was heated to 70° C. A solution of CeCl₃ (6.3 mL, 1.194 mol/L) was added to the hot solution, and the pH was slowly increased to pH 7.5 by dropwise addition of NaOH (20 wt. %, 6.2 mol/L). The solution was then allowed to age at 70° C. under magnetic stirring for 1.5 hours, holding pH at pH 7.5±0.2. The solution was then removed from the heat and allowed to settle undisturbed for 12 to 18 hours. The supernatant was decanted off and saved for ICP-MS analysis of Ce and As. The precipitated solids were centrifuged and washed twice before being filtered through a 0.4 μm cellulose membrane and washed thoroughly with 500 to 800 mL of de-ionized water. The solids were air-dried and analyzed by X-ray diffraction.

In a third test, solid powders of the novel Ce—As compound were tested for stability in a low-pH leach test. 0.5 g of the novel Ce—As compound were added to 10 mL of an acetic acid solution with a pH of either pH 2.9 or pH 5.0. The container was sealed and rotated for 18±2 hours at 30±2 revolutions per minute at an ambient temperature in the range of 22±5° C. After the required rotation time, the solution was filtered through a 0.2 micron filter and analyzed by ICP-MS for Ce and As which may have been leached from the solid. Less than 1 ppm of As was detected by ICP-MS.

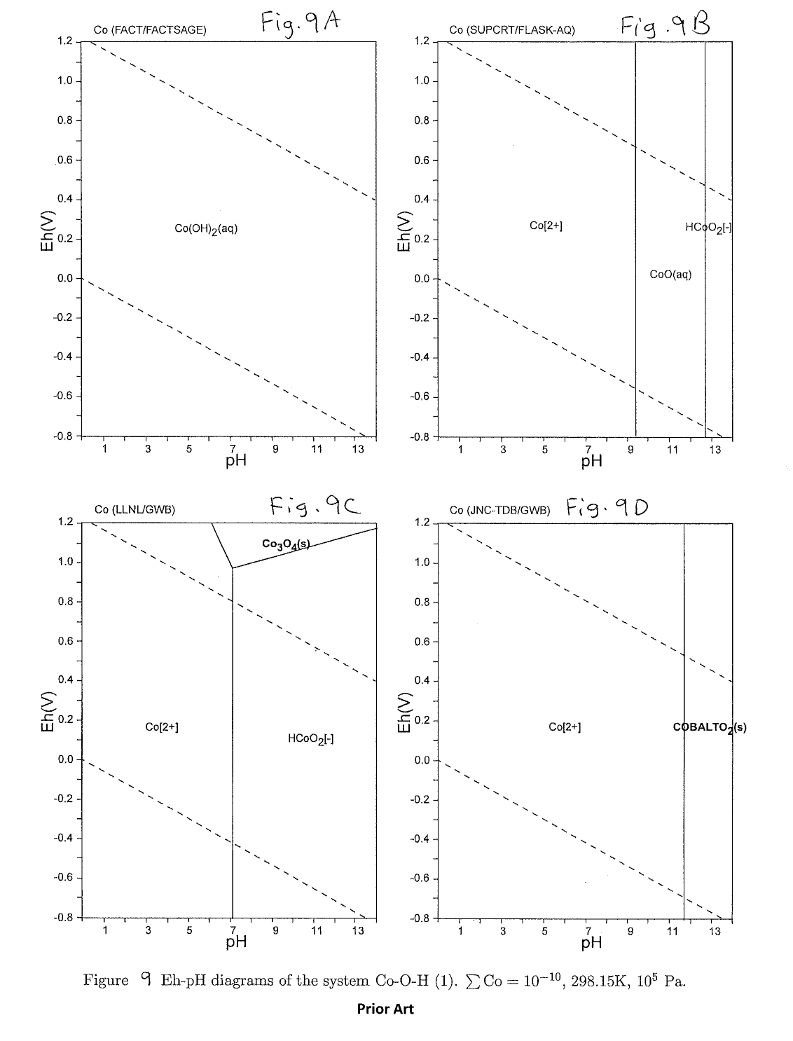

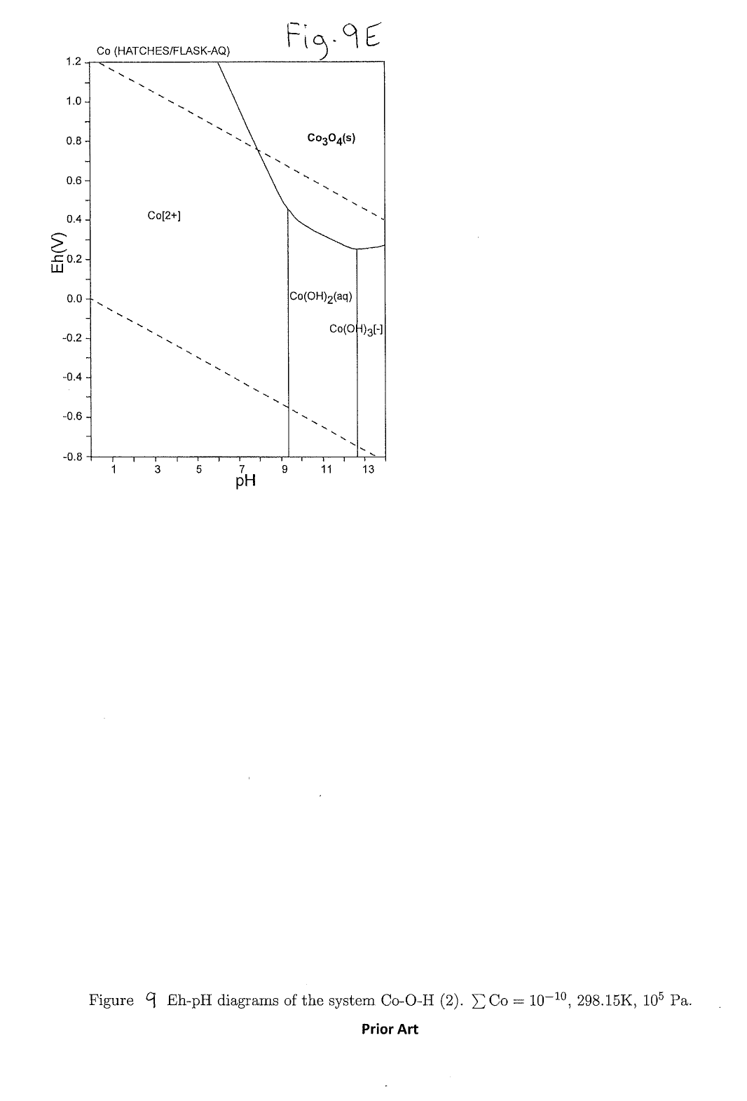

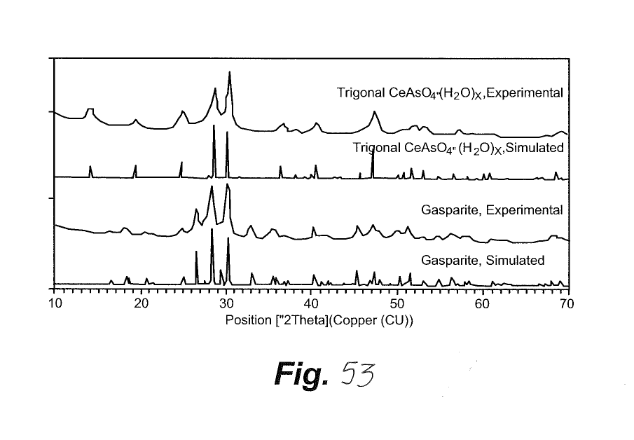

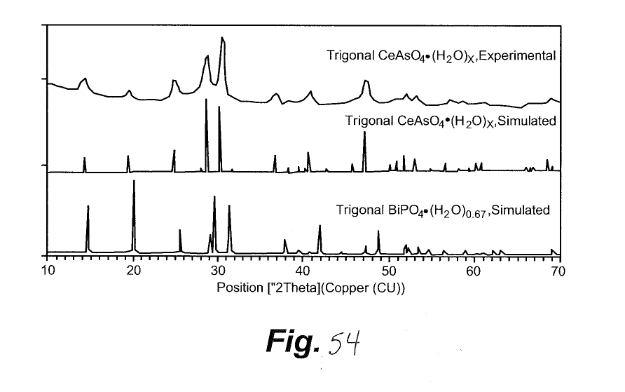

FIG. 53 compares the X-Ray Diffraction (“XRD”) results for the novel Ce—As compound (shown as trigonal CeAs O₄.(H₂O)_{X} (both experimental and simulated) and gasparite (both experimental and simulated). FIG. 9 compares the XRD results for trigonal CeAs O₄.(H₂O)_{X} (both experimental and simulated) and trigonal BiP O₄.(H₂O)_{0.67} (simulated). The XRD results show that the precipitated crystalline compound is structurally different from gasparite (CeAsO₄), which crystallizes in a monoclinic space group with a monazite-type structure, and is quite similar to trigonal BiP O₄.(H₂O)_{0.67}.

Experiments with different oxidation states of Ce and As demonstrate that the novel Ce—As compound requires cerium in the Ce (III) state and arsenic in the As(V) state. pH titration with a strong base, such as sodium hydroxide, seems to be necessary. As pH titration with sodium carbonate produces either gasparite, a known and naturally occurring compound or a combination of gasparite and trigonal CeAsO₄.(H₂O)_{X}. The use of cerium chloride and cerium nitrate both successfully demonstrated the successful synthesis of the novel compound. The presence of other metal species, such as magnesium, aluminum, silicon, calcium, iron, copper, and zinc, have not been shown to inhibit the synthesis of the novel compound. The presence of fluoride will compete with arsenic removal and produce an insoluble CeF₃ precipitate. Solutions containing only arsenic and cerium show that a Ce:As atomic ratio of 1:1 is preferable for forming the novel compound, and solutions containing excess cerium have produced a cerium oxide (CeO₂) precipitate in addition to the novel compound. Additionally, the novel compound appears to be quite stable when challenged with a leach test requiring less than 1 ppm arsenic dissolution in solution of pH 2.9 and pH 5.0.

### Example 4

In this Example, a test solution containing 1.0 ppmw chromium calculated as Cr was prepared by dissolving reagent grade potassium dichromate in distilled water. This solution contained Cr⁺⁶ in the form of oxyanions and no other metal oxyanions. A mixture of 0.5 gram of lanthanum oxide (La₂O₃) and 0.5 gram of cerium dioxide (CeO₂) was slurried with 100 milliliters of the test solution in a glass container. The resultant slurries were agitated with a Teflon coated magnetic stir bar for 15 minutes. After agitation the water was separated from the solids by filtration through Whatman #41 filter paper and analyzed for chromium using an inductively coupled plasma atomic emission spectrometer. This procedure was repeated twice, but instead of slurrying a mixture of lanthanum oxide and cerium dioxide with the 100 milliliters of test solution, 1.0 gram of each was used. The results of these tests 1-3 are set forth below in Table 4.

TABLE 4

| | | | | Oxyanion | |
|---|---|---|---|---|---|
| | Oxyanion in Water | | | in Water | Oxyanion |
| Example | Before Test | | Slurried | After Test | Removed |
| Number | Element | (ppmw) | Material | (ppmw) | (percent |
| | | | 0.5 gm La₂O₃ | | |
| 1 | Cr | 1.0 | 0.5 gm CeO₂ | ≦0.013 | ≧98.7 |
| 2 | Cr | 1.0 | 1.0 gm CeO₂ | ≦0.001 | ≧99.9 |
| 3 | Cr | 1.0 | 1.0 gm La₂O₃ | ≦0.015 | ≧98.5 |
| | | | 0.5 gm La₂O₃ | | |
| 4 | Sb | 1.0 | 0.5 gm CeO₂ | ≦0.016 | ≧98.4 |
| 5 | Sb | 1.0 | 1.0 gm CeO₂ | ≦0.016 | ≧98.4 |
| 6 | Sb | 1.0 | 1.0 gm La₂O₃ | ≦0.100 | ≧90.0 |
| | | | 0.5 gm La₂O₃ | | |
| 7 | Mo | 1.0 | 0.5 gm CeO₂ | ≦0.007 | ≧99.3 |
| 8 | Mo | 1.0 | 1.0 gm CeO₂ | ≦0.001 | ≧99.9 |
| 9 | Mo | 1.0 | 1.0 gm La₂O₃ | ≦0.009 | ≧99.1 |
| | | | 1.0 gm La₂O₃ | | |
| 10 | V | 1.0 | 1.0 gm CeO₂ | ≦0.004 | ≧99.6 |
| 11 | V | 1.0 | 1.0 gm CeO₂ | 0.120 | 88.0 |
| 12 | V | 1.0 | 1.0 gm La₂O₃ | ≦0.007 | ≧99.3 |
| | | | 0.5 gm La₂O₃ | | |
| 13 | U | 2.0 | 0.5 gm CeO₂ | ≦0.017 | ≧98.3 |
| 14 | U | 2.0 | 1.0 gm CeO₂ | 0.500 | 75.0 |
| 15 | U | 2.0 | 1.0 gm La₂O₃ | ≦0.050 | ≧95.0 |
| | | | 0.5 gm La₂O₃ | | |
| 16 | W | 1.0 | 0.5 gm CeO₂ | ≦0.050 | ≧95.0 |
| 17 | W | 1.0 | 1.0 gm CeO₂ | ≦0.050 | ≧95.0 |
| 18 | W | 1.0 | 1.0 gm La₂O₃ | ≦0.050 | ≧95.0 |

As can be seen the lanthanum oxide, the cerium dioxide and the equal mixture of each were effective in removing over 98 percent of the chromium from the test solution.

Tests 4-6

The procedures of Tests 1-3 were repeated except that a test solution containing 1.0 ppmw antimony calculated as Sb was used instead of the chromium test solution. The antimony test solution was prepared by diluting with distilled water a certified standard solution containing 100 ppmw antimony along with 100 ppmw each of As, Be, Ca, Cd, Co, Cr, Fe, Li, Mg, Mn, Mo, Ni, Pb, Se, Sr, Ti, Tl, V, and Zn. The results of these tests are also set forth in Table 4 and show that the two rare earth compounds alone or in admixture were effective in removing 90 percent or more of the antimony from the test solution.

Tests 7-9

The procedures of Tests 1-3 were repeated except that a test solution containing 1.0 ppmw molybdenum calculated as Mo was used instead of the chromium test solution. The molybdenum test solution was prepared by diluting with distilled water a certified standard solution containing 100 ppmw molybdenum along with 100 ppmw each of As, Be, Ca, Cd, Co, Cr, Fe, Li, Mg, Mn, Ni, Pb, Sb, Se, Sr, Ti, Tl, V, and Zn. The results of these tests are set forth in Table 4 and show that the lanthanum oxide, the cerium dioxide and the equal weight mixture of each were effective in removing over 99 percent of the molybdenum from the test solution.

Tests 10-12

The procedures of Tests 1-3 were repeated except that a test solution containing 1.0 ppmw vanadium calculated as V was used instead of the chromium test solution. The vanadium test solution was prepared by diluting with distilled water a certified standard solution containing 100 ppmw vanadium along with 100 ppmw each of As, Be, Ca, Cd, Co, Cr, Fe, Li, Mg, Mn, Mo, Ni, Pb, Sb, Se, Sr, Ti, Tl, and Zn. The results of these tests are set forth in Table 4 and show that the lanthanum oxide and the equal weight mixture of lanthanum oxide and cerium dioxide were effective in removing over 98 percent of the vanadium from the test solution, while the cerium dioxide removed about 88 percent of the vanadium.

Tests 13-15

The procedures of Tests 1-3 were repeated except that a test solution containing 2.0 ppmw uranium calculated as U was used instead of the chromium test solution. The uranium test solution was prepared by diluting a certified standard solution containing 1,000 ppmw uranium with distilled water. This solution contained no other metals. The results of these tests are set forth in Table 4 and show that, like in Tests 10-12, the lanthanum oxide and the equal weight mixture of lanthanum oxide and cerium dioxide were effective in removing the vast majority of the uranium from the test solution. However, like in those examples, the cerium dioxide was not as effective removing about 75 percent of the uranium.

Tests 16-18

The procedures of Tests 1-3 were repeated except that a test solution containing 1.0 ppmw tungsten calculated as W was used instead of the chromium test solution. The tungsten test solution was prepared by diluting a certified standard solution containing 1,000 ppmw tungsten with distilled water. The solution contained no other metals. The results of these tests are set forth in Table 4 and show that the lanthanum oxide, cerium dioxide, and the equal weight mixture of lanthanum oxide and cerium dioxide were equally effective in removing 95 percent or more of the tungsten from the test solution.

### Example 5

This example demonstrates the affinity of halogens for rare earth metals. A series of tests were performed to determine if certain halogens, particularly fluoride (and other halogens), compete with the binding of arsenic to cerium chloride. Arsenic is known to bind strongly to cerium chloride in an aqueous medium when using water soluble cerium chloride (CeCl₃). This halogen binding affinity was determined by doing a comparison study between a stock solution containing fluoride and one without fluoride. Materials used were: CeCl₃ (1.194 M Ce or 205.43 g/L (Rare Earth Oxide or REO) and 400 mL of the stock. The constituents of the stock solution, in accordance with NSF P231 “general test water 2” (“NSF”), are shown in Tables 5 and 6:

TABLE 5
Amount of Reagents Added

| | | Amount of |
|---|---|---|
| | Amount of | Reagent Added |
| | Reagent Added | to 3.5 L (g) |
| Compound | to 3.5 L (g) | No Fluoride |
| NaF | 5.13 | 0 |
| AlCl₃•6H₂O | 0.13 | 0.13 |
| CaCl₂•2H₂O | 0.46 | 0.46 |
| CuSO₄•5H₂O | 0.06 | 0.06 |
| FeSO₄•7H₂O | 2.17 | 2.16 |
| KCl | 0.16 | 0.15 |
| MgCl₂•6H₂O | 0.73 | 0.74 |
| Na₂SiO₃•9H₂O | 1.76 | 1.76 |
| ZnSO₄•7H₂O | 0.17 | 0.17 |
| Na₂HAsO₄•7H₂O | 18.53 | 18.53 |

TABLE 6
Calculated Analyte Concentration

| | | Theoretical |
|---|---|---|
| | Theoretical | Concentration |
| | Concentration | (mg/L) No |
| Element | (gm/L) | Fluoride |
| Cl | 19032 | 15090 |
| Na | 1664 | 862 |
| K | 24 | 22 |
| Cu | 4 | 4 |
| Fe | 125 | 124 |
| Zn | 11 | 11 |
| As | 1271 | 1271 |
| Mg | 25 | 20 |
| Ca | 36 | 36 |
| Al | 16 | 16 |
| Si | 50 | 50 |
| S | 79 | 79 |
| F | 663 | 0 |

The initial pH of the stock solution was pH approximately 0-1. The temperature of the stock solution was elevated to 70° C. The reaction or residence time was approximately 90 minutes.

The procedure for precipitating cerium arsenate with and without the presence of fluorine is as follows:

### Step 1:

Two 3.5 L synthetic stock solutions were prepared, one without fluorine and one with fluorine. Both solutions contained the compounds listed in Table 5.

### Step 2:

400 mL of synthetic stock solution was measured gravimetrically (402.41 g) and transferred into a 600 mL Pyrex beaker. The beaker was then placed on hot/stir plate and was heated to 70° C. while being stirred.

### Step 3:

Enough cerium chloride was added to the stock solution to meet a predetermined molar ratio of cerium to arsenic. For example, to achieve a molar ratio of one ceria mole to one mole of arsenic 5.68 mL of cerium chloride was measure gravimetrically (7.17 g) and added to the stirring solution. Upon addition of cerium chloride a yellow/white precipitate formed instantaneously, and the pH dropped due to the normality of the cerium chloride solution being 0.22. The pH was adjusted to approximately 7 using 20% sodium hydroxide.

### Step 4:

Once the cerium chloride was added to the 70° C. solution, it was allowed to react for 90 minutes before being sampled.

### Step 5:

Repeat steps 2-4 for all desired molar ratios for solution containing fluoride and without fluoride.

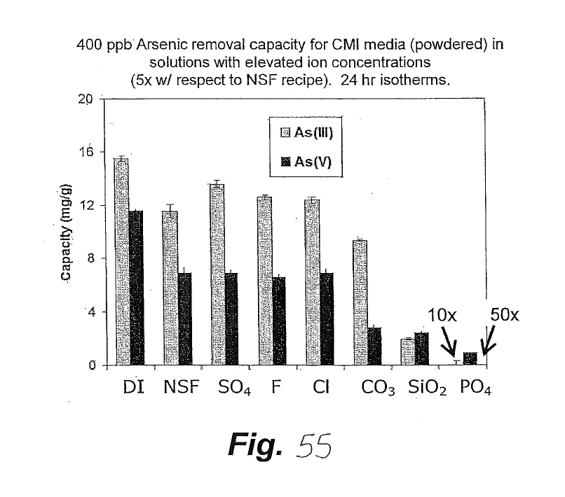

The results are presented in Table 7 and FIGS. 55 and 56.

Table 7. The residual arsenic concentration in supernatant solution after precipitation with cerium chloride solution.

TABLE 7

| Molar | Residual As Concentration w/ | Residual As Concentration no |
|---|---|---|
| Ratio | Fluoride Present (mg/L) | Fluoride Present (mg/L) |
| 1.00 | 578 | 0 |
| 1.10 | 425 | 0 |
| 1.20 | 286 | 0 |
| 1.30 | 158.2 | 0 |
| 1.40 | 58.1 | 0 |
| 1.50 | 13.68 | 0 |
| 1.60 | 3.162 | 0 |
| 1.71 | 0 | 0 |
| 1.81 | 10.2 | 0 |
| 1.90 | 0 | 0 |
| 2.01 | 0 | 0 |

A comparison of loading capacities for solutions containing or lacking fluoride shows a strong affinity for halogens and halogenated compounds. FIG. 55 shows the affinity of cerium III for fluoride in the presence of arsenic. FIG. 56 shows that the loading capacities (which is defined as mg of As per gram of CeO₂) for solutions lacking fluoride are considerably higher at low molar ratios of cerium to arsenic. Sequestration of fluorinated organic compounds, particularly fluorinated pharmaceutical compounds, using rare earth metals, and particularly cerium, is clearly indicated.

Solutions with a cerium to arsenic molar ratio of approximately 1.4 to 1 or greater had a negligible difference in the loading capacities between solution that contained F and not having F⁻. This leads one to believe that an extra 40% cerium was needed to sequester the F; then the remaining cerium could react with the arsenic.

These results confirm that the presence of fluoride effectively competes with the sequestration of arsenic and other target materials. The interference comes from the competing reaction forming CeF₃; this reaction has a much more favorable Ksp. In light of these results, fluorine and other halogens should be removed prior to addition of the rare earth-containing additive.

### Example 6

This example demonstrates the successful removal of sulfate-containing compounds, halogenated compounds, carbonate-containing compounds, and phosphate-containing compounds, using a cerium dioxide powder. A cerium powder, having a 400 ppb arsenic removal capacity, was contacted with various solutions containing arsenic (III) as arsenite and arsenic (V) as arsenate and elevated concentrations of the compounds that compete for the known binding affinity between arsenic and cerium. The competing organic compounds included sulfate ions, fluoride ions, chloride ions, carbonate ions, silicate ions, and phosphate ions at concentrations of approximately 500% of the corresponding NSF concentration for the ion. The cerium dioxide powder was further contacted with arsenic-contaminated distilled and NSF P231 “general test water 2” (“NSF”) water. Distilled water provided the baseline measurement.

The results are presented in FIG. 55. As can be seen from FIG. 55, the ions in NSF water caused, relative to distilled water, a decreased cerium dioxide capacity for both arsenite and arsenate, indicating a successful binding of these compounds to the rare earth metal. The presence of carbonate ion decreased the cerium dioxide removal capacity for arsenate more than arsenite. The presence of silicate ion decreased substantially cerium dioxide removal capacities for both arsenite and arsenate. Finally, phosphate ion caused the largest decrease in cerium dioxide removal capacities for arsenite (10× NSF concentration) and arsenate (50× NSF concentration), with the largest decrease in removal capacity being for arsenite.

### Example 7

A number of tests were undertaken to evaluate solution phase or soluble cerium ion precipitations.

Test 1:

Solutions containing 250 ppm of Cr(VI) were amended with a molar equivalent of cerium supplied as either Ce(III) chloride or Ce(IV) nitrate. The addition of Ce(III) to chromate had no immediate visible effect on the solution, however 24 hours later there appeared to be a fine precipitate of dark solids. In contrast, the addition of Ce(IV) led to the immediate formation of a large amount of solids.

As with the previous example, aliquots were filtered, and the pH adjusted to pH 3 for Ce(IV) and pH 5 for Ce(III). The addition of Ce(III) had a negligible impact on Cr solubility, however Ce(IV) removed nearly 90% of the Cr from solution at pH 3.

Test 2:

Solutions containing 50 ppm of molybdenum Spex ICP standard, presumably molybdate, were amended with a molar equivalent of Ce(III) chloride. As with previous samples, a solid was observed after the cerium addition and an aliquot was filtered through a 0.45 micron syringe filter for ICP analysis. At pH 3, nearly 30 ppm Mo remained in solution, but as pH was increased to 5, the Mo concentration dropped to 20 ppm, and near pH 7 the Mo concentration was shown to be only 10 ppm.

### Example 8

These examples examined the adsorption and desorption of a series of non-arsenic anions using methods analogous to those established for the arsenic testing.

Permanganate:

Two examples were performed. In the first example, 40 g of ceria powder were added to 250 mL of 550 ppm KMnO₄ solution. In the second example, 20 g of ceria powder were added to 250 mL of 500 ppm KMnO₄ solution and pH was lowered with 1.5 mL of 4 N HCl. Lowering the slurry pH increased the Mn loading on ceria four fold.

In both examples the ceria was contacted with permanganate for 18 hours then filtered to retain solids. The filtrate solutions were analyzed for Mn using ICP-AES, and the solids were washed with 250 mL of DI water. The non-pH adjusted solids were washed a second time.

Filtered and washed Mn-contacted solids were weighed and divided into a series of three extraction tests and a control. These tests examined the extent to which manganese could be recovered from the ceria surface when contacted with 1 N NaOH, 10% oxalic acid, or 1 M phosphate, in comparison to the effect of DI water under the same conditions.

The sample of permanganate-loaded ceria powder contacted with water as a control exhibited the release of less than 5% of the Mn. As with arsenate, NaOH effectively promoted desorption of permanganate from the ceria surface. This indicates that the basic pH level, or basification, acts as an interferer to permanganate removal by ceria. In the case of the second example, where pH was lowered, the effect of NaOH was greater than in the first case where the permanganate adsorbed under higher pH conditions.

Phosphate was far more effective at inducing permanganate desorption than it was at inducing arsenate desorption. Phosphate was the most effective desorption promoter we examined with permanganate. In other words, the ability of the ceria powder to remove permanaganate in the presence of phosphate appears to be relatively low as the capacity of the ceria powder for phosphate is much higher than for permanganate.

Oxalic acid caused a significant color change in the permanganate solution, indicating that the Mn(VII) was reduced, possibly to Mn(II) or Mn(IV), wherein the formation of MnO or MnO₂ precipitates would prevent the detection of additional Mn that may or may not be removed from the ceria. A reductant appears therefore to be an interferer to ceria removal of Mn(VII). In the sample that received no pH adjustment, no desorbed Mn was detected. However, in the sample prepared from acidifying the slurry slightly a significant amount of Mn was recovered from the ceria surface.

Chromate

250 mL of solution was prepared using 0.6 g sodium dichromate, and the solution was contacted with 20 g of cerium powder for 18 hours without pH adjustment. The slurry was filtered and the solids were washed with DI water then divided into 50 mL centrifuge tubes to test the ability of three solutions to extract chromium from the ceria surface.

Ceria capacity for chromate was significant and a loading of >20 mg Cr/g ceria was achieved without any adjustments to pH or system optimization (pH of filtrate was approximately 8). Likewise, the extraction of adsorbed chromate was also readily accomplished.

Raising the pH of the slurry containing chromate-laden ceria using 1N NaOH was the most effective method of desorbing chromium that was tested. Considerably less chromate was desorbed using phosphate and even less was desorbed using oxalic acid. This indicates that phosphate and oxalic acid are not as strong interferers to chromate removal when compared to permanganate removal. In the control sample, only 5% of the chromate was recovered when the loaded solid was contacted with distilled water.

Antimony

The solubility of antimony is rather low and these reactions were limited by the amount of antimony that could be dissolved. In this case, 100 mg of antimony (III) oxide was placed into 1 L of distilled water with 10 mL concentrated HCl, allowed several days to equilibrate, and was filtered through a 0.8 micron polycarbonate membrane to remove undissolved antimony. The liter of antimony solution was contacted with 16 g of ceria powder, which was effective removing antimony from solution, but had too little Sb(III) available to generate a high loading on the surface. In part due to the low surface coverage and strong surface-anion interactions, the extraction tests revealed little Sb recovery. Even the use of hydrogen peroxide, which would be expected to convert Sb(III) to a less readily adsorbed species of Sb(V), did not result in significant amounts of Sb recovery.

Arsenic

Tables 8-11 show the test parameters and results.

TABLE 8
Table 8: Loading of cerium oxide surface with arsenate and arsenite
for the demonstration of arsenic desorbing technologies.

| | | C | | E | | | | | | K | L | M |
|---|---|---|---|---|---|---|---|---|---|---|---|---|
| | B | Mass | | Resid | F | G | H | I | J | Rinse | Rinse | Final |
| | [As] | CeO2 | D | [As] | As-loading | Wet | Wet | Dry | % | Vol | [As] | [As] |
| A | (g/L) | (g) | pH | (ppm) | (mg/g) | Mass | mass | (g) | Solids | (mL) | (ppm) | (mg/g) |
| As (III) | 2.02 | 40.0 | 9.5 | 0 | 50.5 | 68 | 7.48 | 4.63 | 61.9 | 250 | 0 | 50.5 |
| As (V) | 1.89 | 40.0 | 5 | 149 | 43.5 | 69 | 8.86 | 5.33 | 60.2 | 250 | 163 | 42.5 |

TABLE 9
Loading of cerium oxide surface with arsenate and arsenite
for the demonstration of arsenic desorbing technologies.

| | | | Residual | | Rinse | Final |
|---|---|---|---|---|---|---|
| | [As] | | [As] | As-loading | [As] | [As] |
| | (g/L) | pH | (ppm) | (mg/g) | (ppm) | (mg/g) |
| As(III) | 2.02 | 9.5 | 0 | 50.5 | 0 | 50.5 |
| As(V) | 1.89 | 5 | 149 | 43.5 | 163 | 42.5 |

TABLE 10
Arsenic extraction from the ceria surface
using redox and competition reactions

| Extractant | pH | % As(III) recovered | % As(V) recovered |
|---|---|---|---|
| Water | 7 | 0.0 | 1.7 |
| 1N NaOH | 13 | 0.2 | 60.5 |
| 20% NaOH | 14 | 2.1 | 51.8 |
| 0.25 PO₄³⁻ | 8 | 0.4 | 15.0 |
| 10 g/L CO₃²⁻ | 10 | 2.0 | 7.7 |
| 10% oxalate | 2.5 | 3.0 | 16.5 |
| 30% H₂O₂ | 6 | 2.0 | 1.5 |
| H2O2/NaOH | 13 | 25.2 | 31.0 |
| 0.1M ascorbate | 4 | 0.0 | 0.0 |

TABLE 11
Loading and extraction of other adsorbed elements
from the ceria surface (extraction is shown for each
method as the ‘percent loaded that is recovered)

| | | | Per- | Per- |
|---|---|---|---|---|
| | chromate | antimony | manganate | manganate |
| loading pH | 8 | 2 | 6 | 11 |
| loading (mg/g) | 20 | 1 | 4 | 0.7 |
| water (% rec) | 5.1 | <2 | 2.6 | 3.4 |
| 1N NaOH (% rec) | 83 | <2 | 49.9 | 17.8 |
| 10% oxalic (% rec) | 25.8 | 2.3 | 22.8 | <3 |
| 0.5 M PO₄³⁻ (% rec) | 60.7 | | 78.6 | 45.8 |
| 30% H₂O₂ (% rec) | | 2.3 | | |

### Example 9

Struvite particles comprising NH₄MgPO₄.6H₂O were mixed in CeCl₃ solutions having different molar ratios of CeCl₃ to NH₄MgPO₄.6H₂O of about 0.8, 1.0, 1.2 and 1.5 CeCl₃ to NH₄MgPO₄.6H₂O. In each instance, the mass of the struvite was about 0.2 g, and the concentration of CeCl₃ was about 0.5 mole/L. Furthermore, controls of about 0.2 grams of struvite in about 0.1 L de-ionized water were prepared. The pH value of each solution was adjusted to a pH of about pH 4.3±0.2. Magnetic stir-bars were used to stir each sample solution. After stirring for at least about 16 hours, the solids were filtered from the solution. The filtered solids were analyzed by x-ray diffraction and the solutions were analyzed by ICP-MS. Final solution pH values of the solutions ranged from about pH 4.6 to about pH 8.0. The results are summarized in Table 12.

TABLE 12

| Nominal Concentrations | | | | | | Residual Concentrations | | | | |
|---|---|---|---|---|---|---|---|---|---|---|
| Sample | Struvite | pH | Mg | P | Ce | pH | Mg | P | Ce | P |
| ID | (mg) | Initial | (ppm) | (ppm) | (ppm) | Final | (ppm) | (ppm) | (ppm) | Removal |
| A | 205 | 5.0 | 203 | 258 | 935 | 8.0 | 140 | 7.9 | <0.1 | 96.9% |
| B | 205 | 5.6 | 203 | 259 | 1171 | 7.9 | 170 | 8.8 | <0.1 | 96.6% |
| C | 199 | 5.6 | 197 | 251 | 1360 | 5.3 | 170 | <0.5 | 62 | >99.8% |
| D | 202 | 4.9 | 200 | 255 | 1732 | 4.7 | 190 | <0.5 | 270 | >99.8% |
| CONTROL | 198 | 5.6 | 196 | 250 | 0 | 9.3 | 19 | 21 | 0 | N/A |
| CONTROL | 204 | 5.0 | 202 | 257 | 0 | 5.1 | 190 | 260 | 0 | N/A |
| CONTROL | 200 | 7.0 | 198 | 253 | 0 | 7.5 | 70 | 100 | 0 | N/A |

### Example 10

Struvite, NH₄MgPO₄.6H₂O, particles were mixed in about 0.1 L solutions containing different rare earth chlorides. The rare earth chloride solutions were about 0.15 mol/L solutions of LaCl₃, CeCl₃, PrCl₃ and NdCl₃. The mass of struvite added to each rare earth chloride solution was about 0.2 g and the molar ratio of the rare earth chloride to struvite was about 1.0. The pH of rare earth chloride solution was adjusted to a pH of about pH 4.3±0.2. Magnetic stir-bars were used to stir each sample solution. After stirring for at least about 16 hours, the solids were filtered from the solution. The filtered solids were analyzed by x-ray diffraction and the solutions were analyzed by ICP-MS. Final solution pH values ranged from about pH 4.6 to about pH 8.0. The results are summarized in Table 13.

TABLE 13

| Nominal Concentrations | | | | | | | | | | |
|---|---|---|---|---|---|---|---|---|---|---|
| Rare | | | | | | Residual Concentrations | | | | |
| Earth | Struvite | pH | Mg | P | REE | pH | Mg | P | REE | P |
| Element | (mg) | Initial | (ppm) | (ppm) | (ppm) | Final | (ppm) | (ppm) | (ppm) | Removal |
| La | 202 | 2.3 | 200 | 255 | 1142 | 2.7 | 150 | <0.5 | 200 | >99.8% |
| Ce | 201 | 7.0 | 199 | 254 | 1148 | 5.4 | 110 | <0.5 | 220 | >99.8% |
| Pr | 201 | 3.41 | 199 | 254 | 1156 | 3.8 | 190 | <0.5 | 0.17 | >99.8% |
| Nd | 202 | 2.7 | 200 | 255 | 1188 | 3.3 | 180 | <0.5 | .012 | >99.8% |

### Example 11

Example 11 is a control having about 0.2 g of struvite, NH₄MgPO₄.6H₂O, particles mixed in about 0.1 L of a 0.15 mol/L acidic ferric chloride, FeCl₃, solution. The molar ratio of ferric chloride to struvite was about 1.0 and the initial pH of the solution was about pH 2.5. The initial pH of the control solution was low enough to dissolve the struvite without the presence of ferric chloride. A magnetic stir-bar was used to stir the control solution. After stirring for at least about 16 hours, the solids were filtered from the control solution. The filtered solids were analyzed by x-ray diffraction and the control solution was analyzed by ICP-MS. Final solution pH value was about pH 2.3. The results are summarized in Table 14.

TABLE 14

| Nominal Concentrations | | | | | | Residual Concentrations | | | | |
|---|---|---|---|---|---|---|---|---|---|---|
| Metal | Struvite | pH | Mg | P | REE | pH | Mg | P | Metal | P |
| Element | (mg) | Initial | (ppm) | (ppm) | (ppm) | Final | (ppm) | (ppm) | (ppm) | Removal |
| Fe | 200 | 2.5 | 198 | 252 | 454 | 2.3 | 190 | 22 | 2.2 | 91.3% |

The Examples 9-11 show that struvite can be more effectively removed with rare earth-containing compositions than with other removal materials such as ferric chloride.

### Example 12

Table 15 summarizes deposit material removal capacities from deinoized and NSF waters for cerium dioxide.

TABLE 15

Removal Capacity (mg/g)

| Deposit Material | DI | NSF |
|---|---|---|
| Antimonate | 10.91 | — |
| Arsenite | 11.78 | 13.12 |
| Arsenate | 0.86 | 7.62 |
| Nitrate | — | 0.00 |
| Phosphate | — | 35.57 |
| Sulfate | — | 46.52 |

### Example 13

Experiments were performed to remove metals and metalloids from de-ionized and NSF standardized waters (see Table 16) by a cerium-containing composition.

TABLE 16

Removal Capacity (mg/g)

| Contaminant | DI | NSF |
|---|---|---|
| Antimony | 10.91 | |
| Arsenic (III) | 11.78 | 13.12 |
| Arsenic (V) | 0.86 | 7.62 |
| Cadmium | 10.73 | 9.75 |
| Chromium (VI) | 4.35 | 0.01 |
| Copper | 9.91 | 11.65 |
| Lead | 15.23 | 7.97 |
| Mercury | 12.06 | 3.33 |
| Uranium | 12.20 | 9.10 |
| Zinc | 8.28 | 10.32 |

As can be seen from Table 16, a cerium-containing composition is effective in removing species comprising the target materials of Table 16.

### Example 14

Experiments were performed to qualitatively determine the ability of a cerium-containing additive to remove metals and metalloids from de-ionized and NSF standardized waters (see Table 17).

TABLE 17

Can Be removed

| | Contaminant | DI | NSF |
|---|---|---|---|
| Metals | Antimony | Yes | — |
| | Arsenic (III) | Yes | Yes |
| | Arsenic (V) | Yes | Yes |
| | Cadmium | Yes | Yes |
| | Chromium (VI) | Yes | — |
| | Copper | Yes | Yes |
| | Lead | Yes | Yes |
| | Mercury | Yes | Yes |
| | Uranium | Yes | Yes |
| | Zinc | Yes | Yes |

As can be seen from Table 16, a cerium-containing composition is effective in removing species comprising the target materials of Table 17.

### Example 15

Experiments were performed to qualitatively determine the removal of organic, metal, metalloids and non-metal contaminants from de-ionized and NSF standardized waters (see Tables 18 and 19).

TABLE 18
Pb in NSF 53 Water Removal Capacities

| | | Average Removal Capacity | |
|---|---|---|---|
| Media | pH | (mg Pb/g media) | Average % Removal |
| CeO₂ | 6.5 | 11.65 | 97.97 |
| Agglomerated | 6.5 | 6.35 | 54.41 |
| CeO₂ | | | |
| CeO₂ | 8.5 | 12.65 | 97.96 |
| Agglomerated | 8.5 | 6.85 | 52.43 |
| CeO₂ | | | |

TABLE 19

| | | | | | | | | Removal | |
|---|---|---|---|---|---|---|---|---|---|
| | | | Initial | Volume | Time | Mass | Final | Capacity | |
| | | | [Pb] | Treated | Tested | Media | [Pb] | (mg Pb/g | % |
| Media | Sample | pH | (ug/L) | (L) | (Hr) | (g) | (ug/L) | media) | Removal |
| CeO₂ | 1 | 6.5 | 477 | 0.50 | 24 | 0.0176 | 9.28 | 13.29 | 98.05 |
| | 2 | 6.5 | 477 | 0.50 | 24 | 0.0274 | 10.7 | 8.51 | 97.76 |
| | 3 | 6.5 | 477 | 0.50 | 24 | 0.0178 | 9.04 | 13.14 | 98.10 |
| Agglomerated | 1 | 6.5 | 438 | 0.50 | 24 | 0.0194 | 195 | 6.26 | 55.48 |
| CeO₂ | 2 | 6.5 | 438 | 0.50 | 24 | 0.0178 | 209 | 6.43 | 52.28 |
| | 3 | 6.5 | 438 | 0.50 | 24 | 0.0191 | 195 | 6.36 | 55.48 |
| CeO₂ | 1 | 8.5 | 490 | 0.50 | 24 | 0.0216 | 8.28 | 11.15 | 98.31 |
| | 2 | 8.5 | 490 | 0.50 | 24 | 0.0174 | 11.9 | 13.74 | 97.57 |
| | 3 | 8.5 | 490 | 0.50 | 24 | 0.0184 | 9.84 | 13.05 | 97.99 |
| Agglomerated | 1 | 8.5 | 487 | 0.50 | 24 | 0.0204 | 215 | 6.67 | 55.85 |
| CeO₂ | 2 | 8.5 | 487 | 0.50 | 24 | 0.0181 | 242 | 6.77 | 50.31 |
| | 3 | 8.5 | 487 | 0.50 | 24 | 0.0175 | 238 | 7.11 | 51.13 |

CeO₂ is in the form of a powder and agglomerated CeO2 is agglomerated with a polymeric binder.

Insoluble forms of lead may be removed from an aqueous media containing one or both of soluble and insoluble forms of lead by the rare-earth containing composition. The insoluble lead may be in the form of colloidal and/or particulate lead, such as, but not limited to a lead oxide, lead hydroxide, and/or lead oxy(hydroxyl). The insoluble lead composition may be in a hydrated form having one or more waters of hydration.

The NSF testing water composition in defined in one or more of the following documents: “NSF/ANSI 42-2007a NSF International Standard/American National Standard for Drinking Water Treatment Units—Drinking Water Treatment Units—Aesthetic Effects” Standard Developer—NSF International, Designated as a ANSI Standard, Oct. 22, 2007, American National Standards; “NSF/ANSI 53-2009e NSF International Standard/American National Standard Drinking Water Treatment Units—Health Effects” Standard Developer—NSF International, designated as an ANSI Standard, Aug. 28, 2009; and “NSF/ANSI 61-2009 NSF International Standard/American National Standard for Drinking Water Additives-Drinking Water System Components-Health Effects” Standard Developer NSF International, designated as an ANSI Standard, Aug. 26, 2009.

### Example 16

High surface area (“HAS”) ceria (Surface area: 130±10 m²/g) having a loading of about 20 mg was contacted with an analyte having about 0.5 mg/L of the reagent in question and qualifying as NSF 53 water. The NSF water components are provided in Table 20 below:

TABLE 20
NSF 53 Water Components

| Reagent | Concentration (mg/L) |
|---|---|
| Sodium Bicarbonate | 20 |
| Magnesium Sulfate | 30 |
| Calcium Chloride | 30 |

The analyte had a pH of pH 12.25±0.25, a temperature of 20-25° C. (or ambient room temperature.

The analyte was contacted with the HSF ceria for approximately 24 hours.

The reagents in question were bismuth, chromium, cobalt, manganese, zinc and zirconium species. Under the above conditions, the primary species were believed to be in colloidal form.

The media was prepared by measuring 20 mg of HSA ceria in a plastic weigh boat and wetting the HAS ceria media with deionized water for at least 30 minutes.

The analyte was prepared in 2.0 L batches in NSF 53. Lead removal water without added lead. 1,000 mg/L SPEX nitric based standards were obtained and were used to prepare 0.5 mg/L influents of the reagents in question. This solution was mixed with a high shear blender (Ninja Model: BL500 30) for 30 seconds. The pH adjusted to pH 12.25±0.25 with 3M NaOH and mixed for an additional 60 seconds. Previous test with higher concentrations showed that at a pH of 12.25±0.25 particulates were present.

The isotherm was prepared by pouring 500 mL of influent into 4 500 mL bottles. The previously wetted media was poured into each 500 mL sample bottle. Bottles were capped and sealed with electrical tape. Each bottle was then placed within a rolling container that could hold up to 10 bottles. The containers were sealed with duct tape and placed on the rolling apparatus. Samples and controls were rolled for 24 hours. After 24 hours, the rolling containers were removed from the apparatus and the bottles were retrieved from the containers.

For each metal sample, a 5 mL sample was taken and diluted with the addition of 3 mL concentration nitric acid and filtered with a 0.2 μm filter. The samples were acidified to ensure that all metals were in soluble form. Metal samples were analyzed by Inductively Coupled Plasma-Mass Spectrometry (ICP-MS). To confirm the presence of colloidal metals, samples were first filtered to remove any particulates then acidified to ensure metals were in soluble form. Analysis for these test were all below the detection limit for the metal analyzed. All isotherms were prepared and tested in the same manner and were thus readily comparable.

As shown in Table 21, colloidal bismuth, chromium, manganese, and zinc were all removed from NSF 53 water with HSA Ceria. The ability to remove the reagent in question was based on at least a 10% removal of the reagent in question from the influent.

TABLE 21

| | | | Removal | |
|---|---|---|---|---|
| | Initial [M+] | Final [M+] | Capacity (mg | % |
| Metal | (ug/L) | (ug/L) | M+/g media) | Removal |
| Bismuth | 409.6 | 88.53 | 7.73 | 78.39 |
| Chromium | 318.4 | 262.93 | 1.38 | 17.42 |
| Cobalt | 374.4 | 398.4 | −0.59 | −6.41 |
| Manganese | 417.6 | 366.4 | 1.27 | 12.26 |
| Zinc | 603.2 | 499.73 | 2.53 | 17.15 |
| Zirconium | 321.6 | 346.13 | −0.62 | −7.63 |

*The Final Conc, Removal Capacity, and % Removal were averages taken from three samples

This table 22 shows the breakdown of cobalt and zirconium.

TABLE 22

| | | | Removal | |
|---|---|---|---|---|
| | Initial [M+] | Final [M+] | Capacity (mg | % |
| Metal | (ug/L) | (ug/L) | M+/g media) | Removal |
| Cobalt 9A | 374.40 | 369.60 | 0.12 | 1.28 |
| Cobalt 9B | 374.40 | 440.00 | −1.62 | −17.52 |
| Cobalt 9C | 374.40 | 385.60 | −0.27 | −2.99 |
| Zirconium | 321.60 | 316.80 | 0.12 | 1.49 |
| 12A | | | | |
| Zirconium | 321.60 | 296.00 | 0.60 | 7.96 |
| 12B | | | | |
| Zirconium | 321.60 | 425.60 | −2.59 | −32.34 |
| 12C | | | | |

Colloidal bismuth, chromium, manganese, and zinc were all removed from NSF 53 water with HSA ceria. These results give us an understanding that, under ideal conditions, these reagents could be removed using HSA ceria.

### Example 17

This example compares various test results to draw conclusions on how changes in, temperature, surface area, speciation, and concentration affect the loading capacity of arsenic onto ceria. The experimental procedure is set forth below:

Material: CeO₂: LOI-4.6%, SA-140 m²/g;
CeO₂: LOI-6.3%, SA-210 m²/g

### Loading: 40 g

### Test Solution Constituents (Added to 20 L of DI Water):

2244.45 g of NiSO₄.6H₂O
119.37 g of CuSO₄.5H₂O
57.81H₃BO₃
406.11 NaCl
15.01 FeSO₄.7H₂O
4.79 g of CoSO₄.7H₂O
70 con HCl

### Test Solution Conditions:

pH: 1.63
Density: 1.08 mL/g

### Column Influent:

pH: For all columns it ranged from pH 1.1 to 1.2

Density: For all columns it was 1.08 g/mL

Temperature: All columns were run at ambient room temperature ˜21° C. or 70° C.

Flowrate: Flow rates ranged from 1 to 1.8 mL/min, or 2.2%-4.0% Bed Volume

Approximate Amount of Flocculent Used: 22 drops of 1% Nalco 7871

Column Bed Dimensions: For all columns 8.5-9 cm by 2.54 cm ID

### Media:

150 g of ACS certified NaCl was added to 1 L volumetric. The salt was then diluted up to the 1 L mark using DI water. The salt was then transferred to a 2 L beaker and heated to a boil. Next, 15 mL of concentrated HCl was added the boiling water while being stirred using a magnetic stir bar. Quickly after the HCl addition, 40.00 g of dry CeO₂ was slowly added to the mixing acidic salt solution. This solution is allowed to stir for 5 minutes. Next, 22 drops of 1% Nalco 7871 were added to clarify the solution and prevent classification of the material when it is added into the column.

### Loading the Column:

The flocculated CeO₂ media is transferred into a 2.54 cm by 30 cm glass column. DI water is flown through the bed at 12 mL/min to settle the bed until it completely settled down to 8.5 cm. The DI water on top of the bed was decanted and replaced with the influent solution then capped and tightly sealed.

TABLE 23

| As | | | | Loading at |
|---|---|---|---|---|
| Concentration | | Temp. | Loading at | Theoretical |
| (mg/L) | Speciation | (° C.) | Theoretical | REO |
| 1000 | V | 21 | 43 | 45 |
| 3000 | V | 21 | 46 | 48 |
| 1000 | III | 21 | 47 | 49 |
| 3000 | III | 21 | 50 | 52 |
| 1000 | V | 21 | 46 | 50 |
| 3000 | V | 21 | 50 | 54 |
| 1000 | III | 21 | 46 | 49 |
| 3000 | III | 21 | 53 | 56 |
| 1000 | V | 70 | 59 | 61 |
| 3000 | V | 70 | 67 | 70 |
| 1000 | III | 70 | 58 | 61 |
| 3000 | III | 70 | 64 | 67 |
| 1000 | V | 70 | 68 | 72 |
| 3000 | V | 70 | 77 | 82 |
| 1000 | III | 70 | 58 | 62 |
| 3000 | III | 70 | 74 | 74 |
| 6000 | V | 70 | 83 | 89 |
| 6000 | V | 21 | 72 | 78 |
| 6000 | III | 70 | 77 | 82 |
| 6000 | III | 21 | 69 | 73 |

As can be seen from Table 23 and FIG. 57, the arsenic species loading capacity of cerium (IV) oxide loading is affected by changes in temperature, surface area, speciation, and arsenic species concentration.

### Example 18

This example determined what colloidal metals can be removed by high surface area (“HSA”) cerium (IV) oxide from NSF 53 water. The test parameters were as follows:

### Parameters:

Material: HSA ceria oxide (Surface area: 13 ±10 m²/g)

Loading: 20 mg

Analyte Conc: 0.5 mg/L of the reagent in question NSF 53 water

TABLE 24
NSF 53 Water Components

| Reagent | Concentration (mg/L) |
|---|---|
| Sodium Bicarbonate | 20 |
| Magnesium Sulfate | 30 |
| Calcium Chloride | 30 |

pH: Varies

Temperature: 20-25 C ambient room temperature

Contact Duration: 24 hours

Metals Tested Bismuth, Chromium, Cobalt, Manganese, Zinc, Zirconium, Aluminum, and

Copper

### Media Preparation:

20 mg of HSA ceria oxide was measured out in a plastic weigh boat. The media was wetted with DI water for at least 30 minutes.

### Influent Preparation:

Influent was prepared in 2.0 L batches in NSF 53 Lead removal water without added

Lead. 1000 mg/L SPEX nitric based standards were obtained and were used to prepare 0.5 mg/L influents of the reagents in question. This solution was first mixed with a high shear blender (Ninja Model: BL500 30) for 30 seconds, then pH adjusted with 3M NaOH or conc. HCl, the solution was then mixed for an additional 30 seconds. Oxidation-Reduction-Potential (“ORP”) values were then adjusted using solid Sodium Sulfite or 12.5% NaClO solution (see Table 25).

TABLE 25
Test Conditions

| Sample | | Metal | Target | Target | Actual | Actual |
|---|---|---|---|---|---|---|
| ID | Metal | Species | pH | ORP (mV) | ORP (mV) | pH |
| 1 | Bismuth | BiOOH (S) | 12.75-14 | −400-400 | 20 | 13 |
| **1A | Bismuth | Bi(S) | 1-14 | −400 | 225 | 1.68 |
| 2 | Chromium | Cr₂O₃ (S) | >7.5 | −400-100 | 56 | 8.54 |
| 2A | Cobalt | CoO₂ (S) | 12 | na | na | 12.12 |
| 3 | Manganese | MnO₂ (S) | 5-14 | 500 | 350 | 11.95 |
| 3A | Manganese | Mn₂O₃ (S) | 11-12 | 200-300 | 279 | 11.04 |
| 3B | Manganese | Mn₃O₄ (S) | 12 ± 0.5 | 0-100 | 14 | 12 |
| 5 | Zinc | Zn(OH)₂ (S) | 8.5-11.5 | −500-600 | 420 | 10.28 |
| 6 | Zirconium | ZrO₂ (S) | >8.5 | na | na | 12.06 |
| 7 | Aluminum | Al₂O₃(H₂O)(S) | 5.75-7.5 | −400-800 | 275 | 6.74 |
| 8 | Copper | Cu(OH)₂ (S) | 8-10 | 100-700 | 500 | 9.50 |
| 8a | Copper | Cu₂O (S) | 9-12 | −100-50 | 49 | 9.91 |

**Correct ORP value was not obtained

### Test Procedure:

Isotherm Prep Procedure:

Four 500 mL bottles were charged with 500 g influent each. The previously wetted media was poured into each 500 mL sample bottle. Bottles were capped and sealed with electrical tape. Each bottle was then placed within a rolling container that could hold up to 10 bottles. The containers were then sealed with duct tape and placed on the rolling apparatus. Samples were rolled for 24 hours. After 24 hours, the rolling containers were removed from the apparatus and the bottles were retrieved from the containers.

Sample Prep Procedure for Analysis:

For each metal sample, a 5 mL sample was taken and diluted with the addition of 5 mL 10% Nitric acid and then filtered with a 0.2 μm filter. The samples were acidified to ensure that all metals were in soluble form. Metal samples were analyzed by Inductively Coupled Plasma-Mass Spectrometry (ICP-MS). To confirm the presence of insoluble metals, samples were first filtered with a 0.2 μm filter to remove any insoluble metals then acidified to ensure all samples were the same. All isotherms were prepared and tested in the same manner and were thus readily comparable.

### Test Results:

As shown in Tables 26-27, Cr₂O₃(S), Mn₃O₄(S)Al₂O₃(H₂O)(S), Cu(OH)₂(S), and Cu₂O(S) were all removed from NSF 53 water with HSA Ceria. The ability to remove the reagent in question was based on at least a 10% removal of the reagent in question from the influent.

TABLE 26

| | | | Initial | Final | Removal | |
|---|---|---|---|---|---|---|
| Sample | | Metal | [M+] | [M+] | Capacity (mg | % |
| ID | Metal | Species | (ug/L) | (ug/L) | M+/g media) | Removal |
| 1 | Bismuth | BiOOH (S) | | | | |
| **1A | Bismuth | Bi(S) | | | | |
| 2 | Chromium | Cr₂O₃ (S) | 286.11 | 61.04 | 5.54 | 78.67 |
| 2A | Cobalt | CoO₂ (S) | 371.4 | 395.40 | −0.59 | −6.46 |
| 3 | Manganese | MnO₂ (S) | 24.10 | 59.35 | −0.88 | −146.23 |
| 3A | Manganese | Mn₂O₃ (S) | 31.84 | 114.10 | −2.03 | −258.35 |
| 3B | Manganese | Mn₃O₄ (S) | 414.6 | 363.40 | 1.27 | 12.35 |
| 5 | Zinc | Zn(OH)₂ (S) | 27.50 | 13.42 | 0.35 | 51.21 |
| 6 | Zirconium | ZrO₂ (S) | 319.1 | 343.63 | −0.62 | −7.69 |
| 7 | Aluminum | Al₂O₃(H₂O)(S) | 349.80 | 1.72 | 8.70 | 99.51 |
| 8 | Copper | Cu(OH)₂ (S) | 291.96 | 2.12 | 7.22 | 99.27 |
| 8a | Copper | Cu₂O (S) | 343.10 | 2.92 | 8.25 | 99.15 |

*The Final Conc, Removal Capacity, and % Removal were averages taken from three samples
**Correct ORP value was not obtained

TABLE 27
INSOLUBLE METAL REMOVED

| | | | | Removal | |
|---|---|---|---|---|---|
| | | Initial | Final | Capacity | |
| | Metal | [M+] | [M+] | (mg M+/ | % |
| Metal Used | Species | (ug/L) | (ug/L) | g media) | Removal |
| Cobalt 2AA | CoO₂ (S) | 371.40 | 366.60 | 0.12 | 1.29 |
| Cobalt 2AB | CoO₂ (S) | 371.40 | 437.00 | −1.62 | −17.66 |
| Cobalt 2AC | CoO₂ (S) | 371.40 | 382.60 | −0.27 | −3.02 |
| Manganese 3A | MnO₂ (S) | 24.102 | 41 | −0.39 | −68.04 |
| Manganese 3B | MnO₂ (S) | 24.102 | 72 | −1.19 | −197.57 |
| Manganese 3C | MnO₂ (S) | 24.102 | 66 | −1.05 | −173.09 |
| Manganese 3AA | Mn₂O₃ (S) | 31.84 | 69 | −0.91 | −117.40 |
| Manganese 3AB | Mn₂O₃ (S) | 31.84 | 115 | −2.05 | −260.80 |
| Manganese 3AC | Mn₂O₃ (S) | 31.84 | 158 | −3.13 | −396.86 |
| Zinc 5A | Zn(OH)₂ | 27.5 | 27 | 0.00 | 0.20 |
| | (S) | | | | |
| Zinc 5B | Zn(OH)₂ | 27.5 | −22 | 1.22 | 178.84 |
| | (S) | | | | |
| Zinc 5C | Zn(OH)₂ | 27.5 | 34 | −0.17 | −25.41 |
| | (S) | | | | |
| Zirconium 6A | ZrO₂ (S) | 319.10 | 314.30 | 0.12 | 1.50 |
| Zirconium 6B | ZrO₂ (S) | 319.10 | 293.50 | 0.60 | 8.02 |
| Zirconium 6C | ZrO₂ (S) | 319.10 | 423.10 | −2.59 | −32.59 |

### Conclusions:

Colloidal chromium, aluminum, and copper were all removed from NSF 53 water with HSA ceria. Some experiments indicated that cobalt, zinc, and zirconium were also removed. The ability of HAS ceria to remove manganese was unclear.

### Example 19

This example determined what colloidal metals can be removed by high surface area (“HSA”) cerium (IV) oxide from NSF 53 water. The test parameters were as follows:

### Parameters:

Material: HSA Ceria (Surface area: 130±10 m²/g)
Loading: 20 mg
Analyte Conc: 0.5 mg/L of the reagent in question NSF 53 water

NSF 53 Water Components

| Reagent | Concentration (mg/L) |
|---|---|
| Sodium Bicarbonate | 20 |
| Magnesium Sulfate | 30 |
| Calcium Chloride | 30 |

pH, ORP: Varies see Table: 1
Temperature: 20-25 C ambient room temperature
Contact Duration: 24 hours
Metals Tested Bismuth, Chromium, Cobalt, Manganese, Zinc, Zirconium, Aluminum, and Copper

### Media Preparation:

20 mg of HSA Ceria was measured out in a plastic weigh boat. The media was wetted with DI water for at least 30 minutes.

### Influent Preparation:

Influent was prepared in 2.0 L batches in NSF 53 Lead removal water without added Lead. 1000 mg/L SPEX nitric based standards were obtained and were used to prepare 0.5 mg/L influents of the reagents in question. This solution was first mixed with a high shear blender (Ninja Model: BL500 30) for 30 seconds, then pH adjusted with 3M NaOH or conc. HCl, the solution was then mixed for an additional 30 seconds. ORP values were then adjusted using solid

Sodium Sulfite or 12.5% NaClO solution.

TABLE 28

| Sample | | Metal | Target | Target | Actual | Actual |
|---|---|---|---|---|---|---|
| ID | Metal | Species | pH | ORP (mV) | ORP (mV) | pH |
| 1 | Bismuth | BiOOH_{(S)} | 12.75-14 | −400-400 | 20 | 13.00 |
| **1A | Bismuth | Bi_{(S)} | 1-14 | −400 | 20-225 | 12.05 |
| 2 | Chromium | Cr₂O_{3 (S)} | >7.5 | −400-100 | 56 | 8.54 |
| 2A | Cobalt | CoO_{2 (S)} | 12 | na | na | 12.12 |
| 3 | Manganese | MnO_{2 (S)} | 5-14 | 500 | 350 | 11.95 |
| 3A | Manganese | Mn₂O_{3 (S)} | 11-12 | 200-300 | 279 | 11.04 |
| 3B | Manganese | Mn₃O_{4 (S)} | 12 ± 0.5 | 0-100 | 14 | 12.05 |
| 5 | Zinc | Zn(OH)_{2 (S)} | 8.5-11.5 | −500-600 | 420 | 10.28 |
| 6 | Zirconium | ZrO_{2 (S)} | >8.5 | na | na | 12.06 |
| 7 | Aluminum | Al₂O₃(H₂O)_{(S)} | 5.75-7.5 | −400-800 | 275 | 6.74 |
| 8 | Copper | Cu(OH)_{2 (S)} | 8-10 | 100-700 | 500 | 9.50 |
| 8a | Copper | Cu₂O_{(S)} | 9-12 | −100-50 | 49 | 9.91 |

**ORP value estimated, correct value for Bi_{(S)} never obtained value recorded corresponds to BiO⁺

### Procedure:

Isotherm Prep Procedure:

Four 500 mL bottles were charged with 500 g influent each. The previously wetted media was poured into each 500 mL sample bottle. Bottles were capped and sealed with electrical tape. Each bottle was then placed within a rolling container that could hold up to 10 bottles. The containers were then sealed with duct tape and placed on the rolling apparatus. Samples were rolled for 24 hours. After 24 hours, the rolling containers were removed from the apparatus and the bottles were retrieved from the containers.

Sample Prep Procedure for Analysis:

For each metal sample, a 5 mL sample was taken and diluted with the addition of 5 mL 10% Nitric acid and then filtered with a 0.2 μm filter. The samples were acidified to ensure that all metals were in soluble form. Metal samples were analyzed by Inductively Coupled Plasma-Mass Spectrometry (ICP-MS). To confirm the presence of insoluble metals, samples were first filtered with a 0.2 μm filter to remove any insoluble metals then acidified to ensure all samples were the same. All isotherms were prepared and tested in the same manner and were thus readily comparable.

The results are presented in Tables 29-30.

TABLE 29

| | | Target | Initial | Final | Removal | |
|---|---|---|---|---|---|---|
| Sample | | Metal | [M+] | [M+] | Capacity (mg | % |
| ID | Metal | Species | (ug/L) | (ug/L) | M+/g media) | Removal |
| 1 | Bismuth | BiOOH_{(S)} | 557.17 | 27.77 | 13.16 | 95.02 |
| 1A | Bismuth | BiO⁺ | 409.6 | 88.53 | 7.73 | 78.39 |
| 2 | Chromium | Cr₂O_{3 (S)} | 286.11 | 61.04 | 5.54 | 78.67 |
| 2A | Cobalt | CoO_{2 (S)} | 371.4 | 395.40 | −0.59 | −6.46 |
| 3 | Manganese | MnO_{2 (S)} | 493 | 59.35 | 10.67 | 87.96 |
| 3A | Manganese | Mn₂O_{3 (S)} | 512.5 | 114.10 | 9.79 | 77.74 |
| 3B | Manganese | Mn₃O_{4 (S)} | 414.6 | 363.40 | 1.27 | 12.35 |
| 5 | Zinc | Zn(OH)_{2 (S)} | 532 | 13.42 | 12.85 | 97.48 |
| 6 | Zirconium | ZrO_{2 (S)} | 319.1 | 343.63 | −0.62 | −7.69 |
| 7 | Aluminum | Al₂O₃(H₂O)_{(S)} | 349.80 | 1.72 | 8.70 | 99.51 |
| 8 | Copper | Cu(OH)_{2 (S)} | 291.96 | 2.12 | 7.22 | 99.27 |
| 8a | Copper | Cu₂O_{(S)} | 343.10 | 2.92 | 8.25 | 99.15 |

*The Final Conc, Removal Capacity, and % Removal were averages taken from three samples

TABLE 30
INSOLUBLE METAL REMOVED

| | | | | Removal | |
|---|---|---|---|---|---|
| | Target | Initial | Final | Capacity | |
| | Metal | [M+] | [M+] | (mg M+/ | % |
| Metal Used | Species | (ug/L) | (ug/L) | g media) | Removal |
| Cobalt 2AA | CoO_{2 (S)} | 371.40 | 366.60 | 0.12 | 1.29 |
| Cobalt 2AB | CoO_{2 (S)} | 371.40 | 437.00 | −1.62 | −17.66 |
| Cobalt 2AC | CoO_{2 (S)} | 371.40 | 382.60 | −0.27 | −3.02 |
| Zirconium 6A | ZrO₂ _{(S)} | 319.10 | 314.30 | 0.12 | 1.50 |
| Zirconium 6B | ZrO₂ _{(S)} | 319.10 | 293.50 | 0.60 | 8.02 |
| Zirconium 6C | ZrO₂ _{(S)} | 319.10 | 423.10 | −2.59 | −32.59 |

*This table was included due to the negative removal capacities or negative final concentrations of insoluble Cobalt, Manganese, Zinc, and Zirconium.

All metals solutions were prepared in NSF 53 Arsenic test water without the addition of As. These solutions were all challenged with HSA cerium oxide (CeO₂) There was definite removal of Bi (target species BiOOH_{(S)}, BiO⁺) There was definite removal of Cr (target species Cr₂O_{3 (S)}), Mn (target species MnO_{2 (S)}, Mn₂O_{3 (S)}, and Mn₃O_{4 (S)}), Zn (target species Zn(OH)_{2 (S)}), Al (target species Al₂O₃(H₂O)_{(S)}), Cu (target species Cu(OH)_{2 (S)} and Cu₂O_{(S)}), and Zr (target species ZrO_{2 (S)}). There was apparent removal of Co (target species CoO_{2 (S)}) in trial 2AA. These results give us an understanding that under controlled conditions, insoluble compounds of Al, Co, Cr, Cu, Mn, Zn, and Zr could be removed using HSA cerium oxide (CeO₂).

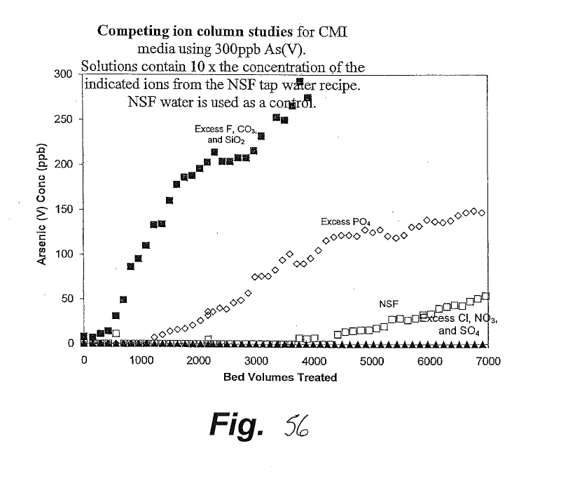

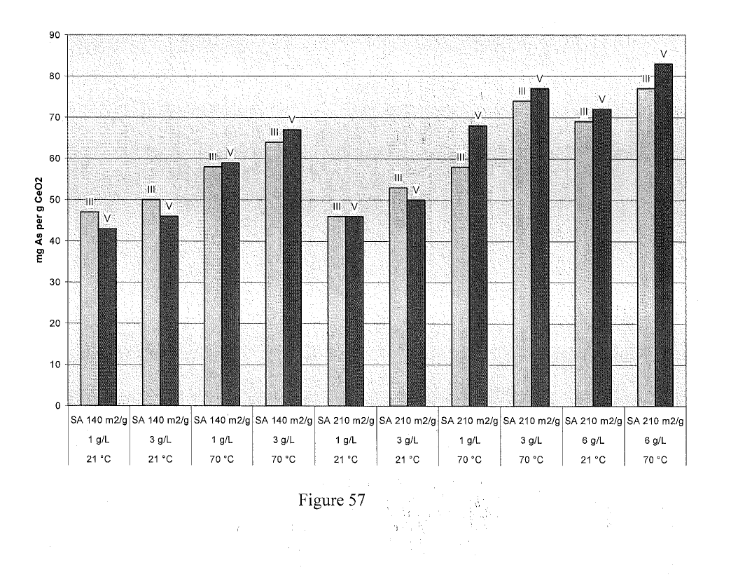

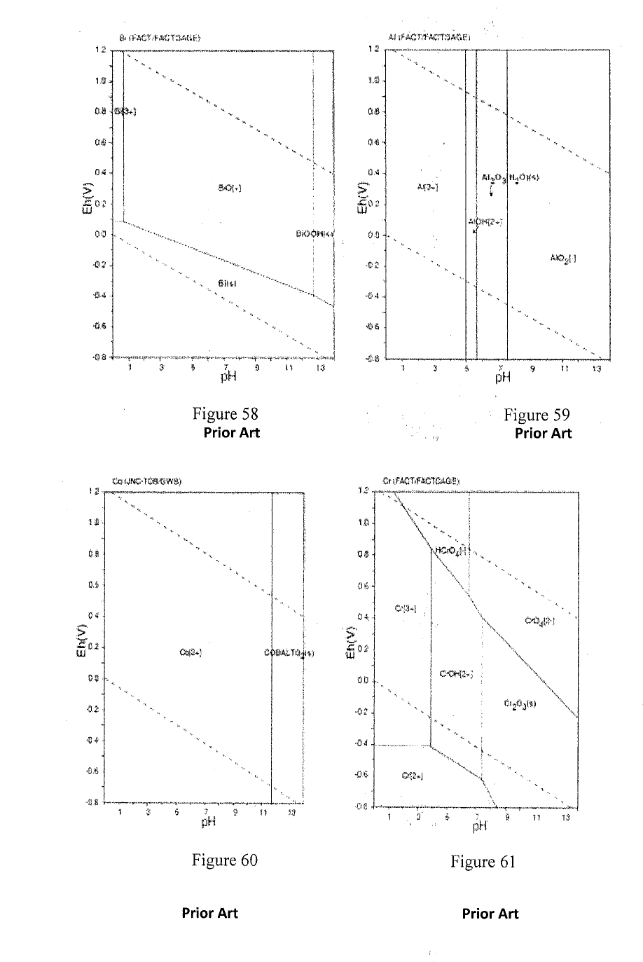

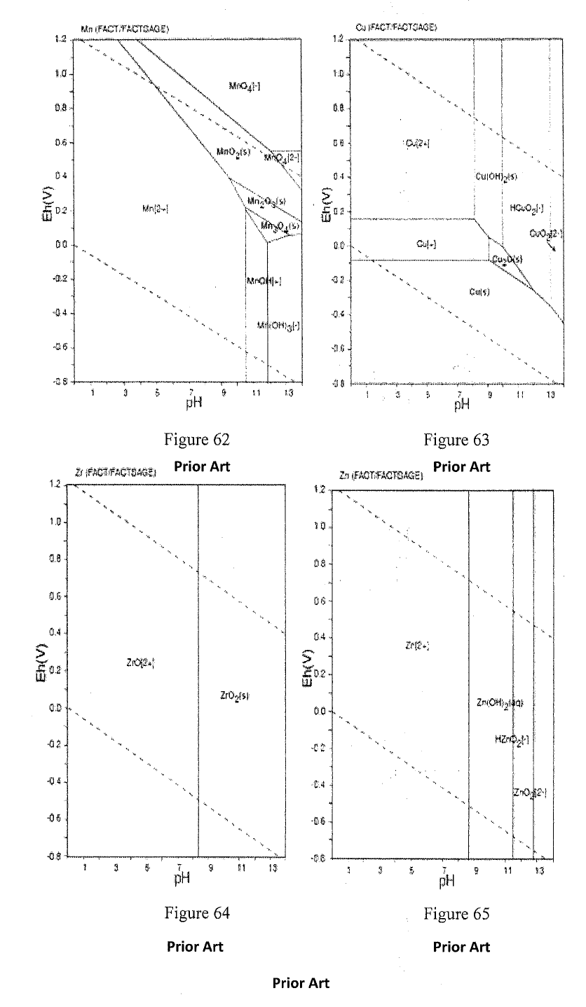

FIGS. 58-65 show Pourbaix diagrams for the above materials.

A number of variations and modifications of the disclosure can be used. One of more embodiments of the disclosure can used separately and in combination. That is, any embodiment alone can be used and all combinations and permutations thereof can be used. It would be possible to provide for some features of the disclosure without providing others.

The present disclosure, in various embodiments, configurations, or aspects, includes components, methods, processes, systems and/or apparatus substantially as depicted and described herein, including various embodiments, configurations, aspects, sub-combinations, and subsets thereof. Those of skill in the art will understand how to make and use the various embodiments, configurations, or aspects after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that any claim and/or combination of claims require more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment.

Moreover, though the description of the disclosure has included descriptions of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A composition of the form: 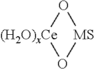
where 0≦X≦8,
wherein MS is one of the following:
M(H₂O)₆ⁿ, M(H₂O)₅OH⁽ⁿ⁻¹), M(OH)⁽ⁿ⁻¹⁾M(H₂O)₄(OH)₂⁽ⁿ⁻²⁾, M(OH)₂⁽ⁿ⁻²⁾, M(H₂O)₃(OH)₃⁽ⁿ⁻³⁾, M(OH)₃⁽ⁿ⁻³⁾, M(H₂O)₂(OH)₄⁽ⁿ⁻⁴⁾, M(OH)₄⁽ⁿ⁻⁴⁾, M(H₂O)(OH)₅⁽ⁿ⁻⁵⁾, M(OH)₅⁽ⁿ⁻⁵⁾, M(OH)₆⁽ⁿ⁻⁶⁾, M(H₂O)₅O⁽ⁿ⁻²⁾, M(H₂O)₄(O)₂⁽ⁿ⁻⁴⁾, M(H₂O)₃(O)₃⁽ⁿ⁻⁶⁾, M(H₂O)₂(O)₄⁽ⁿ⁻⁸⁾, M(H₂O)(O)₅⁽ⁿ⁻¹⁰⁾, M(H₂O)₅CO₃⁽ⁿ⁻²⁾, MCO₃⁽ⁿ⁻²⁾, M(H₂O)₄(CO₃)₂⁽ⁿ⁻⁴⁾, M(CO₃)₂⁽ⁿ⁻⁴⁾, M(H₂O)₃(CO₃)₃⁽ⁿ⁻⁶⁾, M(CO₃)₃⁽ⁿ⁻⁶⁾, M(H₂O)₂(CO₃)₄⁽ⁿ⁻⁸⁾, M(CO₃)₄⁽ⁿ⁻⁸⁾, M(H₂O)(CO₃)₅⁽ⁿ⁻¹⁰⁾, M(CO₃)₅⁽ⁿ⁻¹⁰⁾, M(CO₃)₆⁽ⁿ⁻¹²⁾, M(H₂O)₄ⁿ, M(H₂O)₃OH⁽ⁿ⁻¹⁾, M(H₂O)₂(OH)₂⁽ⁿ⁻²⁾, M(H₂O)(OH)₃⁽ⁿ⁻³⁾, M(H₂O)₃O⁽ⁿ⁻²⁾, M(H₂O)₂(O)₂⁽ⁿ⁻⁴⁾, and M(H₂O)(O)₃⁽ⁿ⁻⁶⁾,
wherein “M” is a metal or metalloid having an atomic number selecting from the group consisting of 5, 13, 22-33, 40-52, 72-84, and 89-94,
wherein “n” is a real number <8, and
wherein “n” represents a charge or oxidation state of “M”.

2. The composition of claim 1, wherein the composition is in an aqueous medium and wherein the aqueous medium comprises a pH and Eh sufficient to favor MS as the primary species of M.

3. The composition of claim 1, wherein the cerium oxide has an oxidation state of (IV) and is in the form of a particulate and wherein M is lead.

4. The composition of claim 1, wherein MS is in the form of a hydroxide.

5. The composition of claim 1, wherein MS is in the form of an oxyhydroxl compound.

6. The composition of claim 1, wherein MS is in the form of a carbonate.

7. The composition of claim 1, wherein MS is in the form a metal or metalloid hydrate.

8. The composition of claim 1, wherein M is one or more of boron, vanadium, chromium, cadmium, antimony, lead, and bismuth and wherein MS is one or more of a hydroxide, a carbonate, and a metal or metalloid hydrate.

9. A method, comprising:
contacting, in a liquid medium, a rare earth-containing additive with one or more of a metal or metalloid hydroxide, carbonate, and hydrate to remove the one or more of a metal or metalloid hydroxide, carbonate, and hydrate.

10. The method of claim 9, wherein the metal or metalloid has an atomic number selected from the group consisting of 5, 13, 22-33, 40-52, 72-84, and 89-94 and the one or more of a metal or metalloid hydroxide, carbonate, and hydrate has one or more of the following formulas:
M(H₂O)₆ⁿ, M(H₂O)₅OH⁽ⁿ⁻¹), M(OH)⁽ⁿ⁻¹⁾M(H₂O)₄(OH)₂⁽ⁿ⁻²⁾, M(OH)₂⁽ⁿ⁻²⁾, M(H₂O)₃(OH)₃⁽ⁿ⁻³⁾, M(OH)₃⁽ⁿ⁻³⁾, M(H₂O)₂(OH)₄⁽ⁿ⁻⁴⁾, M(OH)₄⁽ⁿ⁻⁴⁾, M(H₂O)(OH)₅⁽ⁿ⁻⁵⁾, M(OH)₅⁽ⁿ⁻⁵⁾, M(OH)₆⁽ⁿ⁻⁶⁾, M(H₂O)₅CO₃⁽ⁿ⁻²⁾, MCO₃⁽ⁿ⁻²⁾, M(H₂O)₄(CO₃)₂⁽ⁿ⁻⁴⁾, M(CO₃)₂⁽ⁿ⁻⁴⁾, M(H₂O)₃(CO₃)₃⁽ⁿ⁻⁶⁾, M(CO₃)₃⁽ⁿ⁻⁶⁾, M(H₂O)₂(CO₃)₄⁽ⁿ⁻⁸⁾, M(CO₃)₄⁽ⁿ⁻⁸⁾, M(H₂O)(CO₃)₅⁽ⁿ⁻¹⁰⁾, M(CO₃)₅⁽ⁿ⁻¹⁰⁾, M(CO₃)₆⁽ⁿ⁻¹²⁾, M(H₂O)₄ⁿ, M(H₂O)₃OH⁽ⁿ⁻¹⁾, M(H₂O)₂(OH)₂⁽ⁿ⁻²⁾, and M(H₂O)(OH)₃⁽ⁿ⁻³⁾,
wherein “M” is the metal or metalloid,
wherein “n” is a real number ≦8, and
wherein “n” represents a charge or oxidation state of “M”.

11. The method of claim 10, wherein the liquid medium is aqueous and has an Eh and pH sufficient to render the one or more of a metal or metalloid hydroxide, carbonate, and hydrate as the primary species of M.

12. The method of claim 11, wherein the Eh and pH are determined using a Pourbaix diagram of one or more of FIGS. 2-47 and 57-65.

13. The method of claim 9, wherein the rare earth-containing additive is in the form of cerium (IV) and/or cerium (III) and wherein M is lead.

14. The method of claim 9, wherein metal or metalloid is in the form of a hydroxide.

15. The method of claim 9, wherein metal of metalloid is in the form of a carbonate.

16. The method of claim 9, wherein metal or metalloid is in the form a metal or metalloid hydrate.

17. The method of claim 9, wherein the metal or metalloid is one or more of boron, vanadium, chromium, cadmium, antimony, lead, and bismuth.

18. The method of claim 9, wherein the contacting step comprises the sub-steps:
introducing, to the medium, an oxidizing agent to oxidize a target material-containing species comprising the metal or metalloid to a primary species in the form of the one or more of a metal or metalloid hydroxide, carbonate, and hydrate, the target material-containing species being different from the one or more of a metal or metalloid hydroxide, carbonate, and hydrate; and
thereafter contacting, in the medium, the rare earth-containing additive with the one or more of a metal or metalloid hydroxide, carbonate, and hydrate to remove the one or more of a metal or metalloid hydroxide, carbonate, and hydrate.

19. The method of claim 9, wherein the contacting step comprises the sub-steps:
introducing, to the medium, a reducing agent to reduce a target material-containing species comprising the metal or metalloid to a primary species in the form of the one or more of a metal or metalloid hydroxide, carbonate, and hydrate, the target material-containing species being different from the one or more of a metal or metalloid hydroxide, carbonate, and hydrate; and
thereafter contacting, in the medium, the rare earth-containing additive with the one or more of a metal or metalloid hydroxide, carbonate, and hydrate to remove the one or more of a metal or metalloid hydroxide, carbonate, and hydrate.

20. The method of claim 9, wherein the contacting step comprises the sub-steps:
introducing, to the medium, a base and/or base equivalent to convert a target material-containing species comprising the metal or metalloid to a primary species in the form of the one or more of a metal or metalloid hydroxide, carbonate, and hydrate, the target material-containing species being different from the one or more of a metal or metalloid hydroxide, carbonate, and hydrate; and
thereafter contacting, in the medium, the rare earth-containing additive with the one or more of a metal or metalloid hydroxide, carbonate, and hydrate to remove the one or more of a metal or metalloid hydroxide, carbonate, and hydrate.

21. The method of claim 9, wherein the contacting step comprises the sub-steps:
introducing, to the medium, an acid and/or acid equivalent to convert a target material-containing species comprising the metal or metalloid to a primary species in the form of the one or more of a metal or metalloid hydroxide, carbonate, and hydrate, the target material-containing species being different from the one or more of a metal or metalloid hydroxide, carbonate, and hydrate; and
thereafter contacting, in the medium, the rare earth-containing additive with the one or more of a metal or metalloid hydroxide, carbonate, and hydrate to remove the one or more of a metal or metalloid hydroxide, carbonate, and hydrate.

22. The method of claim 9, wherein the rare earth-containing additive is water soluble.

23. The method of claim 9, wherein the rare earth-contaning additive is water insoluble.

24. A method, comprising:
contacting, in a liquid medium, a rare earth-containing additive with a metal or metalloid target material, the target material being in the form of a hydroxide, carbonate, hydrate, or oxyhydroxyl as a primary species, to remove the target material.

25. The method of claim 24, wherein the target material has an atomic number selected from the group consisting of 5, 13, 22-33, 40-52, 72-84, and 89-94 and the target material has one or more of the following formulas:
M(H₂O)₆ⁿ, M(H₂O)₅OH⁽ⁿ⁻¹), M(OH)⁽ⁿ⁻¹⁾M(H₂O)₄(OH)₂⁽ⁿ⁻²⁾, M(OH)₂⁽ⁿ⁻²⁾, M(H₂O)₃(OH)₃⁽ⁿ⁻³⁾, M(OH)₃⁽ⁿ⁻³⁾, M(H₂O)₂(OH)₄⁽ⁿ⁻⁴⁾, M(OH)₄⁽ⁿ⁻⁴⁾, M(H₂O)(OH)₅⁽ⁿ⁻⁵⁾, M(OH)₅⁽ⁿ⁻⁵⁾, M(OH)₆⁽ⁿ⁻⁶⁾, M(H₂O)₅O⁽ⁿ⁻²⁾, M(H₂O)₄(O)₂⁽ⁿ⁻⁴⁾, M(H₂O)₃(O)₃⁽ⁿ⁻⁶⁾, M(H₂O)₂(O)₄⁽ⁿ⁻⁸⁾, M(H₂O)(O)₅⁽ⁿ⁻¹⁰⁾, M(H₂O)₅CO₃⁽ⁿ⁻²⁾, MCO₃⁽ⁿ⁻²⁾, M(H₂O)₄(CO₃)₂⁽ⁿ⁻⁴⁾, M(CO₃)₂⁽ⁿ⁻⁴⁾, M(H₂O)₃(CO₃)₃⁽ⁿ⁻⁶⁾, M(CO₃)₃⁽ⁿ⁻⁶⁾, M(H₂O)₂(CO₃)₄⁽ⁿ⁻⁸⁾, M(CO₃)₄⁽ⁿ⁻⁸⁾, M(H₂O)(CO₃)₅⁽ⁿ⁻¹⁰⁾, M(CO₃)₅⁽ⁿ⁻¹⁰⁾, M(CO₃)₆⁽ⁿ⁻¹²⁾, M(H₂O)₄ⁿ, M(H₂O)₃OH⁽ⁿ⁻¹⁾, M(H₂O)₂(OH)₂⁽ⁿ⁻²⁾, M(H₂O)(OH)₃⁽ⁿ⁻³⁾, M(H₂O)₃O⁽ⁿ⁻²⁾, M(H₂O)₂(O)₂⁽ⁿ⁻⁴⁾, and M(H₂O)(O)₃⁽ⁿ⁻⁶⁾,
wherein “M” is the metal or metalloid target material,
wherein “n” is a real number ≦8, and
wherein “n” represents a charge or oxidation state of “M”.

26. The method of claim 25, wherein the liquid medium is aqueous and has an Eh and pH sufficient to render the one or more of a metal or metalloid hydroxide, carbonate, and hydrate as the primary species of M.

27. The method of claim 26, wherein the Eh and pH are determined using a Pourbaix diagram of one or more of FIGS. 2-47 and 57-65.

28. The method of claim 24, wherein the rare earth additive is in the form of cerium (IV) and/or cerium (III) and wherein M is lead.

29. The method of claim 24, wherein target material is in the form of a hydroxide.

30. The method of claim 24, wherein target material is in the form of a carbonate.

31. The method of claim 24, wherein target material is in the form a metal or metalloid hydrate.

32. The method of claim 24, wherein the target material is in the form of an oxyhydroxyl compound.

33. The method of claim 24, wherein the target material is one or more of boron, vanadium, chromium, cadmium, antimony, lead, and bismuth.

34. The method of claim 24, wherein the contacting step comprises the sub-steps:
introducing, to the medium, an oxidizing agent to oxidize a target material-containing species to a primary species in the form of the one or more of a metal or metalloid hydroxide, carbonate, oxyhydroxyl, and hydrate, the target material-containing species being different from the one or more of a metal or metalloid hydroxide, carbonate, oxyhydroxyl, and hydrate; and
thereafter contacting, in the medium, the rare earth-containing additive with the one or more of a metal or metalloid hydroxide, carbonate, oxyhydroxyl, and hydrate to remove the one or more of a metal or metalloid hydroxide, carbonate, oxyhydroxyl, and hydrate.

35. The method of claim 24, wherein the contacting step comprises the sub-steps:
introducing, to the medium, a reducing agent to reduce a target material-containing species comprising the metal or metalloid to a primary species in the form of the one or more of a metal or metalloid hydroxide, carbonate, oxyhydroxyl, and hydrate, the target material-containing species being different from the one or more of a metal or metalloid hydroxide, carbonate, oxyhydroxyl, and hydrate; and
thereafter contacting, in the medium, the rare earth-containing additive with the one or more of a metal or metalloid hydroxide, carbonate, oxyhydroxyl, and hydrate to remove the one or more of a metal or metalloid hydroxide, carbonate, oxyhydroxyl, and hydrate.

36. The method of claim 24, wherein the contacting step comprises the sub-steps:
introducing, to the medium, a base and/or base equivalent to convert a target material-containing species comprising the metal or metalloid to a primary species in the form of the one or more of a metal or metalloid hydroxide, carbonate, oxyhydroxyl, and hydrate, the target material-containing species being different from the one or more of a metal or metalloid hydroxide, carbonate, oxyhydroxyl, and hydrate; and
thereafter contacting, in the medium, the rare earth-containing additive with the one or more of a metal or metalloid hydroxide, carbonate, and hydrate to remove the one or more of a metal or metalloid hydroxide, carbonate, oxyhydroxyl, and hydrate.

37. The method of claim 24, wherein the contacting step comprises the sub-steps:
introducing, to the medium, an acid and/or acid equivalent to convert a target material-containing species comprising the metal or metalloid to a primary species in the form of the one or more of a metal or metalloid hydroxide, carbonate, oxyhydroxyl, and hydrate, the target material-containing species being different from the one or more of a metal or metalloid hydroxide, carbonate, oxyhydroxyl, and hydrate; and
thereafter contacting, in the medium, the rare earth-containing additive with the one or more of a metal or metalloid hydroxide, carbonate, oxyhydroxyl, and hydrate to remove the one or more of a metal or metalloid hydroxide, carbonate, oxyhydroxyl, and hydrate.

38. The method of claim 24, wherein the rare earth-containing additive is water soluble.

39. The method of claim 24, wherein the rare earth-containing additive is water insoluble.
